(19) United States
(12) Patent Application Publication
(10) Pub. No.: US 2012/0113218 A1
(43) Pub. Date: May 10, 2012

(54) RECEIVING APPARATUS AND RECEIVING METHOD

(76) Inventors: Manabu SASAMOTO, Yokohama (JP); Shuji Ishihara, Yokohama (JP); Chiyo Ohno, Chigasaki (JP); Hiroyuki Koreeda, Fujisawa (JP)

(21) Appl. No.: 13/239,675

(22) Filed: Sep. 22, 2011

(30) Foreign Application Priority Data
Oct. 1, 2010 (JP) 2010-223386
Oct. 1, 2010 (JP) 2010-223387

(51) Int. Cl. H04N 13/00

(52) U.S. Cl. 348/43; 348/E13.06

(57) ABSTRACT

It is an object of the present invention to provide a content receiving apparatus capable of receiving, storing, and externally exporting content distributed from various networks. A receiving apparatus for receiving a digital signal in which a 3D video program and a 2D video program are mixedly present, includes a program selection unit configured to display and select a received program list; and a function determination unit configured to determine a function of viewing the 3D video program and 2D video program included in the receiving apparatus, wherein the program selection unit displays a viewable program list of the receiving apparatus according to a determination result of the function determination unit at the time of displaying the received program list.

### INCORPORATION BY REFERENCE

The present application claims priority from Japanese application JP2010-223386 filed on Oct. 1, 2010, JP2010-223387 filed on Oct. 1, 2010, the content of which is hereby incorporated by reference into this application.

### BACKGROUND OF THE INVENTION

The present invention relates to a receiver for receiving content distributed from a distribution system via a network and a method of receiving the content, and to a method of distributing content in a content transmission and reception system configured by the distribution and the receiver.

As the background art of the technical field, in International Publication Pamphlet No. WO 2004-100549, there is disclosed an embodiment of realizing a distribution system including a server which distributes content and a receiver which downloads content from the server via the Internet and plays back it.

In this embodiment, there is shown an example in which the Internet browser acquires a download control file (in the present invention, referred to as a download control metafile) describing execution contents of content download from a server and a download agent interprets this file and executes the download.

### SUMMARY OF THE INVENTION

It is an object of the present invention to provide a content receiving apparatus capable of receiving and playing back digital rights-protected content distributed from various networks.

To solve the above-described problem, for example, a configuration described in the scope of claims is adopted.

According to an aspect of the invention, a receiving apparatus for receiving a digital signal in which a 3D video program and a 2D video program are mixedly present, including a program selection unit configured to display and select a received program list; and a function determination unit configured to determine a function of viewing the 3D video program and 2D video program included in the receiving apparatus, wherein the program selection unit displays a viewable program list of the receiving apparatus according to a determination result of the function determination unit at the time of displaying the received program list.

According to the present invention, a content receiving apparatus can receive digital rights-protected content distributed from various networks and play back it while keeping attached use conditions.

Other objects, features and advantages of the invention will become apparent from the following description of the embodiments of the invention taken in conjunction with the accompanying drawings.

### BRIEF DESCRIPTION OF THE DRAWINGS

FIG. 1 illustrates a configuration example of a content transmission and reception system;

FIG. 2 illustrates a configuration example of a distribution system;

FIG. 3 illustrates a configuration example of a receiver;

FIG. 4 illustrates a first example of a relationship between a receiver and a distribution system;

FIG. 5 illustrates a second example of a relationship between a receiver and a distribution system;

FIG. 6 illustrates a third example of a relationship between a receiver and a distribution system;

FIG. 7 is a correlation diagram of ECG metadata;

FIG. 8 illustrates a configuration example of package metadata;

FIG. 9 illustrates a configuration example of download control information;

FIG. 10 illustrates a configuration example of a playback control metafile;

FIG. 11 illustrates a configuration example of a license;

FIG. 12 illustrates an example of a content retrieval screen of a receiver;

FIG. 13 illustrates an example of a retrieval result screen of a receiver;

FIG. 14 illustrates an example of a content purchase screen of a receiver;

FIG. 15 illustrates an example of a content detail display screen of a receiver;

FIG. 16 illustrates an example of a content playback screen of a receiver;

FIG. 17 illustrates an example of an export screen of a receiver;

FIG. 18 illustrates a transition example of web content presented on browser of a receiver;

FIG. 19 illustrates an example of a local navigation screen of a receiver;

FIG. 20 illustrates a configuration example of an interface portion between a receiver and a removable medium;

FIG. 21 illustrates a configuration example of an interface portion between a receiver and a network connection device;

FIG. 22 illustrates an example of a process flowchart in an ECG processing unit;

FIG. 23 illustrates an example of an export process flowchart to a removable medium in a stream export processing unit;

FIG. 24 illustrates an example of an export process flowchart to a network connection device in a stream export processing unit;

FIG. 25 illustrates an example of a process flowchart in a local navigation;

FIG. 26 illustrates another configuration example of an interface portion between a receiver and a removable medium;

FIG. 27 illustrates yet another configuration example of an interface portion between a receiver and a removable medium;

FIG. 28 illustrates a configuration example of a content distribution system;

FIG. 29 illustrates a configuration example of customer information;

FIG. 30 illustrates an example of a process flowchart in which a receiving apparatus accesses a portal system and a content distribution system;

FIG. 31 illustrates an example of a process flowchart in which a receiving apparatus purchases content;

FIG. 32 illustrates an example of a process flowchart in which a receiving apparatus views purchased content;

FIG. 33 illustrates an example of a process flowchart for terminating content during the viewing;

FIG. 34 illustrates an example of a top screen;

FIG. 35 illustrates an example of a top screen;

FIG. 36 illustrates an example of a non-purchased content list screen;

FIG. 37 illustrates an example of a purchased content list screen;

FIG. 38 illustrates an example of a content viewing start selection screen;

FIG. 39 illustrates an example of a process flowchart in which a receiving apparatus accesses a portal system and a content distribution system;

FIG. 40 illustrates an example of a character string exported based on device specification determination processing;

FIG. 41 illustrates a process flowchart of a device specification determination;

FIG. 42 illustrates a 2D content list;

FIG. 43 illustrates a guide for a 3D compatible apparatus;

FIG. 44 illustrates a 2D content list with a guide;

FIG. 45 illustrates a 2D/3D content list;

FIG. 46 illustrates a guide for an apparatus without a display;

FIG. 47 illustrates a 2D/3D content list with a guide;

FIG. 48 illustrates a configuration example of a receiving apparatus having a display unit and a speaker unit;

FIG. 49 illustrates a process flowchart of a device specification determination command execution;

FIG. 50 illustrates a process flowchart of a portal screen selection; and

FIG. 51 illustrates an outline of a screen transmitted to a receiving apparatus by a web server.

### DESCRIPTION OF THE EMBODIMENTS Embodiments of the present invention will be described below.

### First Embodiment

In the present embodiment, an example of a receiver 50 which receives content and a distribution system 60 will be described.

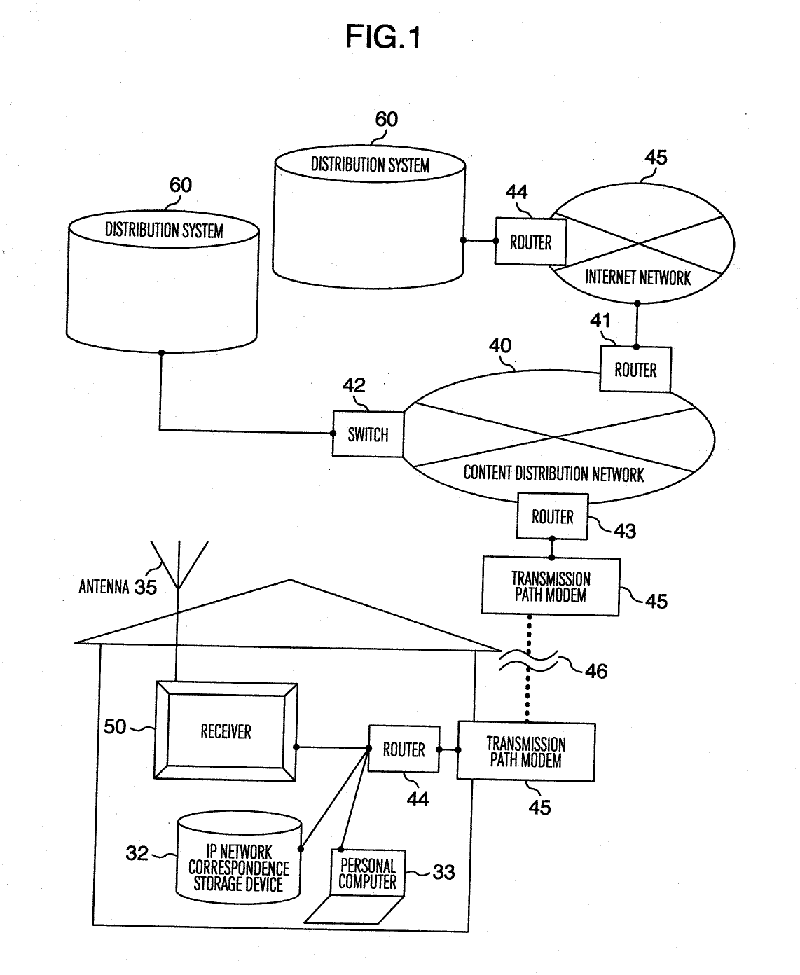

FIG. 1 illustrates a configuration example of a content transmission and reception system to which the present embodiment is applied. A distribution network is configured by a content distribution network 40 which is connected to a home via a rooter 43 and secures network quality in a network, and an external Internet network 45 connected from the content distribution network 40. A distribution system 60 may be connected to the content distribution network 40 via a network switch 42, or to the Internet network 45 via a rooter 44 with general versatility emphasized.

In a network connection to a home, various communication paths 46 such as a coaxial cable, an optical fiber, an asymmetric digital subscriber line (ADSL), and radio communication are supposed. Modulation or demodulation adapted to each path is performed by a transmission path MODEM unit 45, and converted into an IP network.

In the home, demodulation is performed by the transmission path MODEM unit 45, and the IP network converted into a network interface is connected to devices of the home via a rooter 44.

As the devices of the home, a receiver 50, a network attached storage 32 designed for the IP network, personal computer 33, and an audio-video equipment capable of being connected to a network are supposed. Possibly, the receiver 50 collectively has a function of playing back a broadcast program received by an antenna 35, and accumulating it.

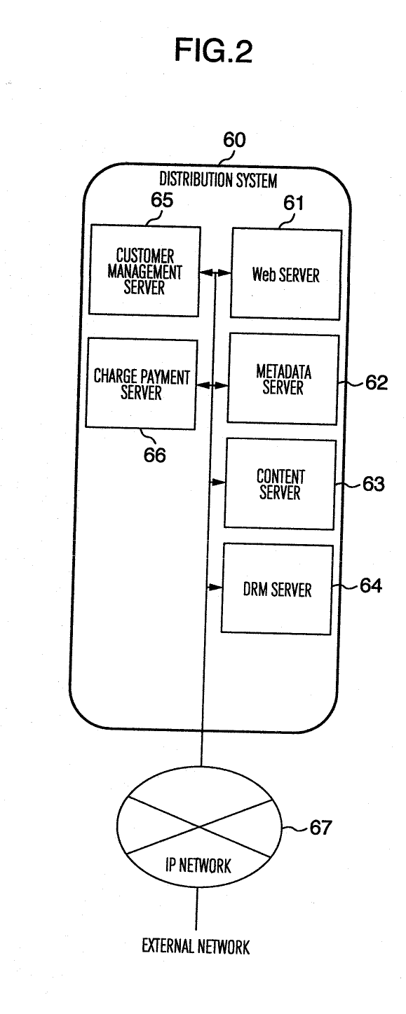

FIG. 2 illustrates a configuration example of the content distribution system 60.

The content distribution system 60 has a web server 61 which distributes a web document 71, ECG metadata 400 which describes attribute information on content to be distributed, a metadata server 62 which distributes playback control information 200 describing information necessary for playing back content, a content server 63 which distributes content itself 75, a DRM server 64 which distributes a license 300 including information on a key necessary for decoding of content necessary for a right to use or use of content, a customer management server 65 which manages customer information of a distribution service, and a charge payment server 66 which performs charging or settlement processing of content through a customer.

Each server is connected to each other via an IP network 67 as well as to Internet network 45 or content distribution network 40 of FIG. 1 via the IP network 67.

Note that a part or all of the servers may be connected directly to the Internet network 45 or the content distribution network 40 without the IP network 67, and they may communicate with each other.

Each server of the distribution system 60 is adamantly an opportunistic model. In a real distribution system, the distribution system 60 may have a server resulting from integrating multiple types of servers in reality, or eliminate some servers. Further, the distribution system 60 may have a configuration in which a server used for distributing multiple data as in the metadata server 62 is divided and configured in reality according to category of data. Each server is connected via a network such as the Internet.

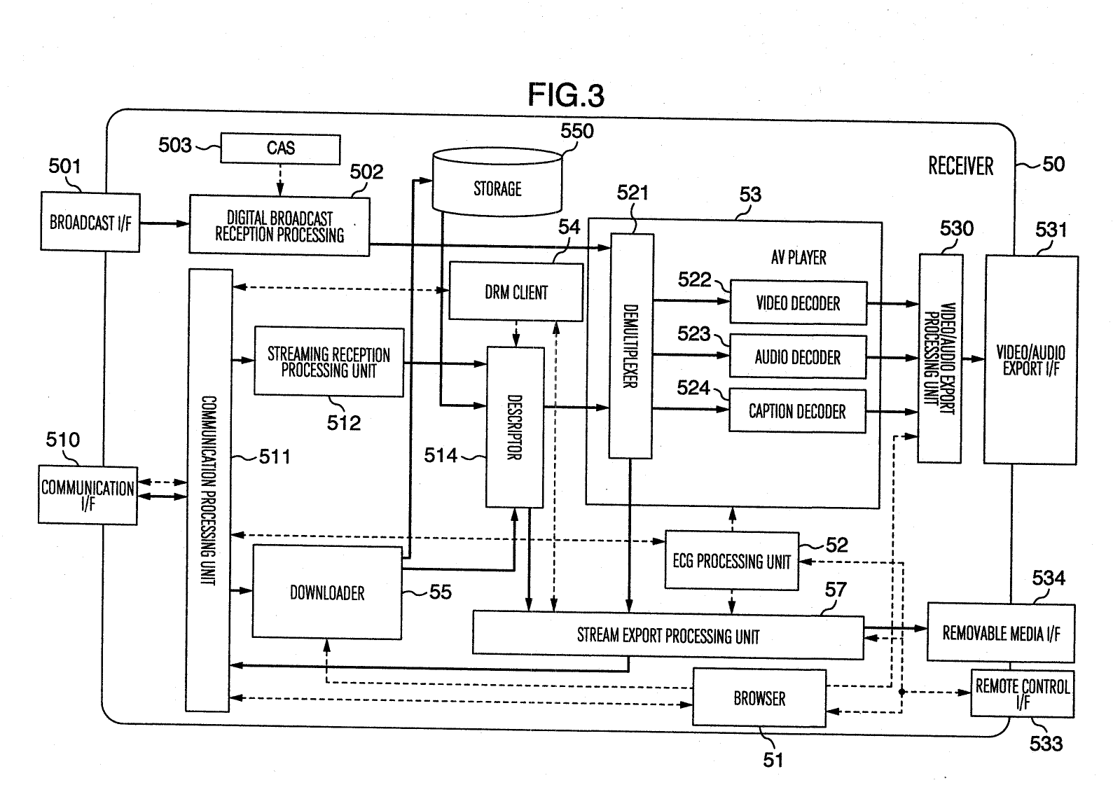

FIG. 3 illustrates a configuration example of the receiver 50.

The receiver 50 can play back received content and export it to a removable medium or network, and further has a storage 550 capable of accumulating content. In the figure, a solid line arrow represents a flow of content, and a dash line arrow represents a flow of control.

The receiver 50 is physically connected to the IP network. Further, the receiver 50 has a communication interface (I/F) 510 which transmits and receives Internet protocol (IP) data packet, and via the communication I/F 510, a communication processing unit 511 which performs processing of various IP communication protocols such as a transmission control protocol (TCP), user datagram protocol (UDP), dynamic host configuration protocol (DHCP), domain name server (DNS), and hyper text transfer protocol (HTTP).

A downloader 55 is a processing unit which performs processing for acquiring content or information related to content. A DRM client 54 manages digital rights of content, and provides a function of viewing content or controlling copies according to purchase conditions of content. A descriptor 514 decodes content to be downloaded based on an instruction from the DRM client 54. A stream export processing unit 57 exports content to a removable medium 560 connected to the receiver 50. In addition, the stream export processing unit 57 exports content to a network connection device 570 connected via the communication processing unit 511 and the communication I/F 510.

The removable medium 560 is an accessible and detachable storage medium via the removable medium I/F 534 connected to the stream export processing unit 57.

The receiver 50 has a remote controller I/F 533 for operation, and is operated by a user in accordance with a remote control signal received thereby.

In addition, there is the possibility that the receiver 50 includes a function of receiving a streaming distribution service of on-demand video and audio content. In this case, the receiver 50 has a streaming reception processing unit 512 which processes real-time reception of the video and audio content via the communication processing unit 511.

An AV player 53 decodes downloaded content, content distributed by steaming distribution, or content in which a broadcast is received, and converts the decoded content into video and audio signals.

The AV player 53 internally has a demultiplexer 521. The processing unit separates content decoded by the descriptor 514 into video, audio, and caption packets, and supplies each packet to a video decoder 522, an audio decoder 523, and a caption decoder 524. By the above-described decoders 522, 523, and 524, information on the video, audio, and caption is decoded, respectively, and converted into integrated video and audio signals by a video and audio export processing unit 530. The video and audio signals are externally exported from the receiver 50 via a video and audio export I/F 531.

Therefore, when a TV set is connected to the video and audio export I/F 531, a user can view content including video and audio.

The video and audio export processing unit 530 and the video and audio export I/F 531 are also considered to be an interface of HDMI (trademark) specifications to integrate, process, and export the video and audio. Further, there is also assumed an example of a video composite signal export and analog audio export as exported externally by independently processing the video and audio.

Further, the receiver 50 may simultaneously has functions of receiving and recording digital broadcast programs. In that case, the receiver 50 has a broadcast I/F 501 which inputs airwaves, a digital broadcast reception processing unit 502 which decodes a digital broadcast signal and converts the decoded signal into a video/audio stream, and a conditional access system (CAS) 503 which performs digital rights protection processing at the time of decoding digital broadcast signals.

The receiver 50 can export the downloaded content directly to the stream export processing unit 57, and to the removable medium 560.

Further, the receiver 50 can store the downloaded content in the storage 550 once. In this case, the stream export processing unit 57 then exports the content acquired from the storage 550 to the removable medium 560 by using an operation of the receiver 50.

Even in a configuration having the storage 550, the receiver 50 may perform either of one process in which content is not stored in the storage 550 but exported, and another process in which content is once stored in the storage 550 and exported.

In this case, even when the receiver 50 has the storage 550 such as an HDD, the downloaded content can be exported to the removable medium 560 via the stream export processing unit 57. Therefore, the content is not required to be stored in the storage 550, and even when spacing is small in the recording capacity of the storage, the download can be performed.

Further, in the receiver 50 of FIG. 3, when only a service in which the content is exported directly to the removable medium 560 is performed without going through the storage 550, more inexpensive receiver on which the storage 550 is not mounted can be realized.

The downloaded content is not decoded and once stored in the storage 550 as it is. When the content stored in the storage 550 is played back or exported to the removable medium 560, the DRM client 54 acquires the license 300 from the DRM server 64. Based on a content key 311 described in the license 300, the descriptor 514 can also decode the content stored in the storage 550.

In the case of playing back the content, the descriptor 514 decodes the content and the demultiplexer 521 separates the content into a video, audio, and caption data packets. The video decoder 522, audio decoder 523, and caption decoder 524 decode the respective separated video, audio, and caption data packets. The video/audio export processing unit 530 exports the decoded video and audio to the outside via the video/audio export I/F 531. Through the above processing, a user can view the content.

In the case of exporting the content, the descriptor 514 decodes the content and the stream export processing unit 57 exports the decoded content to the removable medium 560.

All or part of the digital-broadcasting receiving processing unit 502, CAS 503, communication processing unit 511, streaming reception processing unit 512, descriptor 514, demultiplexer 521, video decoder 522, audio decoder 523, caption decoder 524, video/audio export processing unit 530, storage 550, browser 51, ECG processing unit 52, AV player 53, DRM client 54, downloader 55, local navigation 56, and stream export processing unit 57 illustrated in FIG. 3 are converted into an integrated circuit as a processing unit performing each processing to thereby be realized by using hardware.

Further, the digital-broadcasting receiving processing program 502, CAS program 503, communication processing program 511, streaming reception processing program 512, descriptor program 514, demultiplexer program 521, video decoder program 522, audio decoder program 523, caption decoder program 524, video/audio export processing program 530, storage 550, browser program 51, ECG processing program 52, AV player program 53, DRM client program 54, downloader program 55, local navigation program 56, and stream export processing program 57 stored in a storage device such as the storage 550 and memories (not illustrated) are processed by using an arithmetic processor of a central control unit (not illustrated). Through the above processing, each processing of all or part of the above-described programs can also be realized by using software.

For ease of explanation, each processing realized by performing various programs through the central control unit is described by using as a subject each processing unit realized by programs. When realizing each processing unit by using hardware, each processing unit performs each processing as a subject.

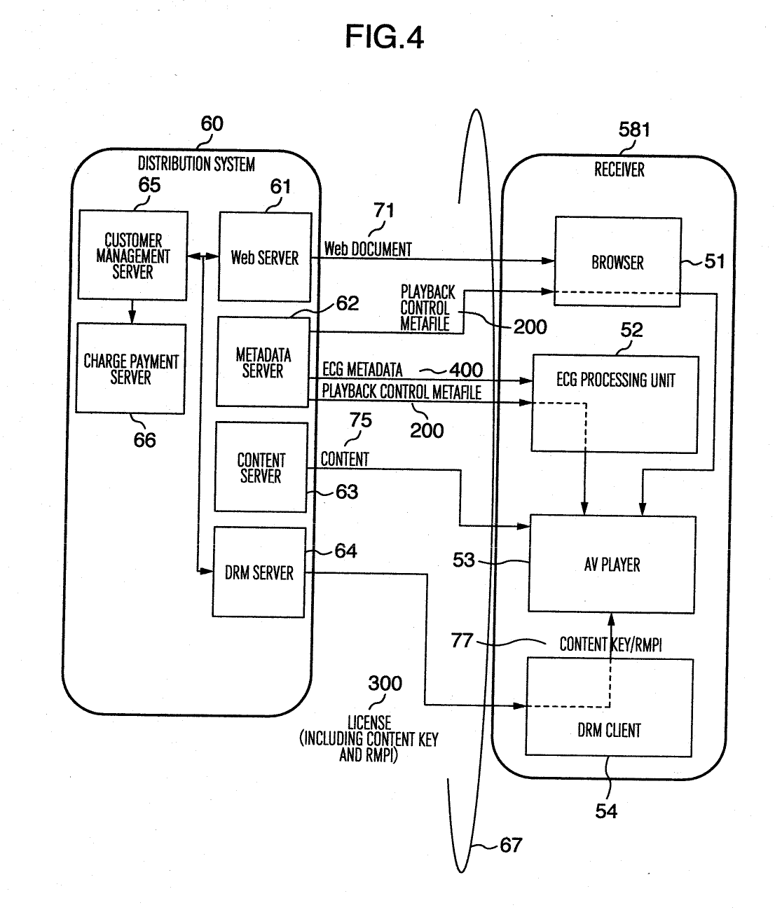

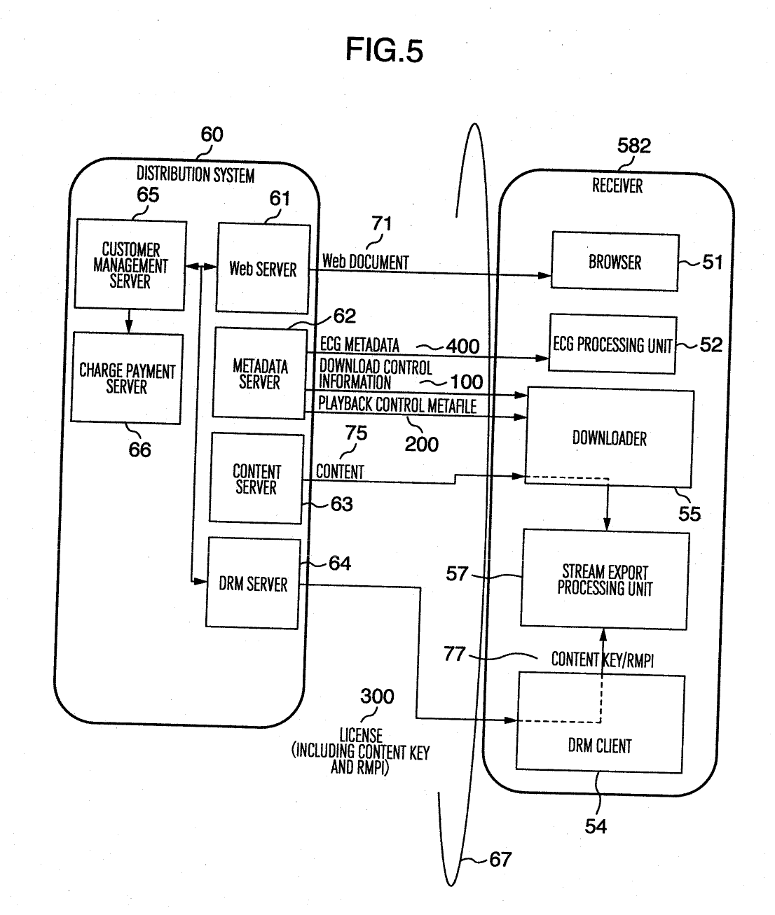

Next, a receiving/delivering relation on data of a content distribution service between the receiver 50 having a system configuration of FIG. 3 and the distribution system 60 of content of FIG. 2 will be described with reference to FIGS. 4, 5, and 6. In FIGS. 4 and 5, only part of blocks used in a flow of a process are displayed from the receiver 50 of FIG. 3. Other processing units of the receiver 50 of FIG. 3 may be included, respectively, and further a configuration illustrated in FIGS. 4 and 5 is not necessarily used. Part of the configuration may be omitted.

A receiver 581 of FIG. 4 is a subset resulting from extracting a block for giving and receiving data to and from a streaming distribution system from the receiver 50 of FIG. 3.

The content distribution system 60 includes the web server 61 which distributes the web document 71, the ECG metadata 400 which describes attribute information on content to be distributed, the metadata server 62 which distributes the playback control metafile 200 describing information necessary for playing back content, the content server 63 which distributes content itself 75, the DRM server 64 which distributes the license 300 including information on a key necessary for decoding content necessary for a right to use of content or use of content, the customer management server 65 which manages customer information of a distribution service, and the charge payment server 63 which performs charging or settlement processing of content through a customer.

For a transmission path 67 in which the above data is communicated between the receiver 581 and the distribution system 60, the distribution network of FIG. 1 is assumed.

In the case of FIG. 4, the browser 51 presents the Web document 71 received from the Web server 61, and retrieves the content 75 desired to be viewed by a user to be found out by operating an operation device such as a remote control. In addition, as another method, there may be provided a method in which the electric content guide (ECG) processing unit 52 of receiver application presents the ECG metadata 400 acquired from the metadata server 62 to a user in a format of ECG and the user retrieves and finds out the content 75 desired to be viewed from the ECG

When a user selects content desired to be viewed and makes a playback instruction of content on the web document 71, the browser 51 acquires from the metadata server 62 the playback control metafile 200 in which a reference destination is described in the web document 71 and requests playback to the AV player 53. Alteinatively, when the user makes a playback instruction of content on the ECG displayed by the ECG processing unit 52, the ECG processing unit 52 acquires from the metadata server 62 the playback control metafile 200 in which a reference destination is described in the ECG metadata 400 and requests playback to the AV player 53.

According to contents of the playback control metafile 200, the AV player 53 acquires, from the DRM client 54, signal export limitation and copy control information called a content key and right management and protection information (RMPI) described in the license 300 of the content. Further, the AV player 53 sets the content key in the descriptor 514 and sets export conditions such as video and audio in the video/audio export I/F 531 according to the RMPI, and performs streaming playback of the content 75 distributed from the content server 63.

The DRM client 54 holds the effective license 300, and when requested from the AV player 53 and the stream export processing unit 57, the DRM client 54 provides the content key and the RMPI from the corresponding license 300. Further, when the requested license 300 is not yet acquired, the DRM client 54 acquires the license 300 necessary for playing back content from the DRM server 64.

A receiver 582 of FIG. 5 is a subset resulting from extracting a block for giving and receiving data to and from a download distribution system from the receiver 50 of FIG. 3.

Also in the case of FIG. 5, the browser 51 presents the web document 71 received from the web server 61, and retrieves the content 75 desired to be viewed by a user to be found out by operating an operation device such as a remote control. In addition, as another method, there may be provided a method in which the ECG processing unit 52 of receiver application presents the ECG metadata 400 acquired from the metadata server 62 to a user in a format of ECQ and the user retrieves and finds out the content 75 desired to be viewed from the ECG

When a user selects content desired to be viewed and makes a download instruction of content on the web document 71, the browser 51 acquires from the metadata server 62 download control information 100 in which a reference destination is described in the web document 71 and makes an execution request of download to the downloader 55. Alternatively, when the user makes a download instruction of content on the ECG displayed by the ECG processing unit 52, the ECG processing unit 52 acquires from the metadata server 62 the download control information 100 in which a reference destination is described in the ECG metadata 400 and makes an execution request of download to the downloader 55.

The downloader 55 acquires the playback control metafile 200. According to contents of the playback control metafile 200, from the DRM client 54, the downloader 55 acquires signal export limitation and copy control information called a content key and right management and protection information (RMPI) described in the license 300 of the content. Further, the downloader 55 sets the content key in the descriptor 514 and sets export conditions such as video and audio in the removable medium 560 and network connection device 570 as an export destination according to the RMPI. The downloader 55 downloads the content 75 distributed from the content server 63 and exports content decoded by the descriptor 514 to the stream export processing unit 57 to thereby perform export processing.

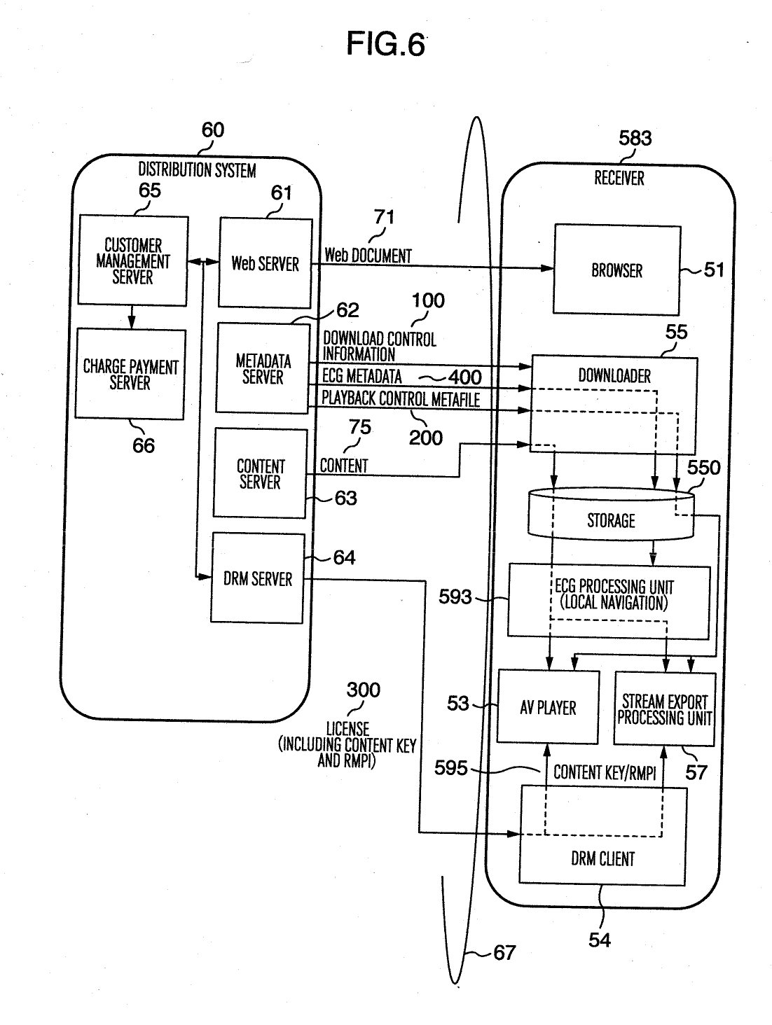

As a receiver 583 of FIG. 6, a block for giving and receiving data to and from a download distribution system via the storage 550 is extracted and described from the receiver 50 of FIG. 3.

In the case of FIG. 6, the browser 51 presents the web document 71 received from the web server 61, and retrieves and finds out the content 75 desired to be viewed by a user by operating an operation device such as a remote control. In the same manner as in FIG. 5, although omitted in the figure, the ECG processing unit 52 of receiver application may present the ECG metadata 400 acquired from the metadata server 62 to the user, and provide a method for retrieving and finding out the content 75 desired to be viewed by the user.

When a user selects content desired to be viewed and makes a download instruction of content on the web document 71, the browser 51 acquires from the metadata server 62 the download control information 100 in which a reference destination is described in the web document 71 and makes an execution request of download to the downloader 55.

The downloader 55 acquires the ECG metadata 400, playback control metafile 200, and content 75 of content to be downloaded, and accumulates them in the storage 550.

The accumulated content 75 can be retrieved, selected, played back, and exported by using application such as the local navigation 56 of the receiver.

When playback of the content is instructed by using the local navigation 56, the AV player 53 is started and the playback is requested. When the export of the content is instructed, the stream export processing unit 57 is started and the export processing is requested.

Next, contents of information to be processed by the receiver will be described in detail.

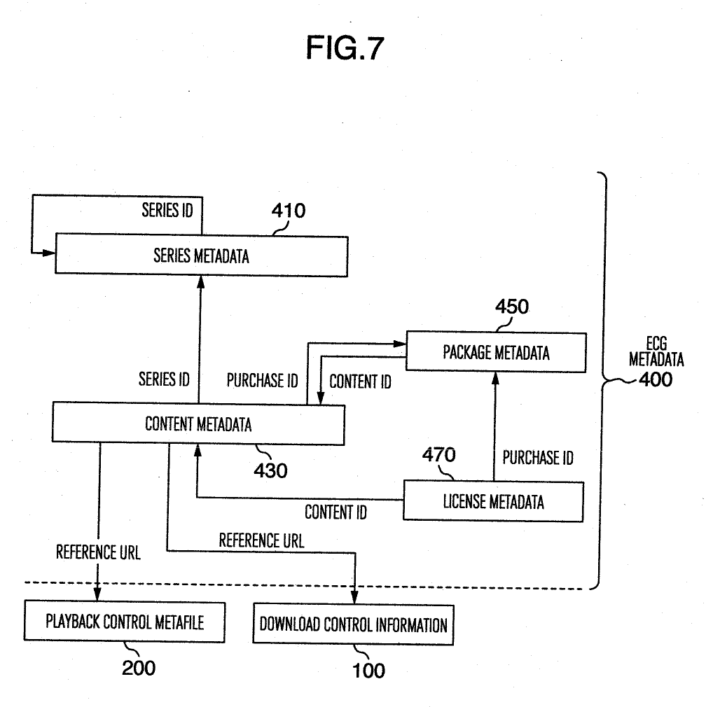

FIG. 7 is a correlation diagram of the ECG metadata 400 presented as the ECG for content retrieval by the ECG processing unit 52. The ECG metadata 400 is described in a format of XML.

The ECG metadata 400 is configured by content metadata 430 in which attribute information such as a name and description of separate distributed programs, video, audio, and genre is described, a series of metadata 410 in which a series of separate programs is grouped and managed to be retrieved, license metadata 470 in which purchased licenses of programs are described, and package metadata 450 in which purchase conditions of programs or grouped programs are described. In the content metadata 430, there can be described a group ID for uniquely discriminating the group metadata 410 to which its program belongs. In the group metadata 410, a hierarchical group configuration can be defined by describing the group ID of the group metadata 410 to which the program itself belongs.

The license metadata 470 has a content ID for uniquely discriminating the content metadata 430 of programs available by its license and a purchase ID for uniquely discriminating the package metadata 450 available as purchase conditions. The content metadata 430 and the package metadata 450 have the purchase ID and content ID corresponding to each other. The content metadata 430 can have reference information for acquiring the playback control information 200 for streaming-playing back content and the download control information 100 for downloading content when the content can be streaming-played back, downloaded, or streaming-played back and downloaded.

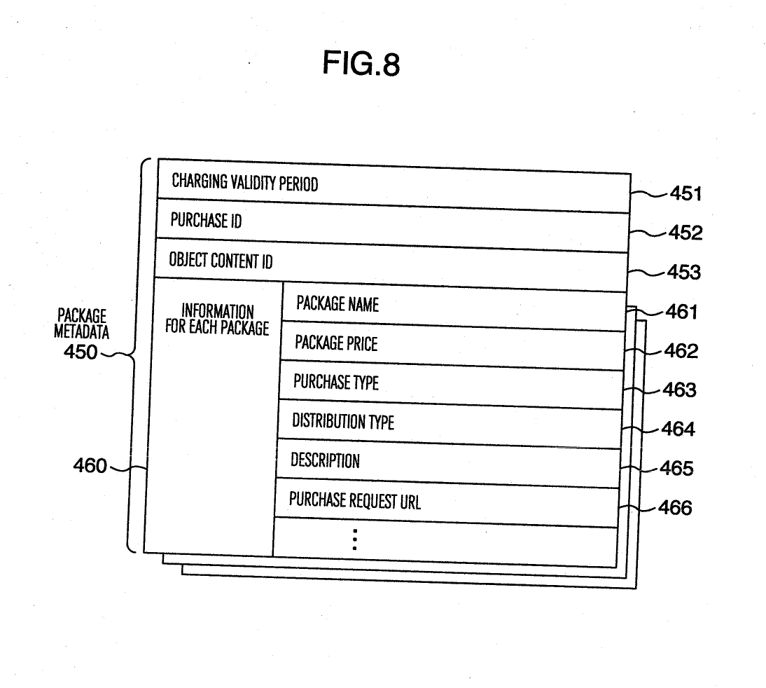

FIG. 8 illustrates a configuration example of the package metadata 450 in the ECG metadata 400.

The package metadata 450 holds a charging valid period 451 describing a start date and time and an end date and time of charging, a purchase ID 452 for uniquely discriminating the package metadata 450, and an object content ID 453 for discriminating content to be purchased of the package metadata 450.

Multiple packages can be described in one package metadata, and the package metadata 450 has the following information about respective packages.

A package name 461, package price 462, and description 465 are information for presenting package contents to a user. A purchase type 463 is information for discriminating a purchase form of a package such as a purchase in a single content type, a purchase of the entire series, or a purchase in monthly contract. A distribution type 464 is information for discriminating a distribution form in a content distribution, such as a streaming distribution, download distribution, or both of them.

A purchase request URL 466 is information describing an access destination of a server for requesting a purchase transaction based on a purchase operation of the user.

That is, the ECG processing unit 52 presents a retrieval screen with reference to the content metadata 430 or group metadata 410. When a user finds out content desired to be used, the ECG processing unit 52 presents purchase conditions of the content to the user with reference to the license metadata 470 of the content and allows the user to perform a purchase operation according to the package metadata 450. In the case where the streaming playback of the content is instructed on the ECG presented by the ECG processing unit 52, the ECG processing unit 52 acquires the playback control information 200 according to URL described in the content metadata 430 and the AV player 53 performs streaming playback according to the description content of the playback control information 200.

In the case where download of the content is instructed on the ECG presented by the ECG processing unit 52, the ECG processing unit 52 acquires the download control information 100 according to URL described in the content metadata 430 and the downloader 55 downloads the content according to the description content of the download control information 100.

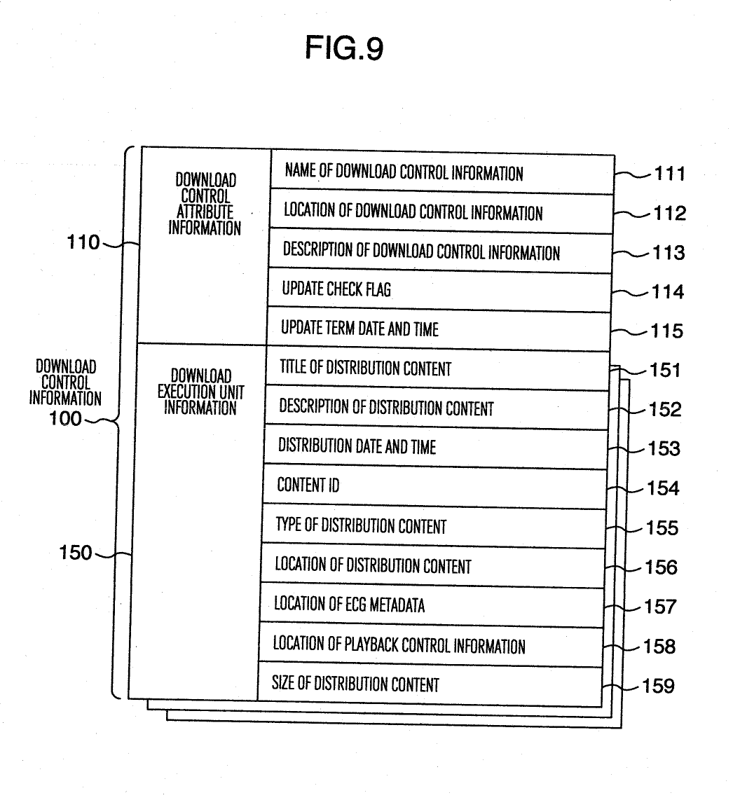

FIG. 9 illustrates a configuration example of the download control information 100. The download control information 100 includes download control attribute information 110 describing contents of a metafile itself and download execution unit data 150 used for downloading one or multiple content.

The download control information 100 is described, for example, in an RDF site summary or really simple syndication (RSS). The download control information can be created (prepared) to arbitrary multiple content within a certain package; however, it fails to be created to multiple packages.

Further, multiple download control information can be prepared to a certain package. Note that the download control information should be prepared so that all content within a package can be necessarily downloaded. The download control information 100 may be updated, and the receiver checks the download control information 100 at a constant frequency and updates a difference. In the case of the RSS, the receiver uniquely discriminates each content by using an enclosure url.

The download control information 100 has information such as a name 111 of download control information representing a name (e.g., a name, file name, and ID of a download reservation) of the corresponding download control information 100, a location 112 of download control information representing a location (For example, it may be a URL on the Internet of a website providing a download reservation. Note that it is not limited to a URL, but may be other addresses. Much the same is true on the locations.) of the corresponding download control information 100, a description 113 of download control information representing a description (e.g., a description and language type about a download reservation) of the corresponding download control information 100, an update check flag 114, and an updated term time and day 115.

The update check flag 114 is a flag which determines whether contents of the download control information 100 on the metadata server 62 is changed, and periodically checked. The update check flag 114 has both of an “updating” value for checking the content and a “single” value failing to periodically check the contents after a first acquisition. The update term date and time 115 is available in the case where the update check flag 114 has an “updating” value, and describes the term date and time for continuing to check an updating of the download control information 100.

The update term date and time 115 indicates the term for monitoring the updating of content. A unit (in units of day, hour, or minute) of the term is arbitrary. The update term date and time 115 can take a value indicating “no term”, namely, a value indicating that the check is semipermanently continued. In addition, as another execution method, when a special value (e.g., all values are zero) of the update term date and time 115 is treated as a “single” value of the update check flag 114, a configuration in which the update check flag 114 is omitted can also be realized.

The multiple download execution unit data 150 can be described in the download control information 100. With regard to each content to be downloaded, the multiple download execution unit data 150 stores information such as a title 151 of distribution content representing a title (may be a program name, or a file name and ID) of the content, a description 152 of the distribution content representing a description (features and remarks) of the content, a distribution date and time 153 representing date and time (may be a unit of day or minute) for distributing the content, a content ID 154 of the distribution content for uniquely discriminating the content on the Internet, a type 155 of the distribution content, a location 156 of the content indicating an acquisition destination URL of the distribution content, a location 157 of an ECG metadata indicating the acquisition destination URL of the ECG metadata corresponding to the content, a location 158 of the playback control information indicating the acquisition destination URL of the playback control information corresponding to the content, and a size 159 of the distribution content.

As one example, the content ID identifier 154 is described by using a character string regulated by a schema referred to as “CRID://authority/content_id”. A portion of authority is a keyword for uniquely discriminating a distributor of the content on the network. In the present embodiment, a domain name managed as a unique name on the Internet is operated as authority.

Here, content_id after authority/ is an ID for uniquely discriminating content within the authority, and a format of the character string may be freely operated by using the authority. Through the above operation, the content on the Internet can be uniquely discriminated by using the content identifier 154. When accessing the content identifier 154 as a URL on the Internet, a user can acquire content as an object and related metadata.

As the distribution date and time 153, there is described a date and time at which the content is normally stored in the content server 63 and disclosed. However, when the download control information 100 is distributed, the content is not yet disclosed and a future date and time to be distributed may be described in the distribution date and time 153. Further, when the distributed content is updated once, the updated date and time is described in the distribution date and time 153.

In the type 155 of the distribution content describes, for example, types of a video, photo, music, program, and multimedia data distributed from a server are described. The video may be further subdivided into a movie, news, and sport, and types of them may be described therein. The music may be further subdivided into a classic, rock, and jazz, and types of them may be described therein.

Metadata for distribution content is attached information necessary for playing back or executing content. As one example, the above-described metadata includes a genre for retrieving content and keyword information. When content is video information, the above includes its thumbnail and chapter information.

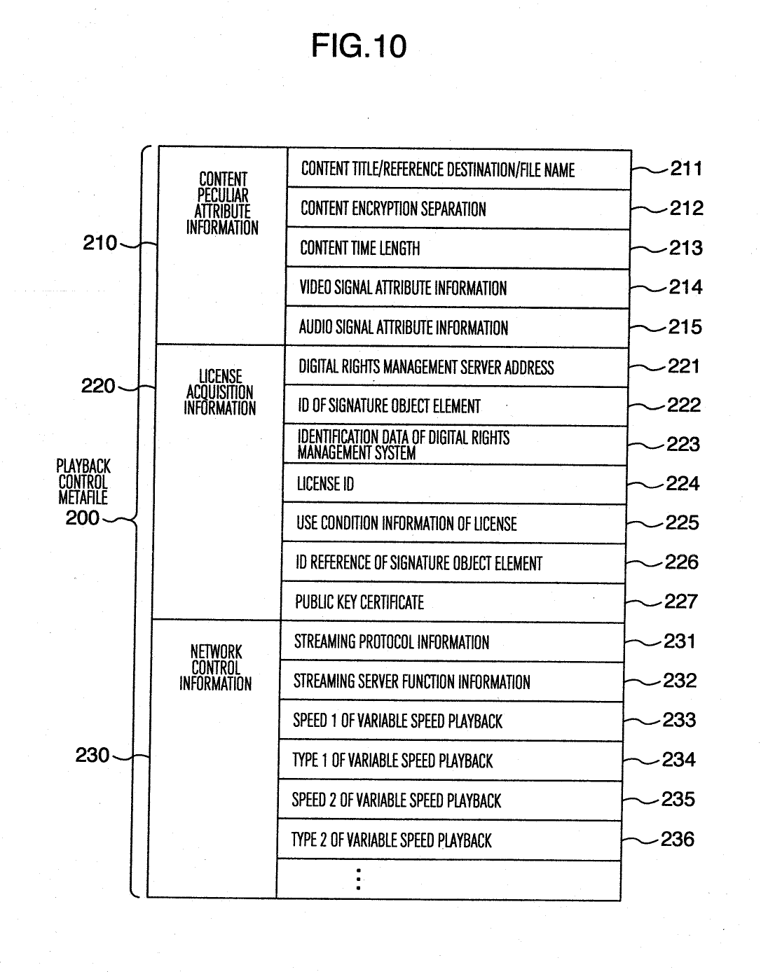

FIG. 10 illustrates a configuration example of the playback control metafile 200. A configuration of the playback control metafile 200 acquired by referring to the download control information 100 will be described.

The playback control metafile 200 includes three XML documents of content peculiar attribute information 210 being information of an AV stream of content itself necessary during the content playback, license acquisition information 220 necessary at the time of accessing a digital rights management server to decrypt a cipher of encrypted content and acquiring a content key for the decoding, and network control information 230 necessary for performing playback control in the case of streaming VOD. Note that the network control information 230 is unnecessary in the case of the download distribution.

The content peculiar attribute information 210 provides a file name and reference destination of a file of content itself 211, discrimination information for determining whether to encrypt content 212, a time length of content 213, attribute information of a video encoding system and a video signal such as resolution, scanning, and aspect ratio 214, and attribute information of an audio signal for discriminating stereo, mono, and multichannel 215.

The license acquisition information 220 of content provides information such as digital rights management server address information being a license acquisition destination of object content 221, type information of a digital rights management system 223, a license ID indicating a type of digital rights protection range attached to content 224, a value and reference destination 226 of a signature object element for verifying a server between a digital rights management server and a receiver as a client 222, use condition information of a license 225, and a public key certificate necessary for verifying a certain signature 227.

The network control information 230 describes information on an available streaming protocol system 231, special playback and program searching system of content 232, information indicating what magnification at each stage when variable speed playback at multiple stages is possible in a server function or various streaming server function information such as interrupted playback can be restarted on the way 233, and information on the playback system 234.

As a playback system, there are supposed a system for preparing and distributing a stream for exclusive use of variable speed playback on the server side, and a system for realizing a pseudo high-speed playback by skipping and playing back a still image included in a normal speed playback stream.

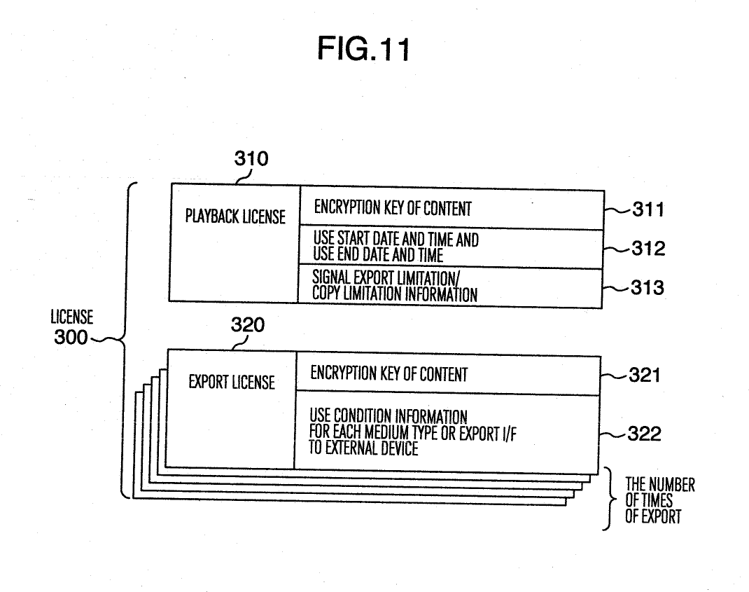

FIG. 11 illustrates a configuration example of the license 300. There will be described a configuration of the license 300 acquired by referring to the download control information 100, or acquired at the time of starting playback of content and at the time of starting export.

Examples of the license 300 include the playback license 310 describing a right for viewing a program and the export license 320 describing a right for exporting content to external media or networks.

The license 300 holds encryption keys 311 and 321 of content necessary for decoding content. In the case of the playback license 310, the license 300 holds a use start date and time and use end date and time 312, signal export limitation, and copy control information 313 during playback. The use start date and time and use end date and time 312 can be specified to an indefinite data and time.

For each exportable medium (or network), in the export license 320, there can be specified use condition information 322 such as a copy limitation and an analog export limitation in the case of exporting content to each medium.

In the export license 320, an export of once by using one license can be performed. Further, N number of export licenses 320 are distributed from the DRM server 64 to the receiver 50 so as to export one content N times.

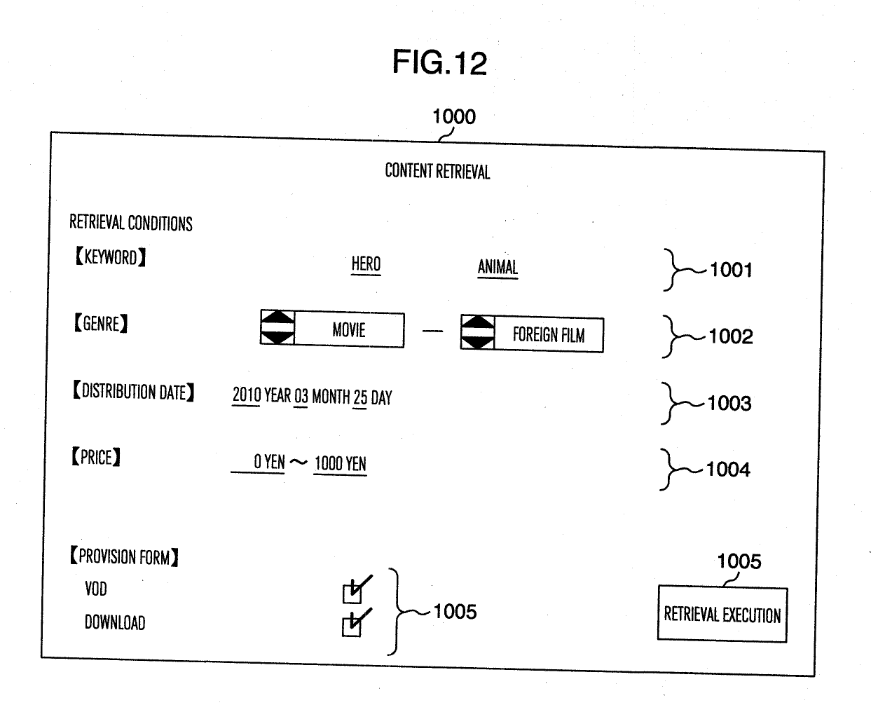

Next, a user interface example of receiver application realized based on the above-described system configuration and data configuration will be described with reference to FIGS. 12 to 19.

FIG. 12 illustrates an example of a content retrieval screen 1000 realized by the ECG processing unit 52.

In this screen started by the remote control, when options such as a keyword 1001, genre 1002, distribution date 1003, price 1004, and provision form 1005, and an input record field are prepared and further a retrieval start 1005 is instructed, the ECG metadata 400 is retrieved according to specification contents of the user.

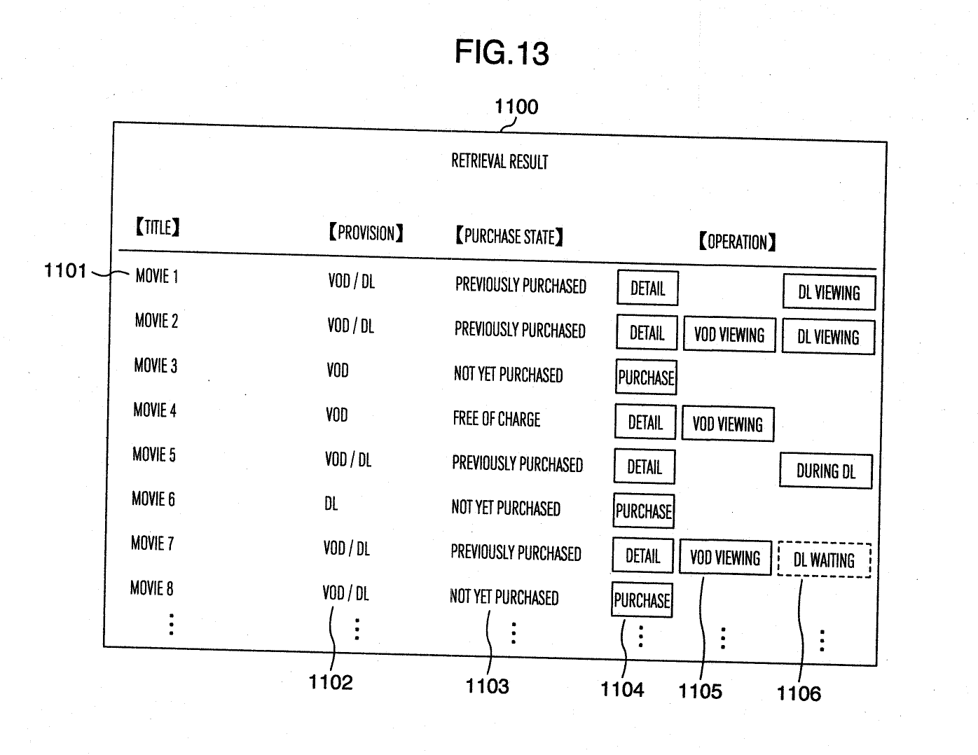

FIG. 13 illustrates a display example of a retrieval result screen 1100 displayed by the ECG processing unit 52. In this example, the ECG processing unit 52 list-displays retrieval results, and displays a title 1101, provision form 1102, and purchase state 1103. As manual operation buttons corresponding to content, the ECG processing unit 52 displays a purchase or detail button 1104, VOD viewing button 1105, and related DL button 1106.

In the provision form field 1102, when content is provided to the package metadata 450 only by a VOD distribution (streaming distribution), “VOD” is assumed to be displayed. When content is provided to the package metadata 450 only by a download distribution, “DL” is assumed to be displayed. When content is provided to the package metadata 450 by both of them, “VOD/DL” is assumed to be displayed. Note that VOD means video on demand.

In the purchase state field 1103, the ECG processing unit 52 presents information managed by the receiver, such as content is previously purchased, not yet purchased by a user, or free of charge.

In the purchase or detail button 1104, when the content is not yet purchased, the “purchase” button is displayed. Further, when the content is not required to be purchased because it is previously purchased, or free of charge, the “detail” button is displayed.

The “VOD viewing” button 1105 is displayed only in the case where the content can be viewed by VOD (streaming), and when this button is selected, the VOD viewing is started.

The related DL button 1106 is displayed only in the downloadable content. When the download is instructed and the content fails to be downloaded according to states, the no-op “DL waiting” button is displayed. When the download is started, the “DL waiting” button is changed into the “during DL” button, and when the download is completed, the “DL viewing” is displayed. When the “DL viewing” button is selected, the downloaded content can be viewed. Even “during DL”, when buffered to some extent, the receiver may be used so as to view content.

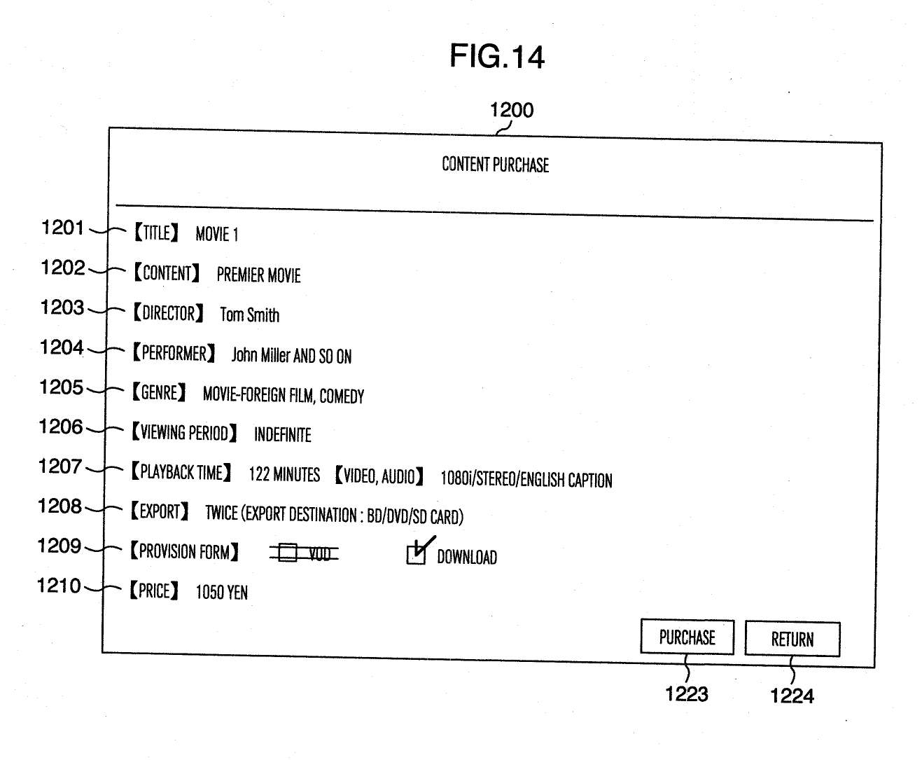

FIG. 14 illustrates an example of a content purchase screen 1200 displayed by the ECG processing unit 52. In the retrieval result screen 1100, in the case of selecting the “purchase” button, the ECG processing unit 52 presents the content purchase screen 1200.

The ECG processing unit 52 presents a title 1201 necessary for purchasing content, contents 1202, director 1203, performer 1204, genre 1205, viewing term 1206, information on playback time or video and audio 1207, information on export destination and the number of exportable times 1208, option of provision form 1209, and price 1210 by using as a base the ECG metadata 400. When the provision form 1209 can be selected, the VOD, download, or both of them can be selected.

In an example of FIG. 14, the “VOD” is displayed to be invalid by using deleted lines, and the “download” is displayed to be valid. Further, the download is displayed to be selected through a check mark by the user.

After the selection, when a “purchase” button 1223 is selected, a purchase transaction of the content is realized between the distribution system and the user.

When a “return” button 1224 is selected, the screen is assumed to be returned to the retrieval result screen 1100.

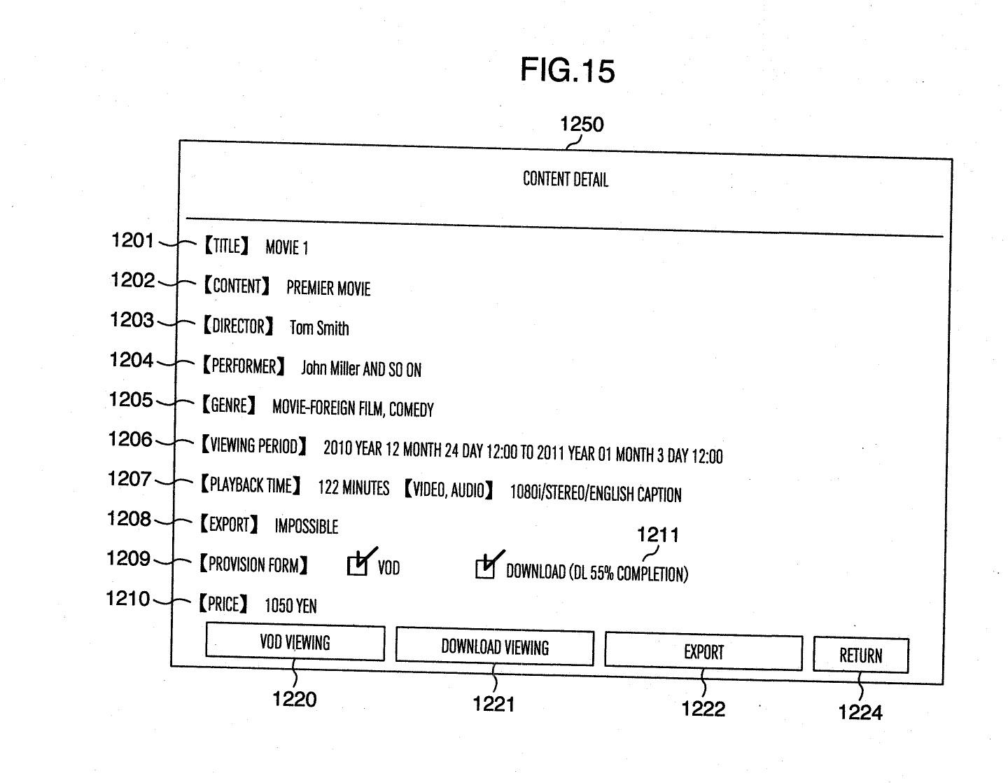

FIG. 15 illustrates an example of a content detail screen 1250 displayed by the ECG processing unit 52. After the content purchase, when the “detail” button is selected on the retrieval result screen 1100, the ECG processing unit 52 presents the content detail screen 1250.

Information on this screen is displayed approximately in the same manner as in the content purchase screen 1200, and since the screen displays a state after the purchase, the “purchase” button 1223 is eliminated. In place of the “purchase” button 1223, buttons such as the “VOD viewing” 1220, “download viewing” 1221, and “export” 1222 are displayed. Further, about content in which each function is effective, a button becomes effective and can be operated.

Further, in the field of the provision form 1209, the content cannot be selected because it is previously purchased, and therefore the provision form of the purchased content is only displayed. When the content can be downloaded and viewed, a progress 1211 of the download may be displayed.

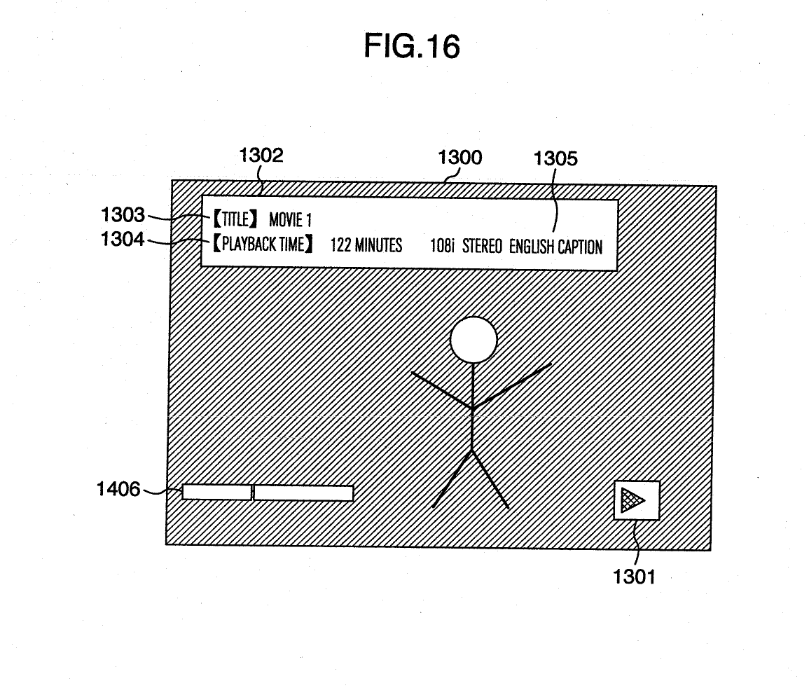

FIG. 16 illustrates an example of a content playback screen 1300 displayed by the ECG processing unit 52. On the content retrieval result screen 1100 or content detail screen 1250, in the case of selecting the VOD viewing or download viewing, the ECG processing unit 52 presents the content playback screen 1300.

Based on the playback control information 200, on the content playback screen 1300, a title 1303, playback time 1304, and detailed information of video and audio 1305 of the content are displayed on a title banner 1302. According to operations via a remote control, operation contents are icon displayed 1301. Further, some receivers display 1406 a current playback position in the entire playback time.

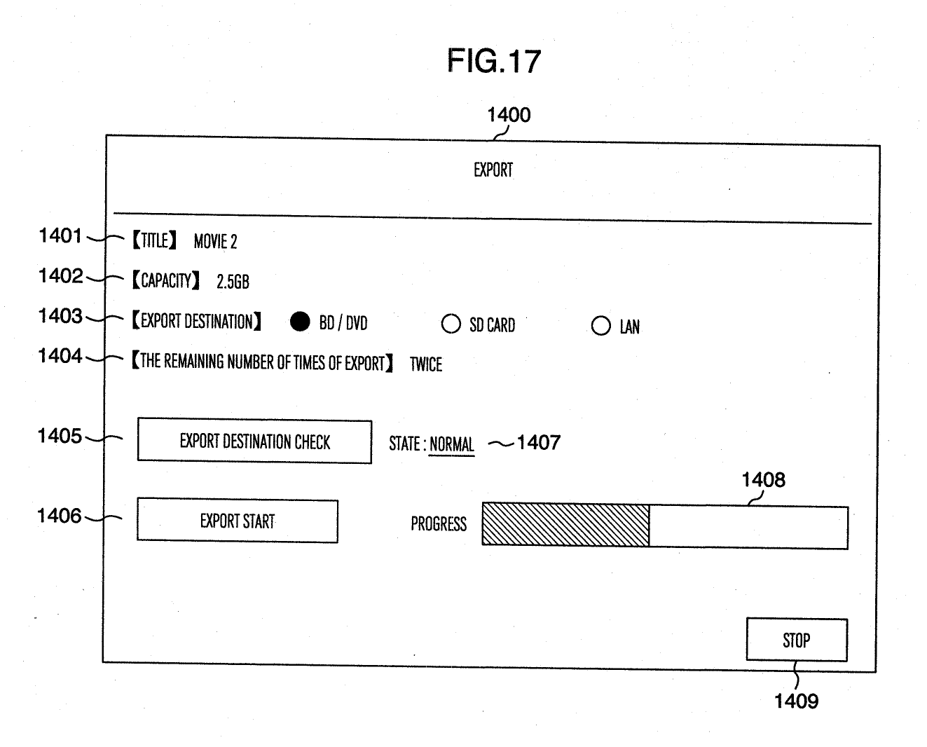

FIG. 17 illustrates an example of an export screen 1400 displayed by the ECG processing unit 52. When an export is instructed on the content detail screen 1250, the ECG processing unit 52 presents the export screen 1400.

Based on the ECG metadata 400, a title 1401 and capacity 1402 of the content are displayed on this screen. Further, an option of permissible export destination 1403 and the remaining number of times 1404 of export managed by the receiver are displayed.

When a user selects an export destination and further an “export destination check” button 1405, there is checked whether content desired to be exported can be recorded on a medium of the export destination. If YES, it is “normal”, and if NO, its cause is displayed on a state field 1407.

Also in the case of selecting the “export start” button 1406, a previous check is performed in the same manner as in the case of selecting the “export destination check” button 1405. If there is a problem, its cause is displayed on the state field 1407. In the case of selecting the “export start” button 1406, if it is normal, the export is started.

Progress of the export is displayed as a progress state 1406. When the export is completed, an export screen 1400 in which the remaining number of times 1404 is reduced by one time is assumed to be displayed.

When the export is stopped before completion of the export and a screen is desired to be returned to the content detail screen 1250, a “stop” button 1409 is selected.

As described above, an ECG screen formed by the ECG processing unit 52 is configured. In another embodiment, in place of the ECG processing unit 52, when presenting the web document 71 acquired from the web server 61, the browser 51 can perform an operation from retrieval to playback of content.

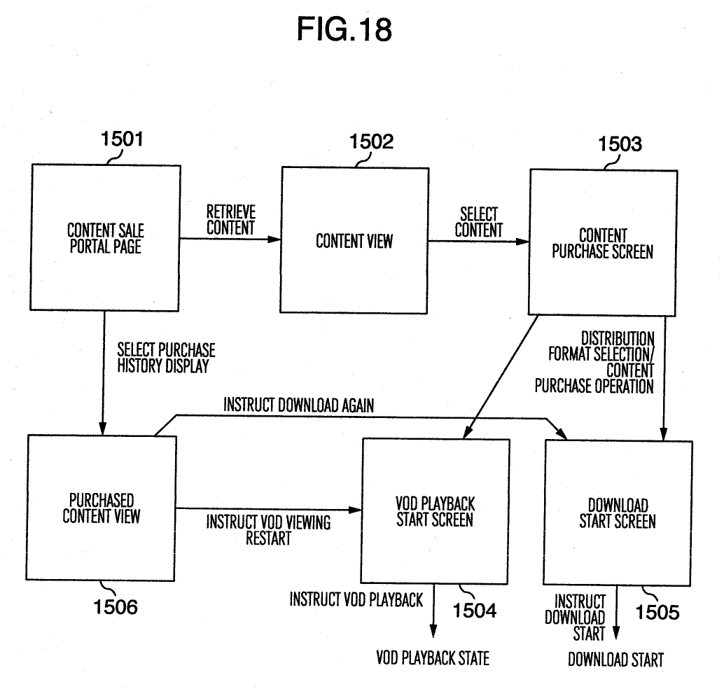

FIG. 18 illustrates a transition example of the web document 71 presented on the browser 51.

When selection of a home page during start of the browser 51 and a bookmark is received, the browser 51 first displays a content sales portal page 1501. Here, when retrieval of the content is instructed, the browser 51 displays as content list page 1502 of the retrieval result. Further, when selecting content from the retrieval result, the browser 51 displays a content purchase page 1503.

On a content purchase screen 1503, when a purchase is selected by using the VOD according to a distribution form in which a distribution form is selected and content is purchased, the browser 51 displays a VOD playback start page 1504. When a VOD playback is instructed, the browser 51 refers to the playback control metafile 200 and displays the content playback screen of FIG. 16.

Further, when a purchase through the download is selected on the content purchase screen 1503, the browser 51 displays the download start page 1505. When instructing a download start, the browser 51 starts a download of the content on the background based on the download control information 100.

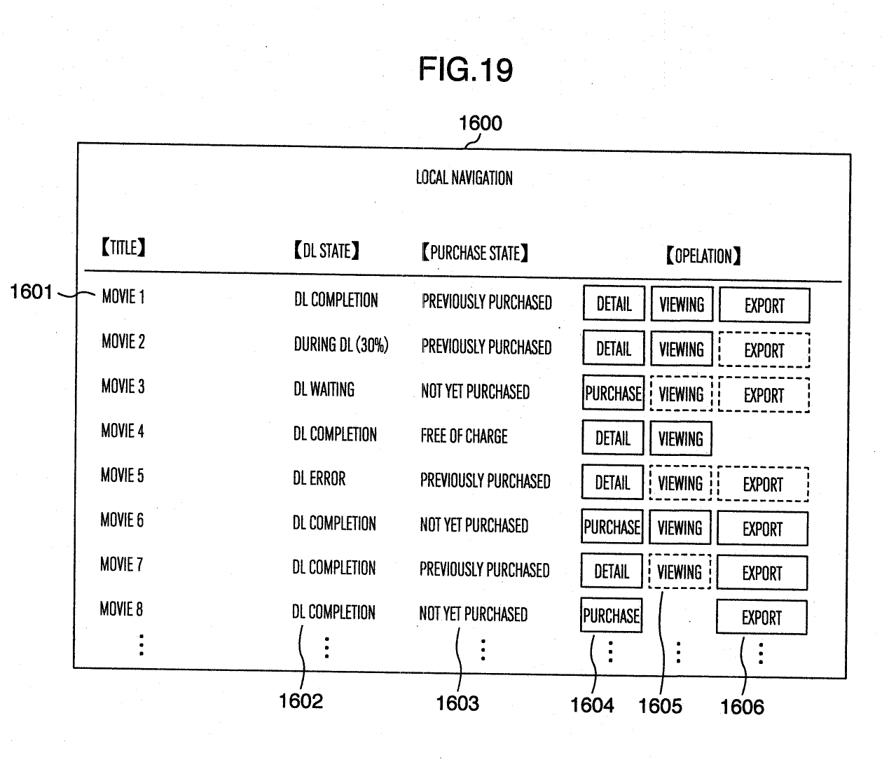

FIG. 19 illustrates a local navigation screen 1600 displayed by the browser 51. A state of the download-distributed content is displayed on the local navigation screen 1600.

On this screen, content in which a download is instructed and downloaded content are displayed in listing. A title of the content 1601, a download state 1602, a purchase state 1603, and a “purchase” or “detailed” button 1604 as an operation button is displayed with respect to content. Further, as purchase conditions, a “viewing” button 1605 is displayed with respect to viewable content and an “export” button 1606 is displayed with respect to exportable content.

In the download state field 1602, there are performed state displays such as “DL waiting” in the seeming download state in which a download is instructed, “during DL” in which a download is started and also its progress is displayed, “DL completion” in which a download is completed, and “DL error” in which an error occurs during the download and which is stopped.

In the purchase state field 1603, states such as not yet purchased, previously purchased, and free of charge are displayed.

With regard to button types, the “purchase” button is displayed with respect to not yet purchased content, and the “detailed” button is displayed with respect to previously purchased content. In the viewing button, when a download is completed or buffering progresses to replayable extent even during the download, the viewing button becomes an effective display and can be selected. Further, when the content turns to an exportable state, the “export” button 1606 becomes an effective display and can be selected.

When the “viewing” button 1605 is selected, the screen transits to the content viewing screen 1300. When the “export” button 1606 is selected, the screen transits to the export screen 1400.

Through the above processing, operations from the retrieval to the playback of content can be performed on the web site.

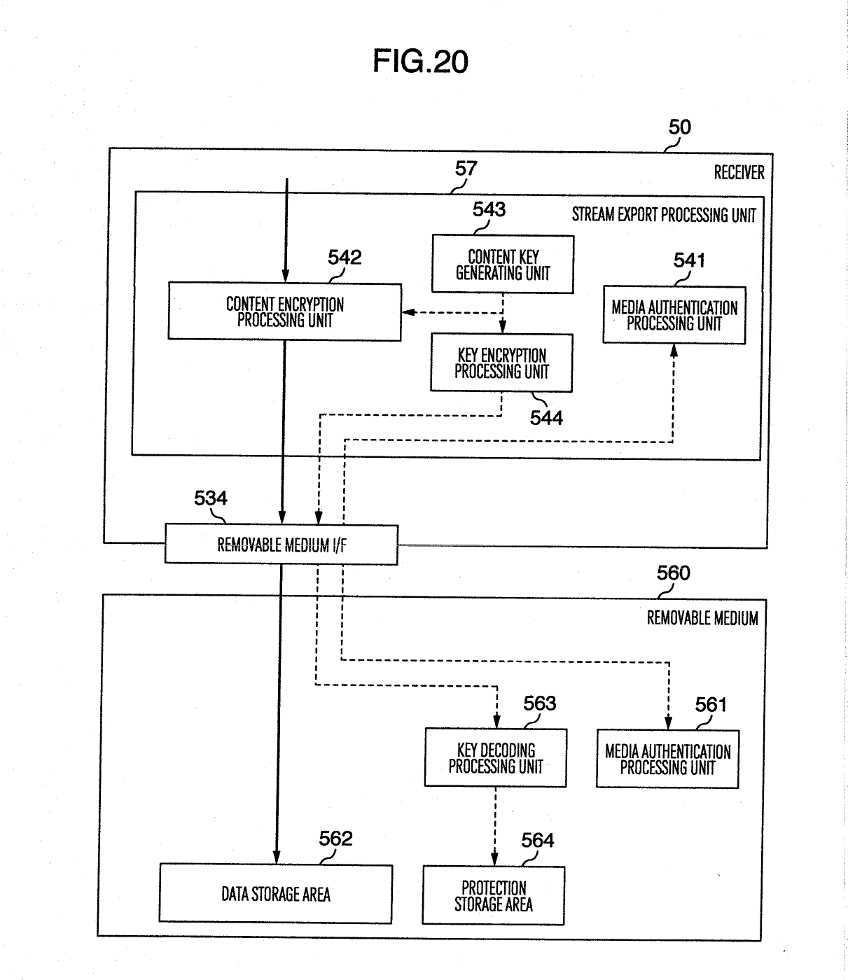

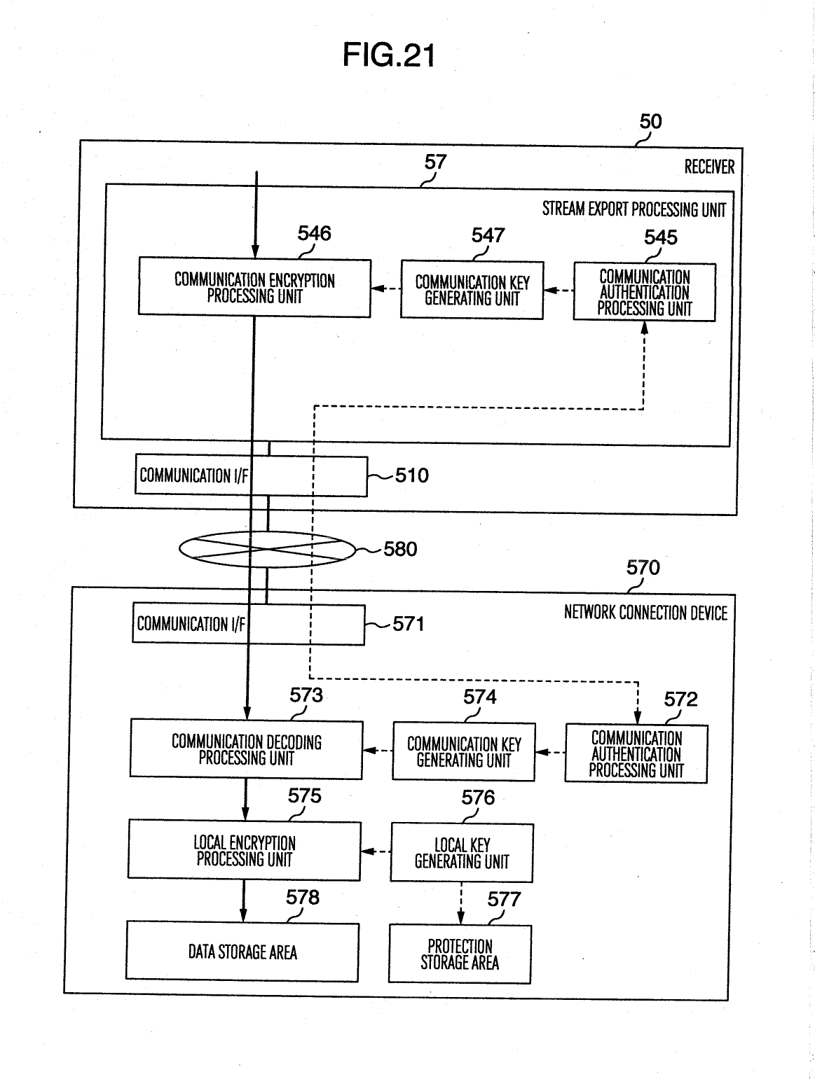

Next, export processing will be described in detail with reference to FIGS. 20 and 21.

FIG. 20 illustrates a configuration example of an interface portion between the receiver and the removable medium. As the removable medium, a removable HDD such as iVDR (trademark) is supposed. However, the removable medium is not limited to the iVDR.

In the figure, a solid line arrow indicates a flow of the content, and a dash line arrow indicates a flow of the control.

FIG. 20 illustrates a configuration example of the stream export processing unit 57 which performs export processing to the removable medium 560 having a digital rights protection function. The stream export processing unit 57 of the receiver 50 includes a media authentication processing unit 541 which performs authentication with the removable medium, a content key generating unit 543 which generates an encryption key for encrypting content to be transferred to a medium, a content encryption processing unit 542 which encrypts the content based on a content key, and a key encryption processing unit 544 which encrypts the generated content key and transfers it to the removable medium.

Content to be supplied to the content encryption processing unit 542 is supplied from the descriptor 514 or demultiplexer 521 of the receiver 50.

All or part of the media authentication processing unit 541, content key generating unit 543, content encryption processing unit 542, and key encryption processing unit 544 illustrated in FIG. 20 are converted into an integrated circuit as a processing unit performing each processing to thereby be realized by using hardware. Further, a media authentication processing program 541, content key generating program 543, content encryption processing program 542, and key encryption processing program 544 stored in the storage 550 or storage device such as memories (not illustrated) are processed by using an arithmetic processor such as a central control unit (not illustrated). As a result, all or part of each processing can be realized by using software.

For ease of explanation, each processing realized by executing various programs through the central control unit will be described by using as a subject each processing unit realized by programs. When each processing unit is realized by hardware, it performs each processing as a subject.

In the removable medium 560 connected via the removable I/F 534, information representing the received content key and use conditions (the number of times of copy and available term) of content is stored correspondingly to the content in a media authentication processing unit 561 which mutually performs authentication with the media authentication processing unit 541 of the receiver 50, a key decoding processing unit 563 which receives and decodes the encrypted content key and takes out the content key, and a protection storage area 564 capable of being read and written only by the receiver 50 with confidence of two-way authentication.

Here, the number of times of copy represents the number of times of the recorded content to be further duplicated. When the number is M, M+1 content can be used in addition to the original content itself. The available term indicates a use term of content in the removable medium, and the following method can be described.

(1) A relative time from a time point at which content is written in the removable medium

(2) A relative time from a time point at which a user first accesses content in the removable medium

(3) Absolute use start date and time and use end date and time (both can be omitted, and the omitted use start date and time and use end date and time are considered to have no limitation)

All or part of the media authentication processing unit 561 and key decoding processing unit 563 illustrated in FIG. 20 are converted into an integrated circuit as a processing unit performing each processing to thereby be realized by using hardware. Further, the media authentication processing program 561 and key decoding processing program 563 stored in the data storage area 562, the protection storage area 564, or memory areas (not illustrated) are processed by using an arithmetic processor such as a central control unit (not illustrated). As a result, all or part of each processing can be realized by using software.

For ease of explanation, each processing realized by executing various programs through the central control unit will be described by using as a subject each processing unit realized by programs. When each processing unit is realized by using hardware, it performs each processing as a subject.

Content encrypted by the media encryption processing unit 542 is stored in the data storage area 562 via the removable I/F 534.

In the media authentication processing unit 541, there are considered a case of authenticating reliability of the removable medium 560 and a case of authenticating reliability of both the removable medium 560 and the receiver 50 having the removable I/F 534.

When reading out the content stored in the removable medium 560, the mutually authenticated receiver 50 reads out a content key of the content from the protection storage area 564. Further, the content read out and encrypted from the data storage area 562 is decoded by using the content key in the receiver 50 to thereby be used.

FIG. 21 illustrates a configuration example of an interface portion between the receiver and the network connection device. FIG. 21 illustrates a configuration example of the stream export processing unit 57 which performs export processing via a network having a digital rights protection function. In this case, the stream export processing unit 57 of the receiver 50 includes a communication authentication processing unit 545 which performs mutual authentication with the network connection device, a communication key generating unit 547 which generates a communication key for encrypting content based on a common key replaced during the authentication, and a communication encryption processing unit 546 which encrypts content based on the generated communication key and sends out the encrypted content via the communication I/F 510.

All or part of the communication authentication processing unit 545, communication encryption processing unit 546, and communication key generating unit 547 illustrated in FIG. 21 are converted into an integrated circuit as a processing unit performing each processing to thereby be realized by using hardware. Further, a communication authentication processing program 545, communication encryption processing program 546, and communication key generating program 547 stored in the storage 550 or storage device such as memories (not illustrated) are processed by using an arithmetic processor such as a central control unit (not illustrated). As a result, all or part of each processing can be realized by using software.

For ease of explanation, each processing realized by executing various programs through the central control unit will be described by using as a subject each processing unit realized by programs. When each processing unit is realized by using hardware, it performs each processing as a subject.

The network connection device is connected to a network 580 via a communication OF 571, and communicates with the receiver 50.

The communication authentication processing unit 572 performs mutual authentication with the communication authentication processing unit 545 of the receiver 50. The communication key generating unit 574 generates a communication key for decoding content based on a common key replaced during the authentication. The communication decoding processing unit 573 decodes the content received via the communication OF 510 based on the generated communication key.

In an example of FIG. 21, the content decoded by the communication decoding processing unit 573 is encrypted by a local encryption processing unit 575 based on an encryption system of the network connection device 570, and is stored in a data storage area 578 of the network connection device 570. The encryption key at this time is generated by a local key generating unit 576. Further, information indicating a local key corresponding to the content and use conditions (the number of times of copy and available term) of the content is stored in a protection storage area 577 accessible only by reliable devices and software.

All or part of the communication decoding processing unit 573, communication key generating unit 574, local encryption processing unit 575, and local key generating unit 576 illustrated in FIG. 21 are converted into an integrated circuit as a processing unit performing each processing to thereby be realized by using hardware. Further, a communication decoding processing program 573, communication key generating program 574, local encryption processing program 575, and local key generating program 576 stored in the data storage area 578, the protection storage area 577, and memory areas (not illustrated) are processed by using an arithmetic processor such as a central control unit (not illustrated). As a result, all or part of each processing can be realized by using software.

For ease of explanation, each processing realized by executing various programs through the central control unit will be described by using as a subject each processing unit realized by programs. When each processing unit is realized by using hardware, it performs each processing as a subject.

In an example of FIG. 21, the network connection device 570 has the data storage area 578 peculiar to the device. Further, the network connection device 570 may have the removable I/F 534 as in the receiver 50 of FIG. 20 and transfer content received via a network to the removable medium 560 via the removable OF 534. A configuration of the network connection device 570 in that case is pursuant to that of the receiver 50 of FIG. 20.

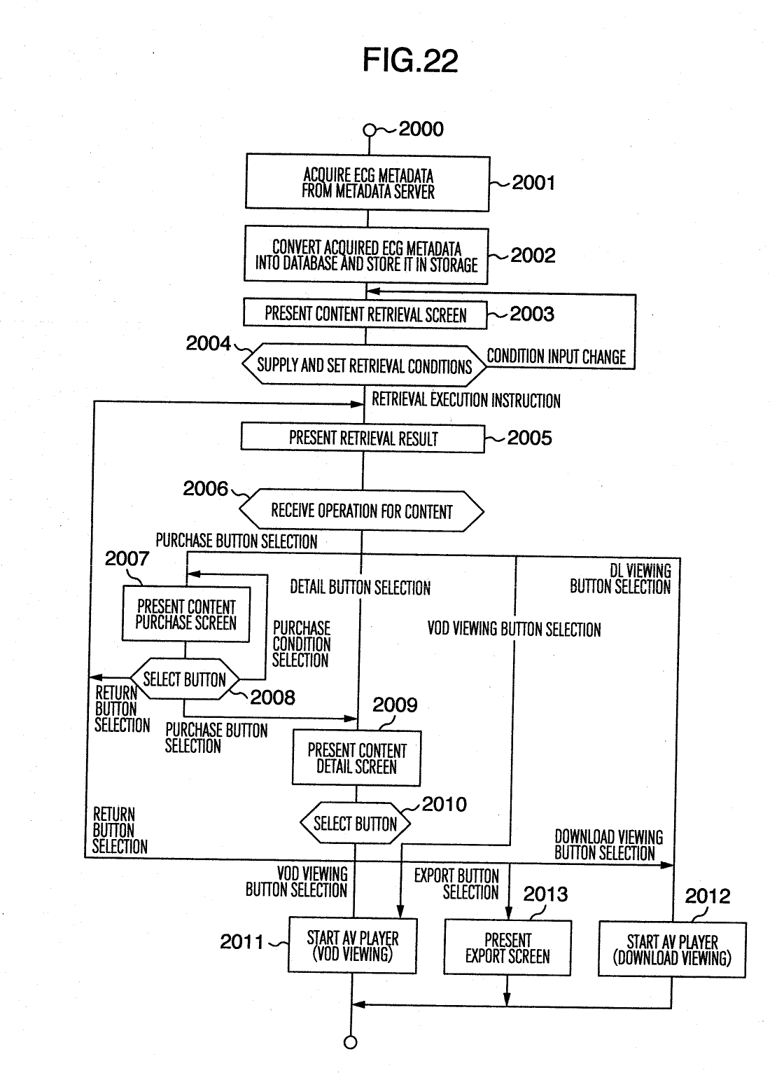

As described above, an example of the receiver corresponding to the content distribution will be described by using an example of the processing performed by the receiver with reference to FIGS.22 to 25.

FIG. 22 illustrates an example of a process flowchart 2000 of the ECG processing unit 52.

The ECG processing unit 52 acquires ECG metadata from a metadata server (S2001: S represents a step). Further, the ECG processing unit 52 makes a database of the acquired ECG metadata into a form easy for data processing, stores it in the storage (S2002), and presents the content retrieval screen 1000 (S2003).

Here, the ECG processing unit 52 supplies and sets retrieval conditions (S2004), and when a user instructs a retrieval execution, the ECG processing unit 52 presents the retrieval result screen 1100. On this screen, the ECG processing unit 52 receives an operation for content (S2006), and when the “purchase button” is selected, the ECG processing unit 52 displays the content purchase screen 1200 (S2007). On this screen, when the user selects purchase conditions and further the purchase button (S2008), the ECG processing unit 52 displays the content detail display screen 1250 (S2009). The content detail display screen 1250 is displayed even when the “detail” button is selected from the retrieval result screen 1100.

When a user selects the “VOD viewing” button from the retrieval result screen 1100, the ECG processing unit 52 starts the AV player 53 and the VOD viewing is started (S2011). When the user selects the “DL viewing” button, the ECG processing unit 52 starts the AV player 53 and the download viewing is started (S2012).

On the content detail display screen 1250, when a user selects the “VOD viewing” button, the ECG processing unit 52 starts the AV player 53 and the VOD viewing is started (S2011). When the user selects the “DL viewing” button, the ECG processing unit 52 starts the AV player 53 and the download viewing is started (S2012). When the user selects the “export” button, the screen transits to the export screen 1400 (S2013).

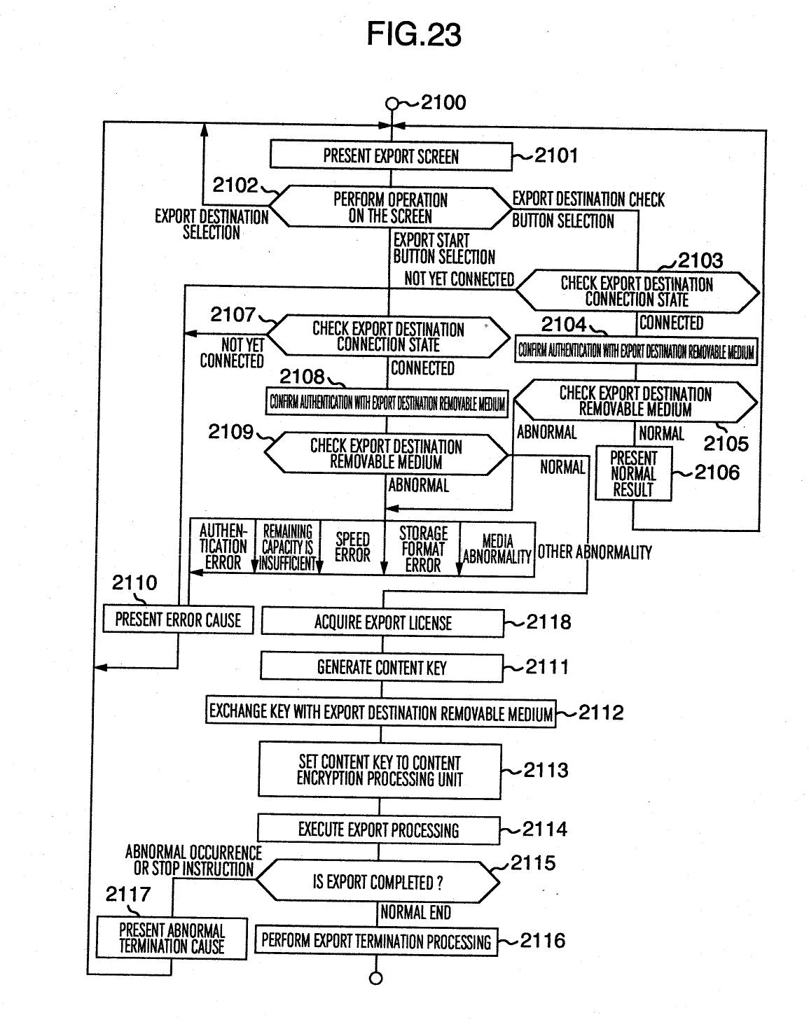

FIG. 23 illustrates an example of a process flowchart of the stream export processing unit 57 in the case of exporting content to the removable medium 560 in the export screen 1400.

After the stream export processing unit 57 presents the export screen 1400 (S2101), a user selects an export destination and further an “export destination check” button by an operation on the screen (S2102). The stream export processing unit 57 checks whether the removable medium 560 is connected to an export destination (S2103). If NO, the stream export processing unit 57 presents an error message indicating that the removable medium 560 is not yet connected to the export destination (S2110).

If YES, the media authentication processing unit 541 then confirms authentication with the removable medium 560 as the export destination (S2104), and performs a detailed check of the removable medium 560 (S2105). Here, if abnormality to describe content is absent, the media authentication processing unit 541 presents a normal result (S2106). If the abnormality is present, the media authentication processing unit 541 presents an error cause (S2110), and the process returns to an operation reception state of an export screen (S2102).

As the error of this time, various causes are considered as follows: for example, an authentication error caused by the removable medium 560 or receiver 50 side, an error in which the remaining capacity necessary for describing content is insufficient, a speed error of the removable medium 560 failing to satisfying a speed necessary for playing back content, a storage format error in the case where a file format regulated by the removable medium 560 is not adapted to content storage, and abnormality in reading and writing of the removable medium 560.

On the export screen 1400, when a user selects the “export start” button, the stream export processing unit 57 checks whether the removable medium 560 is connected to an export destination (S2107). If NO, the stream export processing unit 57 presents an error message indicating that the removable medium 560 is not yet connected to the export destination (S2110). If YES, the stream export processing unit 57 then confirms authentication with the removable medium 560 as the export destination (S2108), and performs a detailed check of the removable medium 560 as the export destination (S2109). Here, if abnormality to describe content is present, the stream export processing unit 57 presents an error cause (S2110), and the process returns to an operation reception state of the export screen (S2102). If the abnormality is absent, the process moves to the export processing.

In the export processing, the DRM client 54 first acquires the export license 320 from the DRM server 64 (S2118). The content key generating unit 543 then generates a content key (S2111). The key encryption processing unit 544 encrypts the generated content key and exchanges the key with the removable medium 560 as the export destination (S2112). The content key generating unit 543 further sets the content key to the content encryption processing unit 542 (S2113). The content encryption processing unit 542 performs the export processing to the removable medium 560 (S2114).

When the content encryption processing unit 542 completes the export processing (S2115), the media authentication processing unit 561 stores the content key and use condition information of the content in the removable medium 560, and updates the file management information in the export termination processing (S2116). The media authentication processing unit 561 enables the reading and writing of the removable medium 560 also in other receivers. Before completion of the export processing, when the export processing is not normally completed due to a stop instruction of a user, and an abnormality occurrence of the removable medium 560, the media authentication processing unit 561 presents the cause of an abnormal termination (S2117), and the process returns to a presentation of the export screen (S2101).

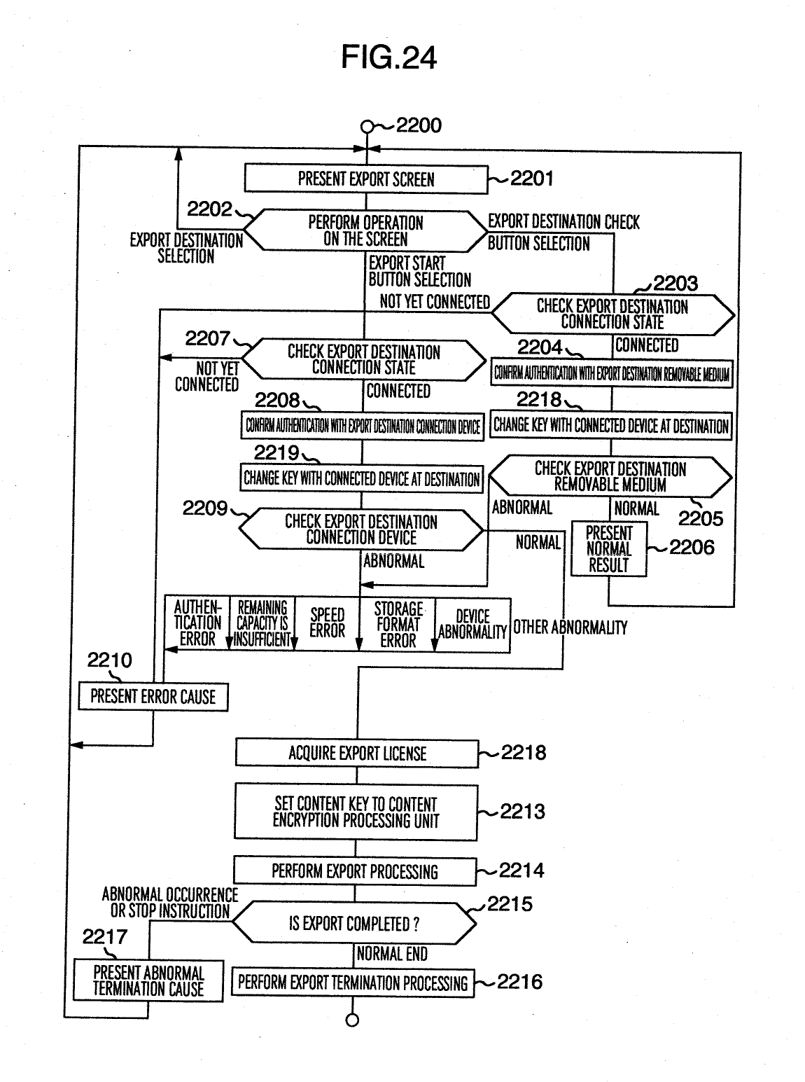

FIG. 24 illustrates an example of a process flowchart of the stream export processing unit 57 in the case of exporting content to the network connection device 570 in the export screen 1400.

After the stream export processing unit 57 presents the export screen 1400 (S2201), a user selects an export destination and further an “export destination check” button by an operation on the screen (S2202). The communication authentication processing unit 545 checks whether the network connection device 570 is connected to an export destination (S2203). If NO, the stream export processing unit 57 displays an error message indicating that the network connection device 570 is not yet connected to the export destination (S2210). If YES, the communication authentication processing unit 545 then confirms authentication with the network connection device 570 as the export destination (S2204), and performs a detailed check of the network connection device 570 (S2105). Here, if abnormality to describe content is absent, the communication authentication processing unit 545 presents a normal result (S2106). If the abnormality is present, the communication authentication processing unit 545 presents an error cause (S2110), and the process returns to an operation reception state of the export screen (S2102).

Also as the error in this case, various causes are considered in the same manner as in the export processing to the removable medium 560: for example, an authentication error caused by the network connection device 570 or receiver 50 side, an error in which the remaining capacity of the network connection device 570 side necessary for storing content is insufficient, a speed error of the network connection device 570 failing to satisfying a speed necessary for playing back content, a storage format error in the case where a file format regulated by the network connection device 570 is not adapted to content storage, and device abnormality of the network connection device 570.

On the export screen 1400, when a user selects the “export start” button, the communication authentication processing unit 545 checks whether the removable medium 560 is connected to an export destination (S2207). If NO, the communication authentication processing unit 545 displays an error message indicating that the removable medium 560 is not yet connected to the export destination (S2210). If YES, the communication authentication processing unit 545 then confirms authentication with the network connection device 570 as an export destination (S2208), and performs a detailed check of the network connection device 570 as the export destination (S2209). Here, if abnormality to describe content is present, the communication authentication processing unit 545 presents an error cause (S2210), and the process returns to an operation reception state of the export screen (S2202). If the abnormality is absent, the process moves to the export processing.

In the export processing, the DRM client 54 first acquires the export license 320 from the DRM server 64 (S2218). The DRM client 54 further sets to the communication encryption processing unit 546 the communication key generated by using as a base the exchanged key during the mutual authentication by the communication authentication processing unit 545 (S2213). The communication encryption processing unit 546 performs the export processing to the network connection device 570 (S2214).

When the export processing is completed (S2215), the stream export processing unit 57 closes the communication session in the export termination processing (S2216). Before completion of the export processing, when the export processing is not normally completed due to a stop instruction of a user, and an abnormality occurrence of the network connection device 570, the stream export processing unit 57 presents the cause of an abnormal termination (S2217), and the process returns to a presentation of the export screen (S2201).

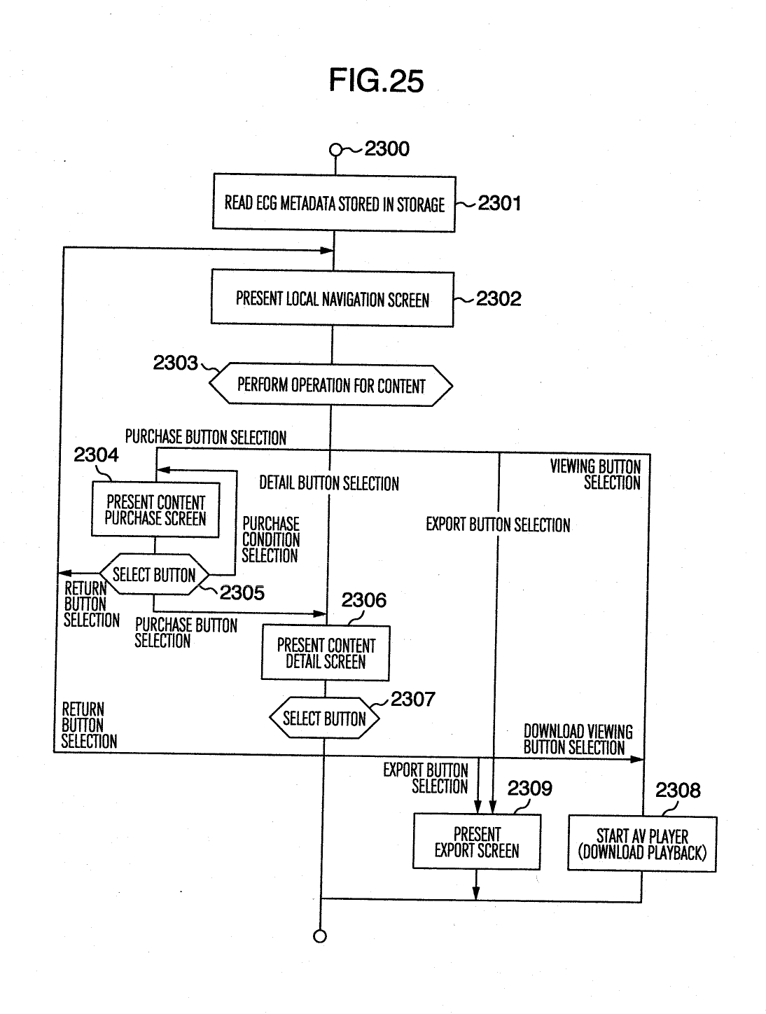

FIG. 25 illustrates an example of a process flowchart of the ECG processing unit 52 on the local navigation screen 1600 of FIG. 19.

On the local navigation screen 1600, the ECG processing unit 52 reads out the ECG metadata on the content of the download distribution stored in the storage unit (not illustrated) (S2301). Based on the above information, the ECG processing unit 52 presents the local navigation screen 1600 (S2302).

In the above-described state, the ECG processing unit 52 receives an operation of the user (S2303). When the user selects the “purchase” button, the ECG processing unit 52 displays the content purchase screen 1200 (S2304). When the user selects purchase conditions and further the purchase button on this screen (S2305), the ECG processing unit 52 displays the content detail display screen 1250 (S2306). The content detail display screen 1250 is displayed also by selecting the “detailed” button from the local navigation screen 1600.

When the user selects the “viewing” button from the local navigation screen 1600, the ECG processing unit 52 starts the AV player 53 and the download viewing is started (S2308). When the user selects the “export” button, the screen transits to the export screen 1400 (S2309).

Also on the content detail display screen, when the “viewing” button is selected based on an operation of the user (S2307), the ECG processing unit 52 starts the AV player 53 and the download viewing is started (S2308). When the “export” button is selected, the screen transits to the export screen 1400 (S2309).

According to the above-described embodiment, the receiver 50 can acquire and view content from the distribution system 60 connected via the network through the ECG displayed on the ECG processing unit 52, the web screen displayed on the browser 51, or the local navigation 1600.

In FIGS. 22 and 25, the case where content is viewed or exported is described with reference to the content retrieval screen generated by the ECG processing unit 52, or the local navigation screen; however, it is not limited thereto. The browser 51 may generate the content retrieval screen or the local navigation screen and perform the same processing. Alternatively, the AV player 53 may generate the content retrieval screen or the local navigation screen and perform the same processing.

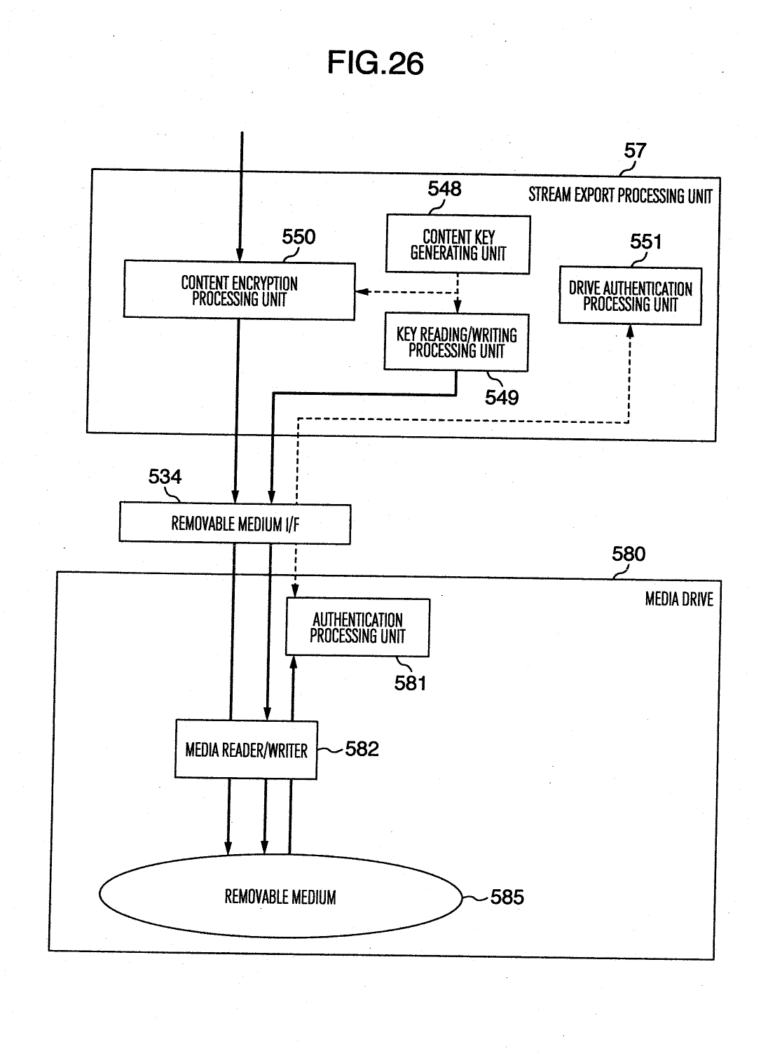

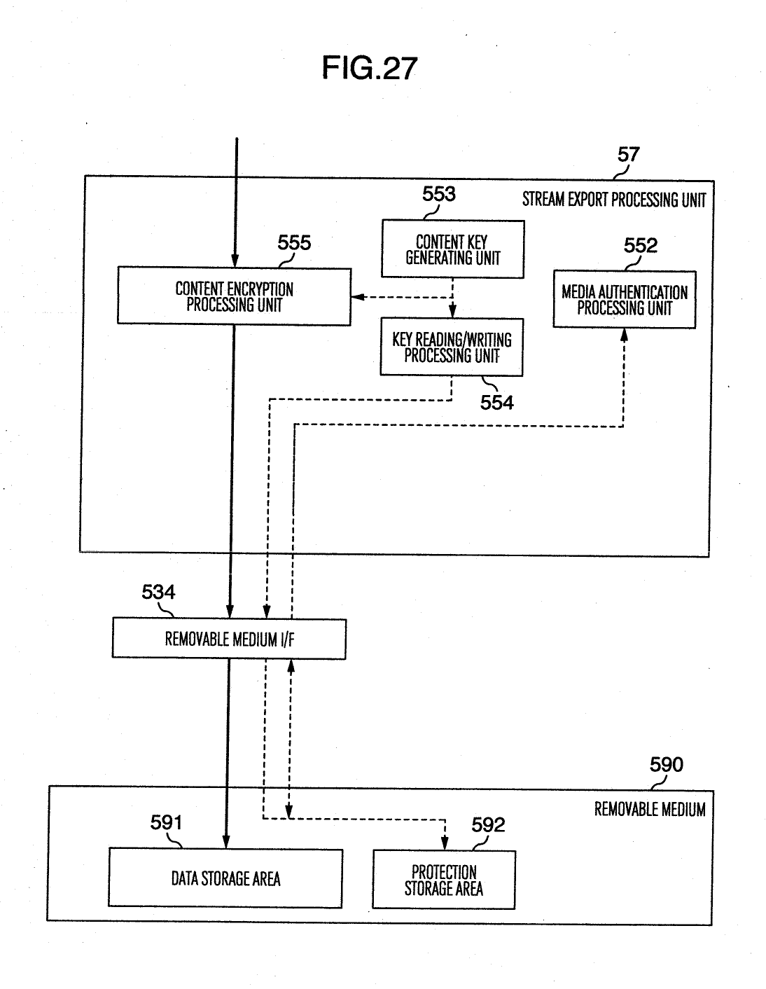

Examples of other removable media used by the receiver 50 are illustrated in FIGS. 26 and 27.

FIG. 26 illustrates an example in the case where the removable medium is an optical disk medium. To the removable medium I/F 534, the media drive 580 is connected, and the removable medium 585 is inserted into the media drive 580 to thereby perform reading/writing via a media reader/writer 582.

The stream export processing unit 57 includes a drive authentication processing unit 551, a content key generating unit 548, a key reading/writing processing unit 549, and a content encryption processing unit 550.

When the removable medium 585 having a digital rights protection function is inserted into the media drive 580 having a digital rights protection function, digital rights-protected content can be read or written. Between an authentication processing unit 581 of the media drive 580 and the drive authentication processing unit 551, the stream export processing unit 57 of the receiver 50 performs authentication processing whether the removable medium 585 and the media drive 580 correspond to the digital rights protection.

After the authentication establishment, the stream export processing unit 57 sets a key generated by the content key generating unit 548 to the content encryption processing unit 550, encrypts the content, and writes the encrypted content in the removable medium 585. Further, through the key reading/writing processing unit 549, the stream export processing unit 57 writes information indicating a media key used for encryption and use conditions (the number of times of copy and available term) of content in the removable medium 585.

All or part of the drive authentication processing unit 551, content key generating unit 548, content encryption processing unit 550, and key reading/writing processing unit 549 illustrated in FIG. 26 are converted into an integrated circuit as a processing unit performing each processing to thereby be realized by using hardware. Further, a drive authentication processing program 551, content key generating program 548, content encryption processing program 550, and a key reading/writing processing program 549 stored in the storage 550 or storage device such as memories (not illustrated) are processed by using an arithmetic processor such as a central control unit (not illustrated). As a result, all or part of each processing can be realized by using software.

For ease of explanation, each processing realized by executing various programs through the central control unit will be described by using as a subject each processing unit realized by programs. When each processing unit is realized by using hardware, it performs each processing as a subject.

All or part of the media reader/writer 582 and authentication processing unit 581 illustrated in FIG. 26 are converted into an integrated circuit as a processing unit performing each processing to thereby be realized by using hardware. Further, a media reader/writer program 582, and authentication processing program 581 stored in the memory areas (not illustrated) are processed by using an arithmetic processor such as a central control unit (not illustrated). As a result, all or part of each processing can be realized by using software.

For ease of explanation, each processing realized by executing various programs through the central control unit will be described by using as a subject each processing unit realized by programs. When each processing unit is realized by hardware, it performs each processing as a subject.

FIG. 27 illustrates an example of the case where the removable medium is a memory card, and the removable medium 590 is connected directly to the removable medium I/F 534.

The stream export processing unit 57 includes a media authentication processing unit 552, a content key generating unit 553, a key reading/writing processing unit 554, and a content encryption processing unit 555.

The removable medium 590 includes a general data storage area 591 and a protection storage area 592 which holds a key for encrypting data. The media authentication processing unit 552 determines, based on the presence or absence of the protection storage area 592, whether the removable medium 590 corresponds to the digital rights protection. After the authentication establishment, the media authentication processing unit 552 sets the key generated by the content key generating unit 553 to the content encryption processing unit 555. The media authentication processing unit 552 encrypts content and writes the encrypted content in the data storage area 591 of the removable medium 590. Through the key reading/writing processing unit 554, the media authentication processing unit 552 further stores information indicating a used media key and use conditions (the number of times of copy and available term) of content in the protection storage area 592.

All or part of the media authentication processing unit 552, content key generating unit 553, content encryption processing unit 555, and key reading/writing processing unit 554 illustrated in FIG. 27 are converted into an integrated circuit as a processing unit performing each processing to thereby be realized by using hardware. Further, a media authentication processing program 552, content key generating program 553, content encryption processing program 555, and key reading/writing processing program 554 stored in the storage 550 or storage device such as memories (not illustrated) are processed by using an arithmetic processor such as a central control unit (not illustrated). As a result, all or part of each processing can be realized by using software.

For ease of explanation, each processing realized by executing various programs through the central control unit will be described by using as a subject each processing unit realized by programs. When each processing unit is realized by hardware, it performs each processing as a subject.

The above-described embodiment permits the receiver 50 to export the received content 75 and digital right-protected content with respect to removable media having various shapes.

### Second Embodiment

In the present embodiment, examples of a distribution system providing a video on demand (VOD) service using streaming and a receiving apparatus receiving the service will be described. In the present embodiment, a receiving apparatus will be mainly described. The present embodiment is preferably applied to the receiving apparatus, and further may be applied to apparatus except the receiving apparatus. Further, all circuit elements of the present embodiment are not necessarily adopted; and selection can be performed therefrom.

<System>

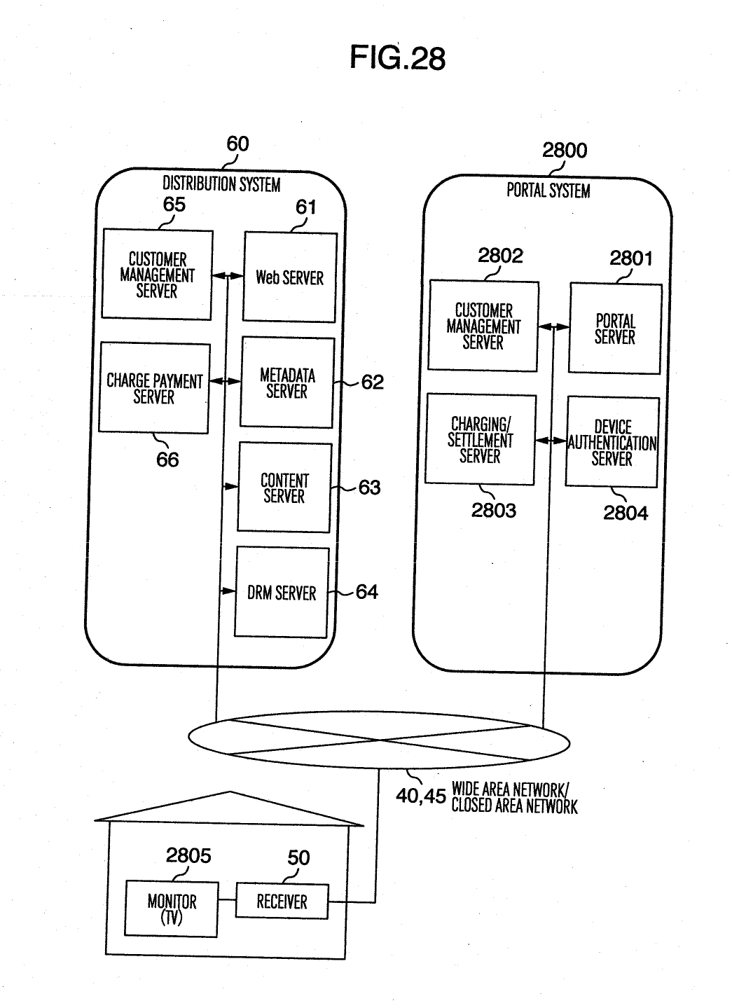

FIG. 28 is a block diagram illustrating a configuration example of a content distribution system. Based on the system configuration illustrated in FIG. 1, the system includes a distribution system 60, a portal system 2800, a receiving apparatus 50, a monitor (display device) 3705, and a wide area network/closed area network (including a content distribution network 40 and the Internet network 45 of FIG. 1).

In the same manner as in FIG. 2, the distribution system 60 includes the web server 61 which distributes data of a web format such as a service menu screen, a content navigation screen, and a sub window screen including an operation button with respect to the receiving apparatus 50; the metadata server 62 which distributes ECG metadata 400 describing attribute information of content and playback control information 200 describing information necessary for playback of content, the content server 63 which distributes (including a streaming distribution and a download distribution) 2D/3D content, the DRM server 64 which distributes a license including information on a right of utilization of content or on a key necessary for decoding of content necessary for utilization, the customer management server 65 which manages customer information of a distribution service, and the charging/settlement server, or the charge payment server, 66 which performs charging and settlement processing of content based on a customer.

Each server of the distribution system 60 is consistently an expedient model, and the real distribution system 60 may have a configuration in which a server obtained by integrating multiple types of servers is used as an entity. On the contrary, the distribution system 60 may have a configuration in which a server used for multiple screens or data distribution as in the web server 61 and the metadata server 62 is divided into types of services or data as a server of an entity.

The portal system 2800 uses as a first connection destination (an entrance to the utilization) various services such as content distribution, shopping, and video phone via a network so that the receiver, or the receiving apparatus, 50 can enjoy the service. Further, the portal system 2800 is assumed to perform induction/bridge to various service systems including the distribution system 60. The above-described system 2800 includes a portal server 2801, a customer management server 2802, a charging/settlement server 2803, and a device authentication server 2804.

When the receiving apparatus 50 starts the browser 51 in order to use a network service, the portal server 2801 distributes to the receiving apparatus 50 data of a web format such as a service navigation screen and content navigation screen.

In the same manner as in the customer management server 65, the customer management server 2802 manages customer information of customers who use services provided by the portal system 2800. Further, the customer management server 2802 performs a portal member authentication in cooperation with the after-mentioned device authentication server 2804.

In the same manner as in the charging/settlement server 66, the charging/settlement server 2803 performs charging and settlement processing of service utilization through customers.

The device authentication server 2804 performs device authentication of the receiving apparatus 50 which accesses the portal system 2800, and confirms that the receiving apparatus 50 is right and accessible to the portal system 2800.

Here, the above-described portal system 2800 may be provided by a service provider which provides the distribution system 60, or a service operation corporation being a third party or the receiving apparatus manufacturer may manage the portal system 2800 independently.

Further, the portal server 2801 and the web server 61, the customer management servers 2802 and 65, and the charging/settlement servers 2803 and 66 each may have a configuration in which an integrated server is used as an entity.

Further, the device authentication server 2804 may be shared between the portal system 2800 and the distribution system 60, and further the distribution system 60 may acquire information of the device authentication server 2804.

<Receiving Apparatus>

The receiving apparatus 50 may have the same configuration as that of FIG. 3.

Further, the receiving apparatus 50 may have the same configuration as those of the receiving apparatus 581 of FIG. 4, 582 of FIGS. 5, and 583 of FIG. 6, if desired. The receiving apparatus 50 is connected to a monitor 2805 via the video/audio export OF 531, and displays a web screen and content received by the receiving apparatus 50 on the monitor 2805. If the monitor 2805 is a device including a means capable of display such as a TV set, a personal computer, a mobile terminal, and a liquid crystal projector; it is not limited thereto. Further, the monitor 2805 may be mounted on the outside of the receiving apparatus 50 or integrated in the receiving apparatus 50. Further, the monitor 2805 may be connected to the receiving apparatus 50 via a communication I/F 510 thereof.

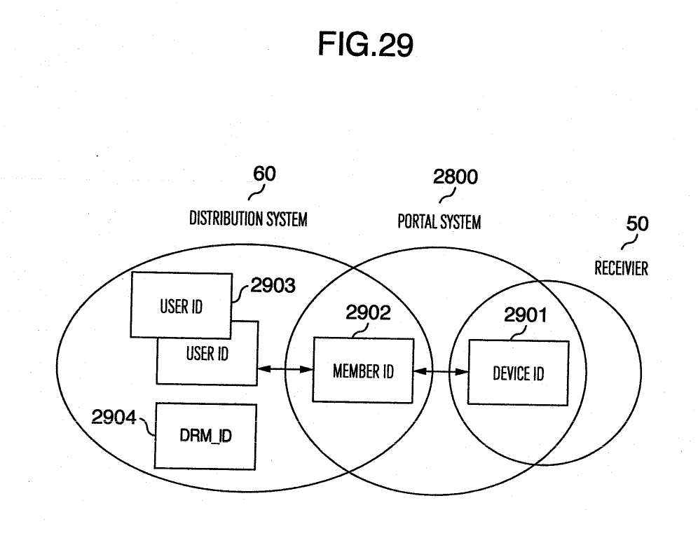

FIG. 29 illustrates a configuration example of customer information managed by the content distribution system and the portal system. Relationships between various IDs in the figure illustrate one example for describing the present embodiment, and utilization of the various IDs in a real service is prevented from being restricted.

The portal system 2800 manages customers by using a device ID 2901 and a member ID 2902.

The device ID 2901 is an ID peculiar to the receiving apparatus 50, and the ID in which the device authentication server 2804 of the portal system 2800 uniquely identifies the receiving apparatus 50 based on the device authentication. This ID may be issued by the portal system 2800. Or, alternatively, an ID obtained by combining and creating one or more information sets such as a model name, manufacturing serial number, and MAC address of the receiving apparatus 50 may be used according to a predetermined rule through the receiving apparatus 50.

In the case where the portal system 2800 issues the device ID 2901, when first accessing the portal system 2800, the receiving apparatus 50 transmits terminal information such as a manufacturer name, model name, manufacturing serial number, and MAC address previously held and managed by the browser 51 of the receiving apparatus 50 to the portal system 2800. The terminal information managed by the browser 51 is secure information written at factory shipment, and may be kept so as not to be changed by a user of the receiving apparatus 50. The portal system 2800 requests the device authentication server 2804 to register the above-described information on the receiving apparatus 50.

In answer to the request, the device authentication server 2804 determines whether the receiving apparatus indicated by the information is stored in the previously held device list (a manufacturer name, model name, and the presence or absence of mounting of streaming or download). If No, the device authentication server 2804 sends back failure of the registration to the portal system 2800. If Yes, the device authentication server 2804 creates the uniquely identifiable device ID 2901 and registers the information and the device ID 2901 to thereby send back a success of the registration and the device ID 2901 to the portal system 2800. The portal system 2800 transmits contents from the device authentication server 2804 to the receiving apparatus 50. Only in the case where the registration is successful, the receiving apparatus 50 records the received device ID 2901 in the storage 550, and uses it for subsequent device authentication.

On the other hand, in the case where the receiving apparatus 50 issues the device ID 2901, when first accessing the portal system 2800, the receiving apparatus 50 creates the device ID 2901 from information such as a manufacturer name, model name, manufacturing serial number, and MAC address held by the browser 51 according to a predetermined rule. Further, the receiving apparatus 50 transmits the device ID 2901 and their information to the portal system 2800.

The portal system 2800 requests the device authentication server 2804 to register the received contents.

In answer to the request, the device authentication server 2804 determines whether the receiving apparatus indicated by the information is present in the above-described previously held device list. If No, the device authentication server 2804 sends back failure of the registration to the portal system 2800. If Yes, the device authentication server 2804 registers received contents and sends back a success of the registration (may include the device ID 2901) to the portal system 2800.

The portal system 2800 transmits contents from the device authentication server 2804 to the receiving apparatus 50. Only in the case where the registration is successful, the receiving apparatus 50 records the received device ID 2901 in the storage 550, and uses it for subsequent device authentication.

The member ID 2902 is an ID for identifying a member using various services provided by the portal system 2800, and an ID issued by the customer management server 2802 of the portal system 2800. The device ID 2901 and the member ID 2902 are assumed to be associated with each other through one to n (n is equal to or more than one).

The distribution system 60 manages customers by using the member ID 2902, user ID 2903, and DRM_ID 2904. The member ID 2902 uses the ID issued by the portal system 2800. The user ID 2903 is an ID independently issued by the distribution system 60 with respect to a member such as a master user ID and a slave user ID, and is used in the case where multiple users share the receiving apparatus 50. The DRM_ID 2904 is an ID for uniquely identifying the DRM client 54 of the receiving apparatus 50, and is used in the case where the distribution system 60 plays back the distributed content through the receiving apparatus 50.

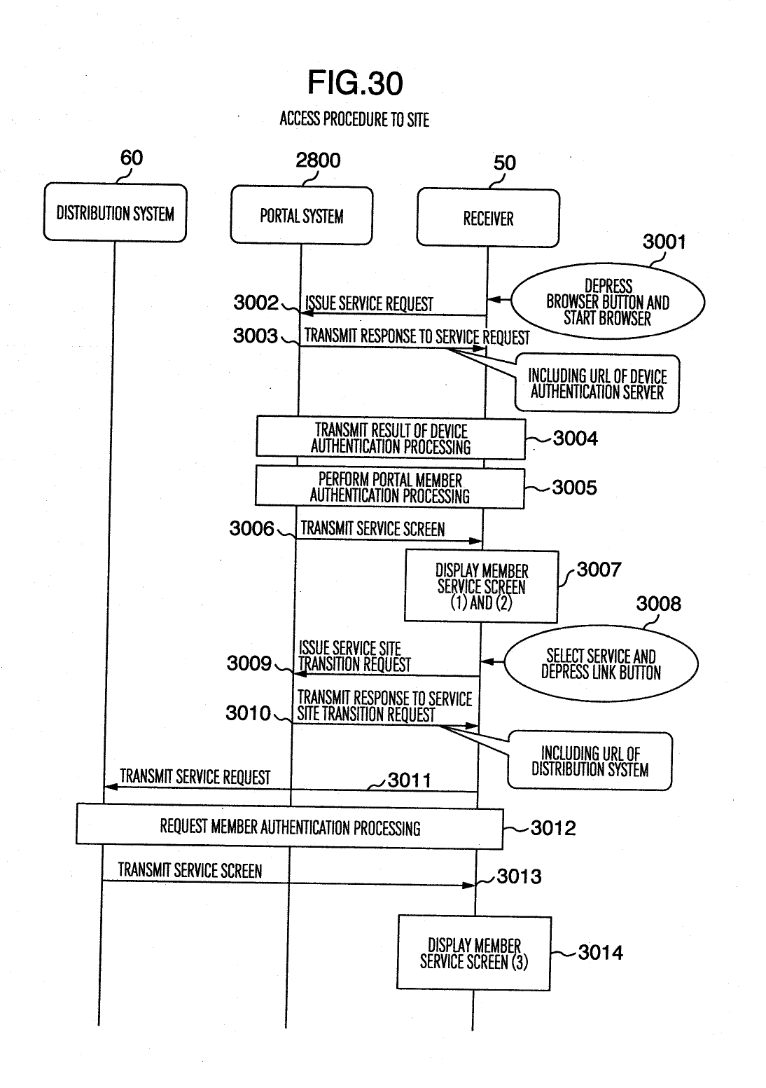

Next, a procedure till the user accesses the portal system 2800 from the receiving apparatus 50 and enjoys content distribution services provided by the distribution system 60 will be described with reference to FIGS. 30 to 33. On the network such as a wide area network/closed area network, when transmitting and receiving at least information necessary for protection such as customer information and the license 300 of content, security of the communication network is assumed to be secured by using existing technology such as a secure socket layer (SSL) and a transport layer security (TLS).

<Procedure of Access to Distribution System>

FIG. 30 illustrates a procedure until an access from the receiving apparatus 50 to the portal system 2800 and further to a site of the distribution system 60.

In order that the user may use various services provided by the portal system 2800 or the distribution system 60, he or she starts a web browser by using a “browser button” of a remote control of the receiving apparatus 50 or an operation button of the main body (step S3001: S represents step).

In answer to the above instruction, the receiving apparatus 50 starts the browser 51 and issues a service request to the portal server 2801 of the portal system 2800 being a previously registered first connection destination. On this occasion, the browser 51 may add attached information such as cookie relating to the portal system 2800 held by the access so far (to the portal system 2800) to the service request for transmission (step S3002).

In answer to the service request, the portal server 2801 of the portal system 2800 transmits a response to the request and information (URL and script) to transit to a site (page) for executing device authentication processing to the receiving apparatus 50 (step S3003).

The browser 51 of the receiving apparatus 50 accesses a site for executing the received device authentication processing, namely, the device authentication server 2804 of the portal system 2800, and executes the predetermined device authentication processing between the both. Here, the above-described device ID 2901 is included into a device authentication request issued to the device authentication server 2804 by the receiving apparatus 50, and further other information (name for identifying a manufacturer or model, and version information) relating to the receiving apparatus 50 may be included thereinto.

Thereafter, to the receiving apparatus 50, the device authentication server 2804 transmits a result of the device authentication processing and a redirect request to the portal server 2801 to be accessed next. On this occasion, the device authentication server 2804 may set a result of the device authentication, the device ID 2901, the date and time at which the device authentication is performed, and cookie including access conditions to the receiving apparatus 50 (step S3004).

The receiving apparatus 50 in which the device authentication processing 3004 is successful accesses the portal server 2801 according to the redirect request from the received device authentication server 2804. On this occasion, the receiving apparatus 50 notifies the portal server 2801 of the device authentication results and cookie contents acquired from the device authentication server 2804.

Along with the device authentication results, the portal server 2801 issues a portal member authentication request to the customer management server 2802. The customer management server 2802 confirms contents of the device authentication results, and determines according to a predetermined authentication procedure whether the receiving apparatus 50 is a portal member. Further, the customer management server 2802 notifies the portal server 2801 of the results.

In addition to the device authentication results, here, the portal server 2801 may issue a portal member authentication request to the customer management server 2802 including the device ID 2901. The customer management server 2802 may determine with reference to the device ID 2901 whether the member ID 2902 is registered (step S3005).

In the case where the receiving apparatus 50 is a portal member based on the determination results received from the customer management server 2802 (namely, in the case where the member ID may be acquired), the portal server 2801 creates a member page corresponding to the member ID and transmits it to the receiving apparatus 50.

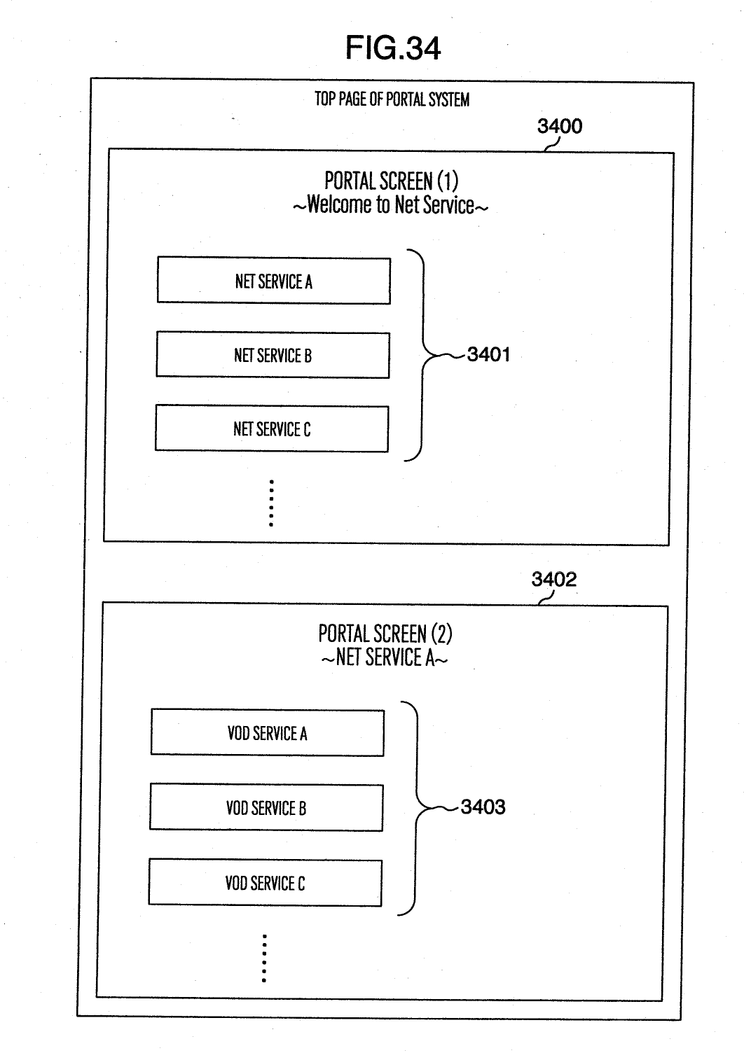

FIG. 34 illustrates an example of a top screen created by the portal system. A screen 3400 illustrates a navigation screen example of the network service first displayed at the time when the user starts the browser 51 in order to use a network service by the receiving apparatus 50. Further, the screen 3400 includes a type 3401 (e.g., a VOD service, net shopping service, and maintenance service) of the network service capable of being provided/bridged by the portal system 2800. The member page created by the portal server 2801 includes data necessary for displaying the screen 3400 and a script for handling the data by using an existing web code such as a hypertext markup language (HTML) and Java (trademark) script.

For example, there is described processing content to be executed or a uniform resource locator (URL) for screen transition at the time when the user selects a desired service on the screen 3400. In subsequent embodiments including the present embodiment, a screen or information created by the distribution system 60 and provided to the browser 51 of the receiving apparatus 50 is assumed to be described by using the above-described existing web code (step S3006).

The browser 51 of the receiving apparatus 50 receiving the member page displays the screen 3400 on the monitor 2805 mounted on the outside of the receiving apparatus 50 or integrated in the receiving apparatus 50. When the user selects, for example, a “net service A” (e.g., VOD service) from the screen 3400, the browser 51 displays a screen 3402 for selecting a link destination 3403 providing the service described in the member page (step S3007).

On the displayed screen 3402, when the user selects a link destination desired to be used to the distribution system 60 (step S3008), the browser 51 of the receiving apparatus 50 issues a transition request to the link destination 3403 selected to the portal server 2801 (step S3009).

The portal server 2801 receiving the transition request transmits information (script including a URL or member ID 2902) for transiting to the selected link destination 4303 to the receiving apparatus 50 (step S3010).

The browser 51 of the receiving apparatus 50 receiving information for transiting to the selected link destination 4303 transmits an access request to a predetermined URL (namely, the web server 61 of the distribution system 60) by using as an argument the member ID 2902 received based on the information (step S3011).

The web server 61 of the distribution system 60 receiving an access request requests the member authentication processing to the customer management server 65 by using the received member ID 2902. The customer management server 65 determines, according to a predetermined authentication procedure based on the member ID 2902, whether the receiving apparatus 50 is a member, and notifies the web server 61 of the results (step S3012).

In the case where the member authentication is successful, here, the customer management server 65 may add information (name and user preference information) relating to the member as well as the presence or absence of registration of the member ID 2902 to the member authentication results.

The web server 61 receiving the member authentication result creates a member page based on information included in the result, and transmits it to the receiving apparatus 50.

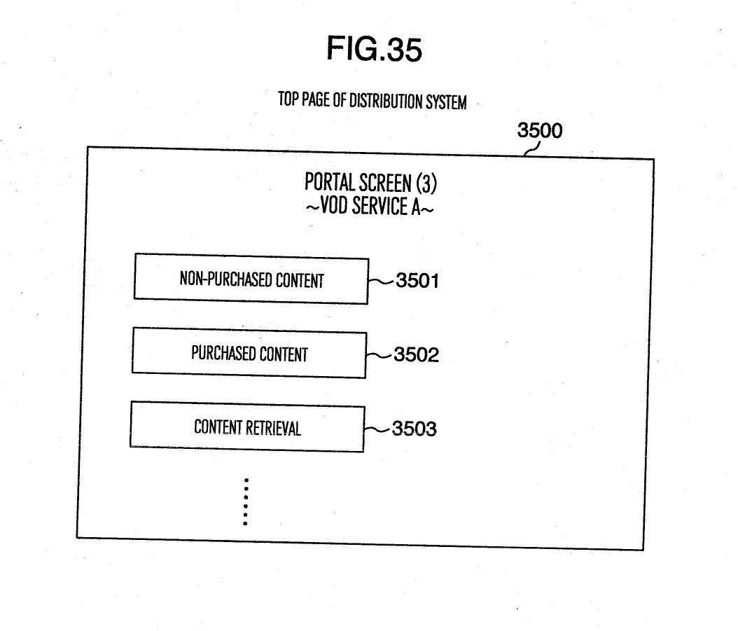

FIG. 35 illustrates an example of a top screen created by the content distribution system. The screen 3500 illustrates a menu screen example of the VOD service provided by the distribution system 60, and includes “non-purchased content” 3501 which is non-purchased currently and for which a purchasable content list of the receiving apparatus 50 is displayed, “purchased content” 3502 for displaying an already purchased content list of the receiving apparatus 50, and “content retrieval” 3503 for retrieving arbitrary content. The member page includes data for displaying the screen 3500, a script for handling the data, and a URL to transit at the time when the user selects any of the screens 3501 to 3503 on the screen (step S3013).

The browser 51 of the receiving apparatus 50 receiving the member page displays the screen 3500 on the monitor 2805 mounted on the outside of the receiving apparatus 50 or integrated in the receiving apparatus 50 (step S3014).

Through the above procedure, the user can access a site of the distribution system 60 from the browser 51 of the receiving apparatus 50.

<Procedure for Purchasing Content>

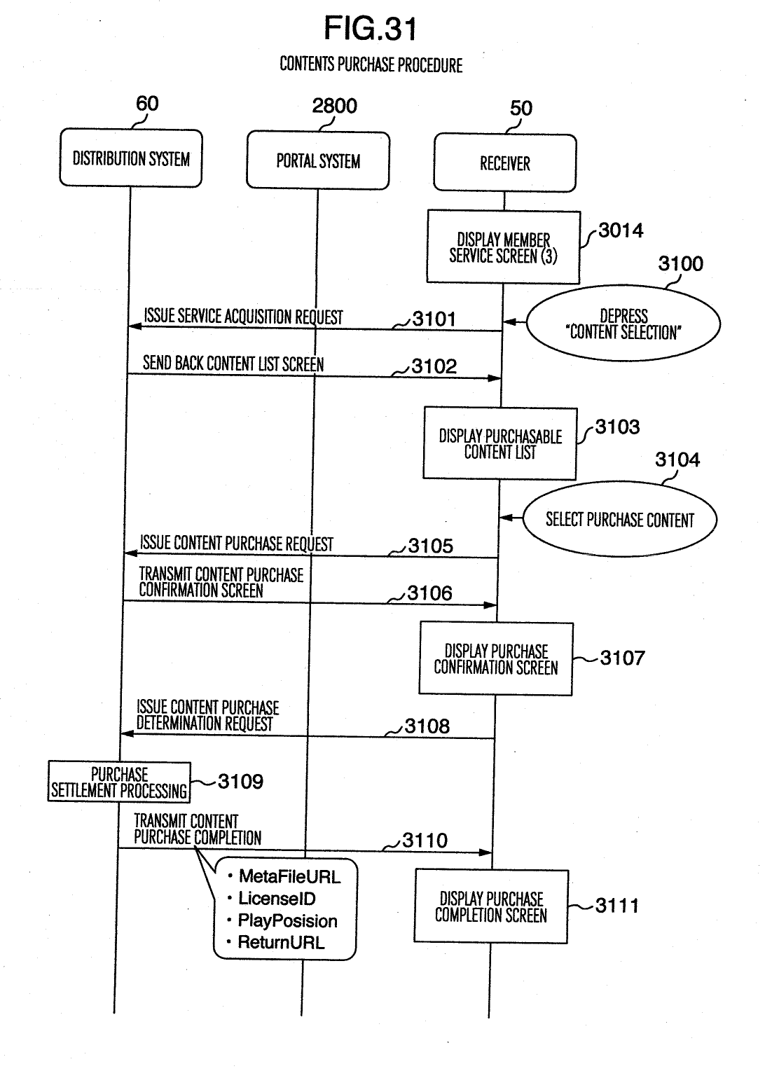

FIG. 31 illustrates an example of a process flowchart in which the receiving apparatus 50 purchases content from the content distribution system.

When the user selects the “non-purchased content” 3501 on the screen 3500 displayed on the monitor 2805 through the browser 51 of the receiving apparatus 50 (step S3100), the browser 51 issues a service acquisition request necessary for displaying a list screen of non-purchased and purchasable content of the receiving apparatus 50 with respect to the web server 61 of the distribution system 60 (step S3101).

In answer to the service acquisition request, the web server 61 of the distribution system 60 performs a device determination of the receiving apparatus 50 based on the member ID 2902 of the receiving apparatus 50, acquires information on the non-purchased and purchasable content of the receiving apparatus 50, creates a non-purchased content list screen, and sends back it.

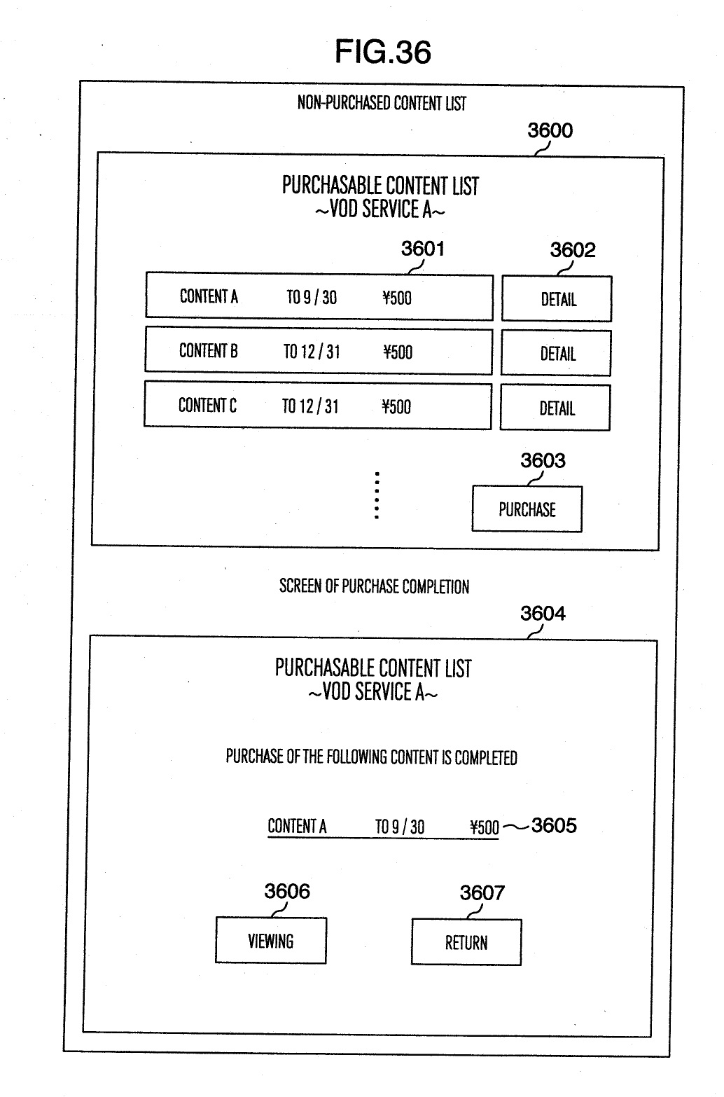

A screen 3600 of FIG. 36 illustrates an example of the non-purchased content list screen created by the distribution system 60. The screen 3600 includes information (a content name, a purchasable term, and a purchase price) 3601 on the purchasable content of the receiving apparatus 50, a button 3602 for displaying detailed information on the content, and a button 3603 for indicating a purchase.

The content list screen includes data for displaying the screen 3600, a script for handling the data, and a URL to transit at the time when the user selects a detail button 3602 of desired content or a purchase button 3603 on the screen (step S3102).

Here, examples of the device determination of the receiving apparatus 50 include a method for acquiring information on the receiving apparatus 50 by using the member ID 2902 to the portal system 2800 through the web server 61, a method for sharing the device authentication server 2804 between the customer management server 65 of the distribution system 60 and the customer management server 2802 of the portal system 2800, and a method for acquiring information on the receiving apparatus 50 at step 3011, 3012, or 3101 of FIG. 30.

The browser 51 of the receiving apparatus 50 receiving content information displays the screen 3600 on the monitor 2805 mounted on the outside of the receiving apparatus 50 or integrated in the receiving apparatus 50 (step S3103).

The user selects content desired to be purchased 3601 on the displayed screen 3600, and depresses the purchase button 3603 (step S3104).

In answer to the above selection, the browser 51 of the receiving apparatus 50 issues a purchase request of the content indicated by the user to the web server 61 of the distribution system 60 by using a URL included in the content list screen (step S3105).

The web server 61 receiving the purchase request transmits the purchase confirmation screen for taking the purchase procedure to the receiving apparatus 50 (step S3106).

The browser 51 of the receiving apparatus 50 receiving the purchase confirmation screen displays the screen on the monitor 2805 (step S3107).

The user confirms purchase terms or purchase procedure displayed on the screen and inputs a user name and a pass word, if desired, and then depresses a purchase confirmation button. In answer to the above, the browser 51 issues a purchase determination request (input user name and pass word may be included) to the web server 61 (step S3108).

The web server 61 of the distribution system 60 receiving the purchase determination request performs purchase and charging processing between the customer management server 65 and the charging/settlement server 66.

When terminating purchase/charging processing, the customer management server 65 notifies the web server 61 of purchase completion. The web server 61 receiving the purchase completion notification creates a license (the contract date and time and the license ID) for purchased content between the customer management server 65 and itself, and associates the license with the member ID 2902 and the DRM ID 2904 (step S3109).

After all of the purchase processing operations are completed, the web server 61 creates the purchase completion screen, and transmits it to the receiving apparatus 50. In a screen 3604 of FIG. 36, one example of the purchase completion screen is illustrated. The screen 3604 includes information 3605 on content in which the purchase is completed, a button 3606 for viewing the content, and a button 3607 for returning to the screen 3600 or 3500.

In addition to data for displaying the screen 3604 and a script for handling the data, the web code of the screen may include an acquisition destination (a URL of the metadata server 62 and a metafile URL) of the playback control metafile 200 of the purchased content, the created license ID (license ID), and an access destination after the end of the viewing (a return URL) (step S3110).

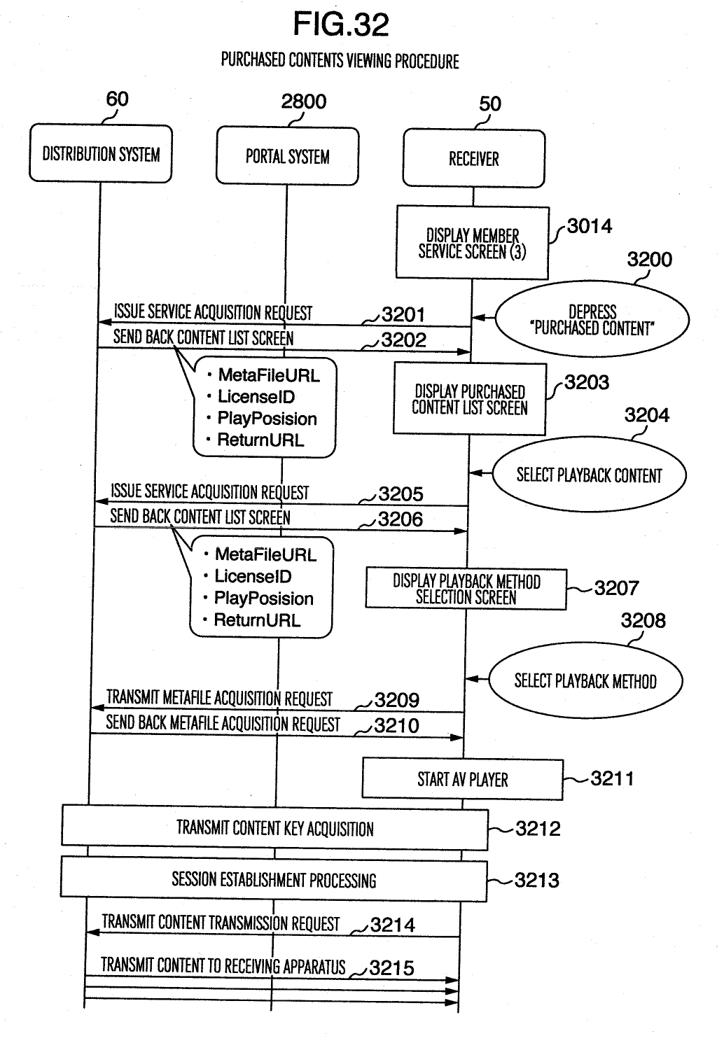

The browser 51 of the receiving apparatus 50 receiving the purchase completion screen displays the screen 3604 on the monitor 2805 (step S3111). Here, when the user selects the viewing button 3606 on the screen 3604, the browser 51 starts the viewing based on procedures of steps S3209 to S3214 of FIG. 32 described subsequently by using information on the metafile URL and play position included in the screen 3604.

Through the above procedures, the user can purchase desired content from the browser 51 of the receiving apparatus 50.

<Procedure for Starting to View Content>

FIG. 32 illustrates an example of a process flowchart for viewing purchased content from the content distribution system through the receiving apparatus 50.

When the user selects the purchased content 3502 on the screen 3500 displayed on the monitor 2805 by the browser 51 of the receiving apparatus 50 (step S3200), the browser 51 issues a service acquisition request necessary for displaying a list screen of the purchased content of the receiving apparatus 50 to the web server 61 of the distribution system 60 by using a URL included in the web code of the screen 3500 (step S3201).

In answer to the above, the web server 61 of the distribution system 60 acquires information on the purchased content and license of the receiving apparatus 50 from the customer management server 65 based on the member ID 2902 of the receiving apparatus 50. The web server 61 then creates a page of the purchased content list and sends back it to the receiving apparatus 50.

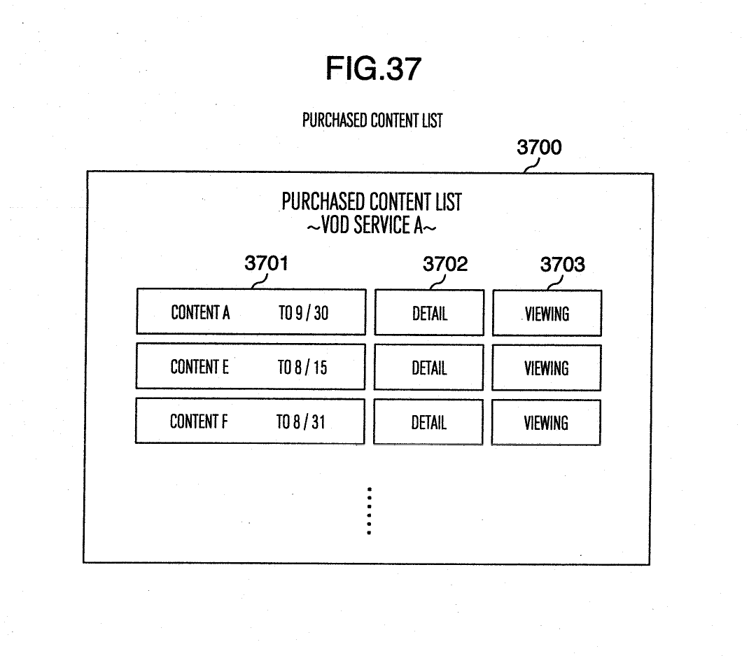

FIG. 37 illustrates an example of the purchased content list screen created by the content distribution system. The screen 3700 includes information 3701 (a content name and a viewable term) on the purchased content of the receiving apparatus 50, a button 3702 for displaying detailed information on the content, and a button 3703 for indicating the viewing. In addition to data for displaying the screen 3700 and a script for handling the data, the page of the purchased content list includes a metafile URL, a license ID, a play position, and a return URL. Note that the play position may be included into the only content that the user (receiving apparatus 50) has interrupted the previous content viewing (step S3202).

The browser 51 of the receiving apparatus 50 receiving the page of the purchased content list displays the screen 3700 on the monitor 2805 mounted on the outside of the receiving apparatus 50 or integrated in the receiving apparatus 50 (step S3203).

When the user selects content 3701 to be viewed on the screen 3700 and depresses the viewing button 3703 (step S3204), the browser 51 determines whether to previously view the content partway by using the play position of selection content acquired at step S3202 according to a procedure such as an HTML or Java script described in the pages of the purchased content list. The browser 51 then selects the URL described according to the above determination result, and issues a service acquisition request to an access destination of the web server 61 indicated by the URL.

For example, if the browser 51 determines that the content is not yet viewed or the entire content is previously viewed (that is, if the play position is not included or the play position indicates a content head), the screen transits to processing of starting the viewing (subsequent step S3209). On the other hand, if determining that the content is previously viewed partway, the browser 51 transmits the service acquisition request to the web server 61 by using a URL associated with the above determination result (step S3205).

The web server 61 receiving the service acquisition request confirms the play position of the content of the receiving apparatus 50, creates a page for selecting a viewing method, and transmits it to the receiving apparatus 50.

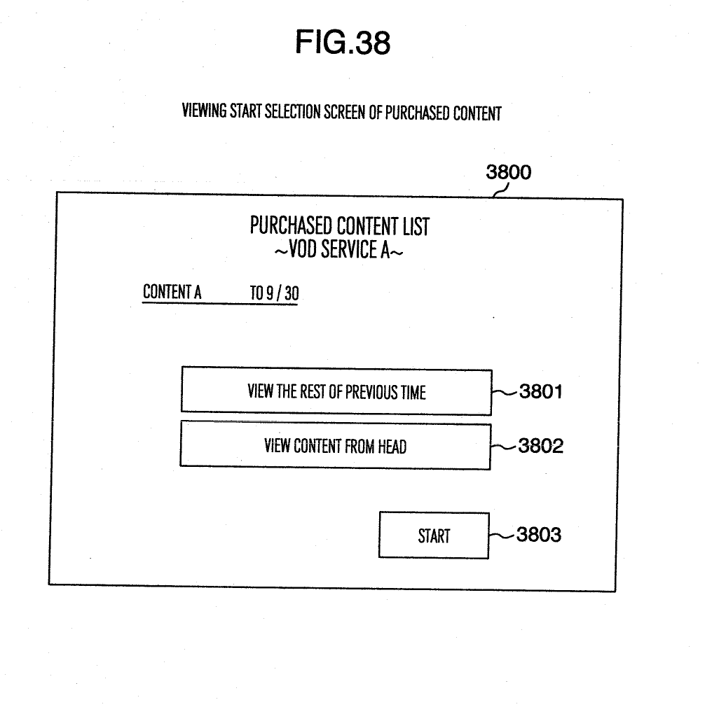

FIG. 38 illustrates an example of a content viewing start selection screen created by the content distribution system. The screen 3800 includes a method for playing back the viewing content 3701 selected by the user, for example, “a method for viewing the rest at the time of viewing content previous time” 3801, a method for viewing content from the head thereof 3802, and a start button for indicating a viewing start 3803. In addition to data for displaying the screen 3800 and a script for handling the data, the page for selecting the viewing method includes information on the metafile URL described at step S3202, license M, play position, and return URL (step S3206).

The browser 51 of the receiving apparatus 50 receiving the page for selecting the viewing method displays the screen 3800 on the monitor 2805 mounted on the outside of the receiving apparatus 50 or integrated in the receiving apparatus 50 (step S3207).

The user selects any one (in the present embodiment, “the method for viewing content from the head” 3802) of the above on the displayed screen 3800, and depresses a start button 3803 (step S3208).

When the user instructs viewing of the predetermined content to be started, the browser 51 temporarily records the metafile URL, license ID, play position, and return URL relating to the selected content. The browser 51 then transmits a playback control metafile acquisition request to the metadata server 62 of the distribution system 60 as the metafile URL (step S3209).

The metadata server 62 of the distribution system 60 receiving the playback control metafile acquisition request sends back the predetermined playback control metafile 200 as illustrated in FIG. 10 to the receiving apparatus 50 (step S3210).

The browser 51 of the receiving apparatus 50 receiving the playback control metafile 200 temporarily records contents of the playback control metafile 200 along with the metafile URL, license ID, play position, and return URL relating to each content, starts the AV player 53, and notifies the metadata server 62 of the distribution system 60 of all or part content of the playback control metafile 200 acquired to the AV player 53, the license ID, and play position (step S3211). Here, after the AV player 53 is started, the browser 51 terminates or stays resident.

In accordance with the license acquisition information (LLI) 220 of the playback control metafile 200, the AV player 53 transmits a key request (including the license ID 224 and DRM_ID 2904 of the LLI 220) to the DRM server 64 of the distribution system 60.

By using the license ID 224 and the DRM_ID 2904, the DRM server 64 receiving the key request determines whether the receiving apparatus 50 can view the content between the customer management server 65 and itself. As a result, only when determining that the receiving apparatus 50 can view the content, the DRM server 64 transmits a content key necessary for viewing the content to the receiving apparatus 50 (step S3212).

In accordance with the content peculiar attribute information (ERI) 210 of the playback control metafile 200, the receiving apparatus 50 receiving the content key performs a session establishment (for the content distribution) between the content server 63 and itself (step S3213). Here, the session serves as a logical connection necessary for performing an HTTP/TCP or RTP/UDP streaming.

In the case where the session establishment is successful, the AV player 53 of the receiving apparatus 50 transmits to the distribution system 60 a transmission request (corresponding to “Play”) of the content on the session by using a URL indicating an acquisition destination of the selected content included in the content title/reference destination/file name 211 of the playback control metafile 200 (step S3214).

While encrypting the content by using a content key, the content server 63 of the distribution system 60 receiving the content transmission request transmits it to the receiving apparatus 50. The receiving apparatus 50 receiving the encrypted content decodes the content by using the content key by the descriptor 514, decodes it by the AV player 53, and displays it on the monitor 2805 mounted on the outside of the receiving apparatus 50 or integrated in the receiving apparatus 50 via the video and audio export I/F 531 (step S3215).

Through the above procedures, the user can view the purchased content through the receiving apparatus 50.

<Procedure for Terminating Content Viewing>

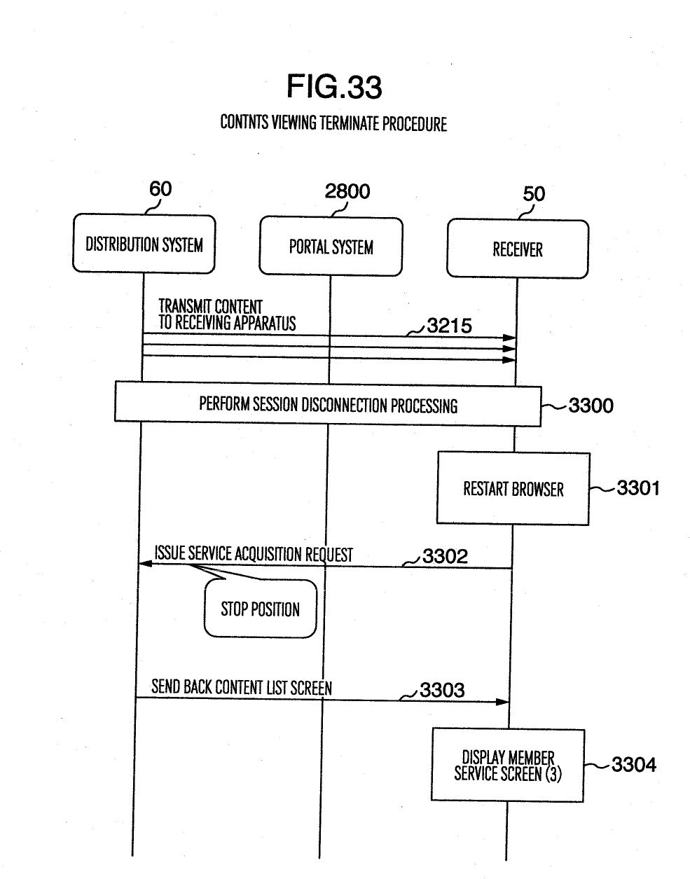

FIG. 33 illustrates an example of a process flowchart for terminating the content during the viewing.

When terminating distribution of the content till the last, the content server 63 performs disconnection processing of the session between the content server 63 and the AV player 53 of the receiving apparatus 50 (step S3300).

When terminating the disconnection processing of the session, the AV player 53 of the receiving apparatus 50 restarts the browser 51, and then delivers a stop position to the browser 51 to thereby terminate the processing (step S3301).

The browser 51 which is restarted accesses a site of the web server 61 of the distribution system 60 indicated by the return URL along with a termination state and stop position of the AV player 53 (step S3302).

In answer to the above, the web server 61 creates a display screen (e.g., the screen 3500) and sends back it to the receiving apparatus 50 (step S3303). Here, the web server 61 holds the received termination state and stop position of the AV player 53, and the stop position may be used as the play position at the time of the next viewing request.

The browser 51 of the receiving apparatus 50 receiving the created screen displays the screen 3500 on the monitor 2805 mounted on the outside of the receiving apparatus 50 or integrated in the receiving apparatus 50 (step S3304).

The above procedure in the case where the desired content is viewed till the last is described. Further, also in the case where the user interrupts the viewing on the way, the same procedure may be used.

According to the above embodiment, the receiving apparatus 50 can easily purchase and view VOD services provided by various service providers. When the portal system 2800 and the distribution system 60 manage the device ID 2901 of the receiving apparatus 50 and the member ID 2902 while associating them with each other, the receiving apparatus 50 can further provide fine services separately.

### Third Embodiment

In the present embodiment, there will be described an example in the case where a 3D receiving function of the receiving apparatus 50 is determined at the time when the user receives content in which a 3D video and a 2D video are mixedly present by using a service of separately distributing program content of a movie via a network, namely, a so-called video on demand (VOD) service based on an instruction of the user.

The presence or absence of the 3D receiving function is first classified into four receiving apparatus of a standard compatible apparatus, 3D ready apparatus, incompatible apparatus, and apparatus without a display. Each of the apparatus will be described in detail below.

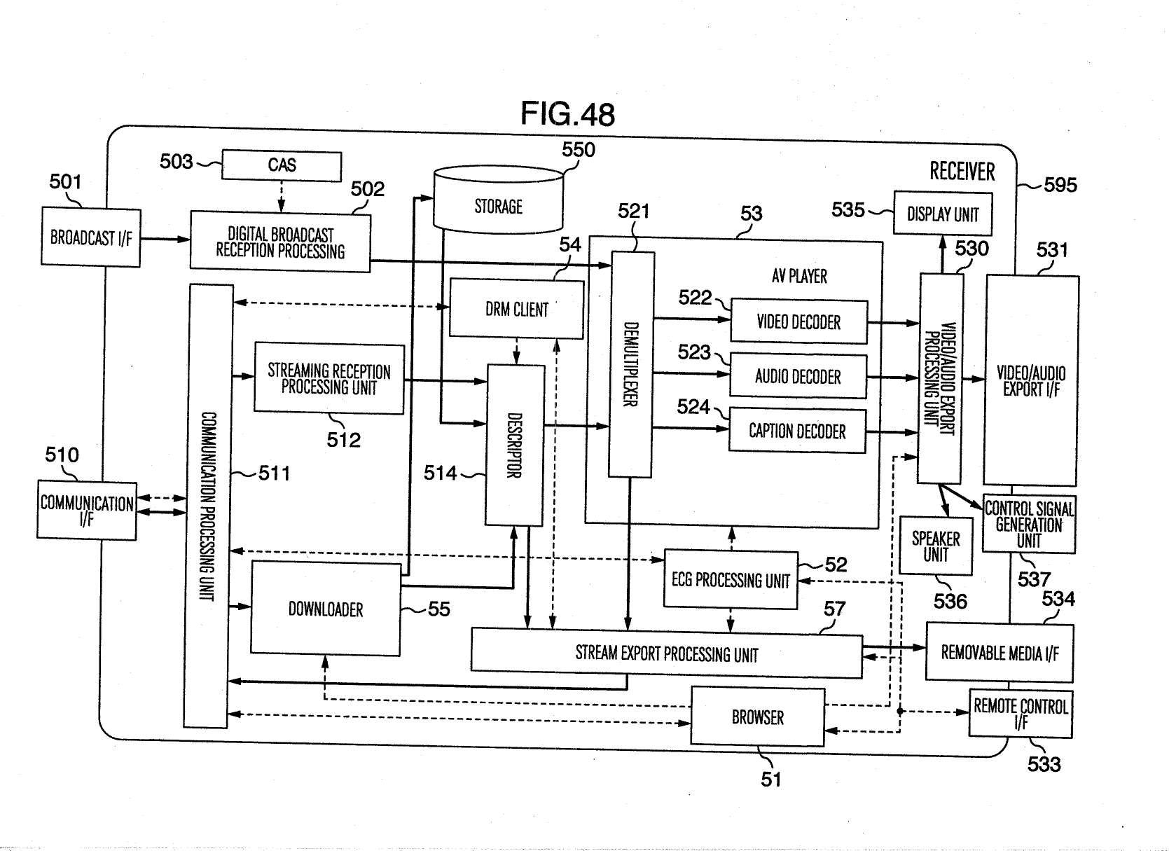

FIG. 48 illustrates a configuration example of a receiving apparatus 595 having a display unit and a speaker unit.

The standard compatible apparatus is the receiving apparatus 595 configured in FIG. 48, and differs from the receiving apparatus 50 of FIG. 3 in the following points. That is, a display unit 535, a speaker unit 536, and a control signal generation unit 537 are added to the video and audio export processing unit 530. The display unit 535 has a function of converting a video and audio exported from the video and audio export processing unit 530 into a displayable format and displaying the converted video and audio, and has a function of displaying also a 3D video.

The speaker unit 536 has a function of converting an audio signal exported from the video and audio export processing unit 530 into an exportable format from the speaker unit and exporting the converted audio. Note that in the receiving apparatus 595, a video signal and an audio signal is not necessarily displayed and exported from the display unit 535 and the speaker unit 536, and may be displayed and exported from devices connected to the video and audio export I/F 531, respectively. Further, the video decoder 522 can perform processing relating to 3D, and has a function of performing appropriate decode processing and exporting a video export to the video and audio export processing unit 530.

Further, in the case where a video signal received from the video decoder 522 is a 3D video signal, when exporting a signal to the video and audio export I/F 531 or the display unit 535, the video and audio export processing unit 530 performs processing of adding an identifier relating to 3D to the signal and exports the added signal to the video and audio export I/F 531 and the display unit 535. In the case where a control signal is required to be transmitted to an external device, for example, to glasses for viewing 3D, the video and audio export processing unit 530 transmits a control signal to the control signal generation unit 537. The control signal generation unit 537 is a 3D glasses controller, and acquires a control signal from the video and audio export processing unit 530 and transmits it to an external device such as glasses for viewing 3D.

Further, the control signal generation unit 537 may be integrated in the receiving apparatus 595, or connected to the receiving apparatus 595 via an interface. Note that processing of the control signal in the video and audio export processing unit 530 and the control signal generation unit 537 are not required depending on a method of the display unit 535 of the receiving apparatus 595. The above-described receiving apparatus 595 as the standard compatible apparatus can appropriately process content including a 3D video.

The 3D ready apparatus is the receiving apparatus 595 configured in FIG. 48, and differs from the standard compatible apparatus in the following points. That is, the 3D content cannot be viewed as it now stands, for example, unless firmware update of the receiving apparatus 595 is performed, the video decoder 522 and the video and audio export processing unit 530 cannot process a 3D video signal; and the control signal generation unit 537 is not integrated in the receiving apparatus 595, and therefore an external connection device such as a control signal generation device having the same function as that of the control signal generation unit 537 connected via an interface for an external connection is required to be purchased. Further, the 3D ready apparatus may have a configuration of the receiving apparatus 50 configured in FIG. 3, being a device without a display function such as a recorder.

In the 3D ready apparatus, the firmware update is performed and the connection to the external connection device such as the control signal generation device is detected. As a result, when the 3D video content can be processed and viewed and the 3D ready apparatus has the same function as that of the standard compatible apparatus, the 3D ready apparatus is qualified as the standard compatible apparatus. On this occasion, the firmware update is performed and the external connection device such as the control signal generation device is connected to the 3D ready apparatus. As a result, when the 3D video content can be processed and viewed, the receiving apparatus 595 updates device specification information to be held and managed by the browser 51.

Note that even if a device without a display function such as a recorder performs firmware update and detects a connection to an external connection device such as the control signal generation device to thereby process and view the 3D video content and to have the same function as that of the standard compatible apparatus, it is qualified not as the standard compatible apparatus but as the apparatus without a display. Further, the receiving apparatus 595 may detect whether an externally connected display corresponds to a 3D display, and update the device specification information to be held and managed by the browser 51.

The incompatible apparatus is the receiving apparatus 595 configured in FIG. 48, and differs from the standard compatible apparatus in the following points. That is, the video decoder 522, the video and audio export processing unit 530, and the display unit 535 cannot perform processing and display relating to 3D. Even if firmware update of the receiving apparatus 595 is performed and an external connection device such as the control signal generation unit 537 is connected to the receiving apparatus 595, the function relating to 3D cannot be added thereto. As a result, the receiving apparatus 595 cannot display and view content including the 3D video.

The apparatus without a display is the receiving apparatus 50 configured in FIG. 3, and differs from the standard compatible apparatus in the following points. That is, the video decoder 522 and the video and audio export processing unit 530 perform processing relating to the 3D video in the same manner, but exports a video signal, audio signal, and control signal from the video and audio export processing unit 530 to external devices via the video and audio export I/F 531. In this case, if a display connected to the receiving apparatus 50 corresponds to display and viewing of the 3D video content, the 3D video content can be displayed and viewed. If the display fails to correspond to the display and viewing of the 3D video content, the 3D video content cannot be displayed and viewed.

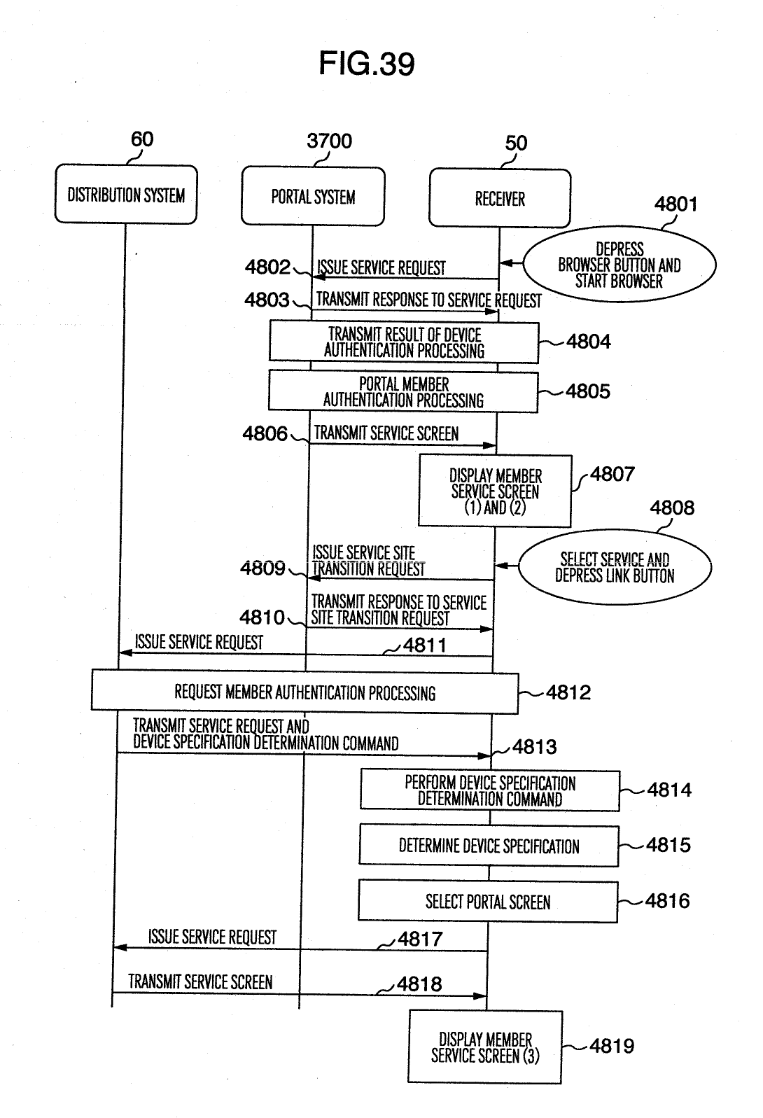

FIG. 39 illustrates an example of a procedure till the receiving apparatus 50 capable of viewing the 3D content as well as the existing 2D content accesses a site of the distribution system 60 capable of distributing the 2D/3D content.

The metadata server 62 of the distribution system 60 includes information for identifying whether each content is 2D or 3D into all or any of, for example, the series metadata 410 or content metadata 430 of the ECG metadata 400 and, for example, the video signal attribute information 214 of the content peculiar attribute information (ERI) 210 of the playback control metafile 200.

At steps 4801 to 4803 of FIG. 39, the receiving apparatus 50 uses the same procedures as those of steps 3901 to 3903 of FIG. 30, and accesses the portal server 3701 of the portal system 3700 to acquire information (a uniform resource locator (URL) and a script) to transit to a site for performing device authentication processing.

After step 4803, the browser 51 of the receiving apparatus 50 accesses the device authentication server 3704 of the portal system 3700, and performs a predetermined device authentication processing between the both. Here, the browser 51 includes information (a name and ID for identifying a manufacturer or type, version information, and 3D acceptability) relating to the receiving apparatus 50 into the device authentication request to be issued to the device authentication server 3704 by the receiving apparatus 50. The device authentication server 3704 then transmits to the receiving apparatus 50 a result of the device authentication processing and a redirect request to the accessible portal server 3701 (step S4804).

At steps 4805 to 4810, the receiving apparatus 50 then uses the same procedures as those of steps 3905 to 3910 of FIG. 30, and displays to the user a top screen (screens 4300 and 4302) received from the portal server 3701 of the portal system 3700, and asks the user to select an arbitrary link destination of the distribution system 60.

After step S4810, the browser 51 of the receiving apparatus 50 transmits an access request to the web server 61 of the distribution system 60 by as an argument using the member ID 3802 (step S4811).

The web server 61 of the distribution system 60 receiving the access request requests the customer management server 65 to perform member authentication processing by using the received member ID 3802. In accordance with a predetermined authentication procedure based on the member ID 3802, the customer management server 65 determines whether the receiving apparatus 50 is a member, and notifies the web server 61 of its results (step S4812). Here, in the case where the member authentication is successful, information (name and user preference information) on the member may be added to the member authentication result along with the presence or absence of the registration of the member ID 3802 in the customer management server 65.

The web server 61 receiving the member authentication result creates a member page based on information included in the result and transmits it to the receiving apparatus 50 (step S4813). On this occasion, the web server 61 corresponds to a case where the receiving apparatus 50 can handle the 3D content or a case where the receiving apparatus 50 cannot handle the 3D content. Further, the web server 61 includes a device specification determination command for changing a screen to be displayed on the receiving apparatus 50 into the member page and transmits to the receiving apparatus 50 a URL indicating multiple link destinations according to the determined contents. On this occasion, in the case where a single URL is transmitted to the receiving apparatus 50, the receiving apparatus 50 fails to perform subsequent device specification determination command execution of step S4814, device specification determination processing of step S4815, and portal screen selection processing of step S4816, and performs a service request of step S4817 by using a URL acquired at step S4813. On this occasion, since the device specification determination processing is not performed, the web server 61 fails to transmit the device specification determination command for executing the device specification determination processing.

The browser 51 of the receiving apparatus 50 receiving the member page executes the device specification determination command received from the web server 61 (step S4814). The browser 51 determines whether to handle the 3D content (step S4815). The browser 51 selects a type of the portal screen to be displayed based on the determination result (step S4816). Further, the browser 51 issues a transmission request of the screen to the web server 61 of the distribution system 60 (step S4817). The above device specification determination command execution processing of step S4814 is processing for sending back a particular character string based on the device specification determination command of step S4813. In the above device specification determination command of step S4813, for example, a script language as in Java script is used. Further, the device specification determination command execution processing of step S4814 includes an object execution-controlled by Java script. The browser 51 of the receiving apparatus 50 executes its script language, and exports device specifications for the 3D content and the 2D content of the receiving apparatus 50 as a character string.

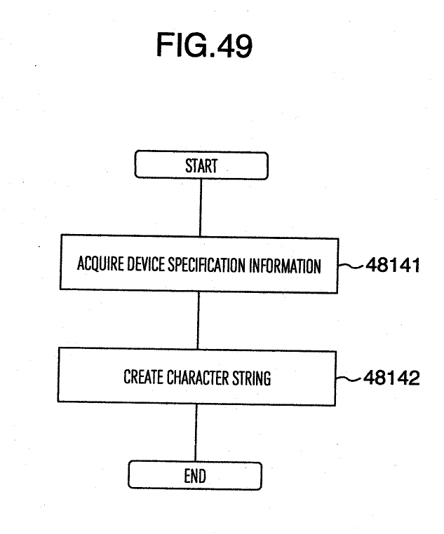

FIG. 49 illustrates an example of a process flowchart of the device specification determination command execution processing of step 4814. The browser 51 first acquires, for example, device specification information of the receiving apparatus 50 with respect to the 3D content and 2D content to be previously held and managed by itself through the execution of the device specification determination command (step S48141). Further, the browser 51 creates a predetermined character string including the acquired device specification information (step S48142). The device specification information of the receiving apparatus 50 is not limited to the 3D content and 2D content held by the browser 51. The browser 51 may acquire the device specification information stored in a storage unit such as a hard disk drive and memory of the receiving apparatus 50.

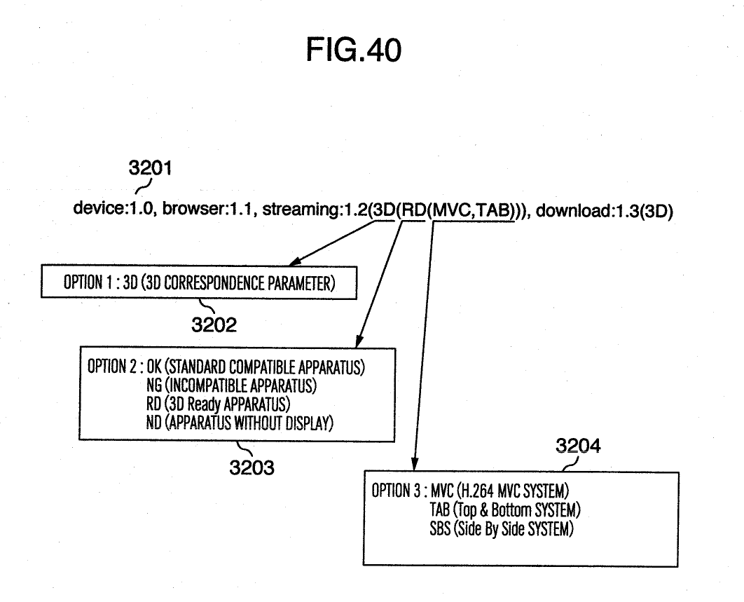

FIG. 40 illustrates an example of a character string exported based on the device specification determination command execution processing of step S4814. In FIG. 40, a reference numeral 3201 denotes a character string exported based on the device specification determination command execution processing of step S4814. The terms device, browser, streaming, and download represent functions of the receiving apparatus 50, and subsequent numerical characters represent version numbers. Here, the item of the streaming represents a function at the time when the receiving apparatus 50 receives VOD services. Characters within a bracket represent installation conditions of a functional option, and are classified into multiple options for description.

In (3D(RD(MVC, TAB))), the receiving apparatus 50 has a parameter of correspondence functions for viewing 3D (option 1: 3D). For example, it represents a 3D ready apparatus capable of viewing the 3D content by installing the control signal generation unit 537 such as a 3D glasses controller on the receiving apparatus 50 (option 2: RD). In the viewable 3D content, for example, the H. 264 MVC system being one of image compression processing systems corresponds to a top & bottom system (option 3: MVC, TAB) in which a resolution in the vertical direction of videos for the right and left eyes is compressed to a half and the 3D video is synthesized to one video screen.

As illustrated in FIG. 40, as the other options, OK (standard compatible apparatus), NG (incompatible apparatus), and ND (apparatus without a display) are considered in the option 2. Further, a side by side system in which a resolution in the horizontal direction of videos for the right and left eyes is compressed to a half and the 3D video is synthesized to one video screen is considered in the option 3. In the case where the receiving apparatus 50 is the incompatible apparatus and fails to correspond to viewing of the 3D content, the descriptions of the options 1, 2, and 3 are unnecessary. Alternatively, the descriptions of the option 1: 3D and the option 2: NG may be performed.

Returning again to FIG. 39, a description will be made. The character string 3201 acquired by the device specification determination command execution processing of step S4814 is delivered to the device specification determination processing of step S4815. The device specification determination processing of step S4815 will be described in detail later.

When device specifications of the receiving apparatus 50 are determined in the device specification determination processing of step S4815, the user selects a URL of a portal screen appropriate to functional specifications of the receiving apparatus 50 according to a result of the device specification determination processing of step S4815 in the portal screen selection processing of step S4816. The portal screen selection information processing of step S4816 will be described in detail later.

The receiving apparatus 50 transmits a portal screen request of step S4817 to the distribution system 60 according to a URL selected by the portal screen selection processing of step S4816. Here, in the selection of the portal screen, for example, a URL indicating a position of the portal screen according to functional specifications may be included in the device specification determination command of step S4813, and the portal screen may be selected by the portal screen selection processing of step S4816.

The web server 61 of the distribution system 60 receiving a transmission request creates a screen capable of handling only content or a screen capable of handling both of the 2D content and 3D content according to a URL of the transmission request, and transmits it to the receiving apparatus 50 (step S4818).

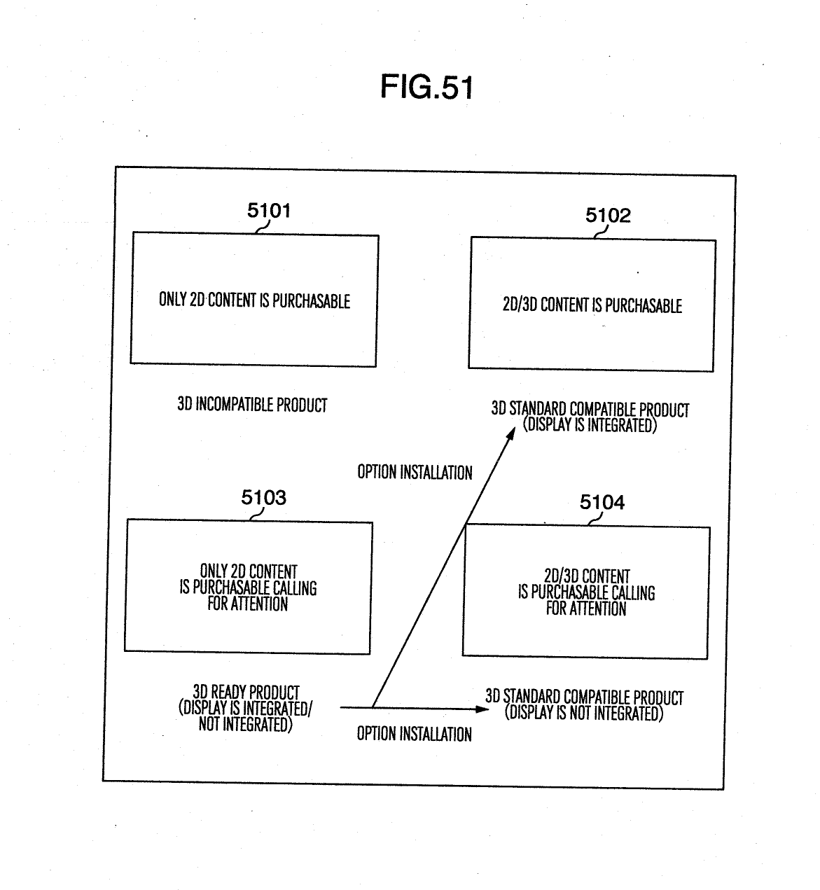

FIG. 51 illustrates an outline of a screen transmitted to the receiving apparatus 50 by the web server 61 of the distribution system 60.

A reference numeral 5101 denotes an outline of a 3D incompatible product being the incompatible apparatus and presents only the 2D content to be purchased. A reference numeral 5102 denotes an outline of a 3D standard compatible product (display is integrated) being the standard compatible apparatus and presents the 2D/3D content to be purchased. A reference numeral 5103 denotes an outline of a 3D ready product (display is integrated/not integrated) being the 3D ready apparatus and presents only the 2D content to be purchased while calling for attention. A reference numeral 5104 denotes an outline of a 3D standard compatible product (display is not integrated) being the apparatus without a display and presents the 2D/3D content to be purchased while calling for attention.

At this time, when the receiving apparatus 50 is the 3D ready apparatus and corresponds to processing/viewing of the 3D content by option installation, an outline of the screen changes from the reference numeral 5103 to the reference numeral 5102 or 5104 depending on whether the display is integrated. Further, even if the receiving apparatus 50 is the 3D ready apparatus, a screen except the above-described screens such as the screen of the reference numeral 5102 in which the 2D/3D content presented by the standard compatible apparatus is mixedly present may be transmitted depending on the web server 61 of the distribution system 60.

The browser 51 of the receiving apparatus 50 receiving a screen displays the screen on the monitor 3705 (step S4819).

The device specification information of the receiving apparatus 50 is held and managed by the browser 51 of the receiving apparatus 50 on whether the receiving apparatus 50 is any one of the 3D incompatible apparatus, 3D standard compatible apparatus, 3D ready apparatus, and apparatus without a display. Further, the device specification information of the receiving apparatus 50 is not limited to the 3D content and 2D content held by the browser 51, and may be stored in a storage unit such as a hard disk drive and memory of the receiving apparatus 50.

A case where the 3D ready apparatus corresponds to processing/viewing of the 3D content based on the option installation will be described. When an option device detection unit (not illustrated) of the 3D ready apparatus detects the connection to an option device such as a 3D glasses controller, a device information management unit (not illustrated) of the receiving apparatus 50 rewrites device specification information from information indicating the 3D ready apparatus to information indicating the 3D compatible apparatus. Also when the 3D ready apparatus corresponds to the 3D display through the firmware update, the device information management unit rewrites device specification information from information indicating the 3D ready apparatus to information indicating the 3D compatible apparatus. In addition, the browser 51 may double as the device information management unit.

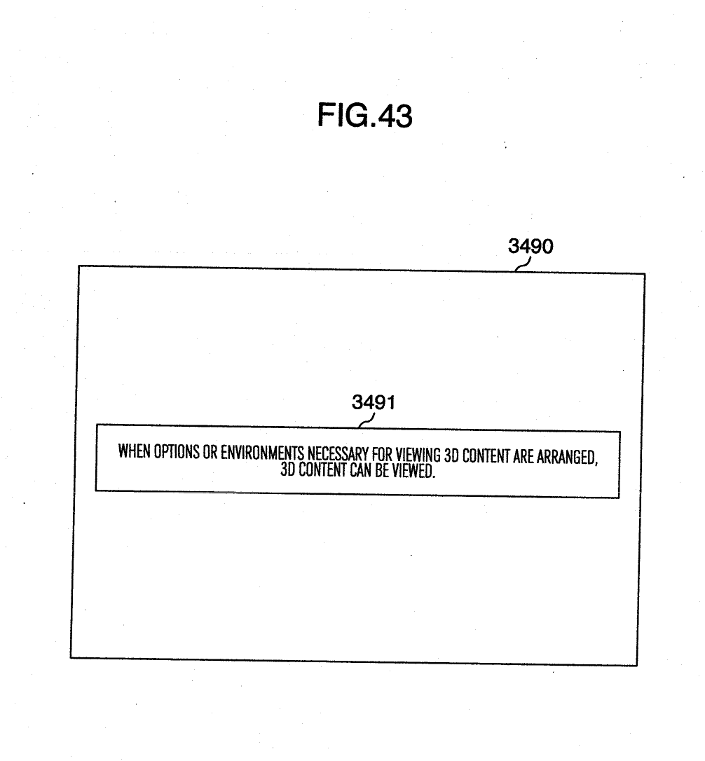

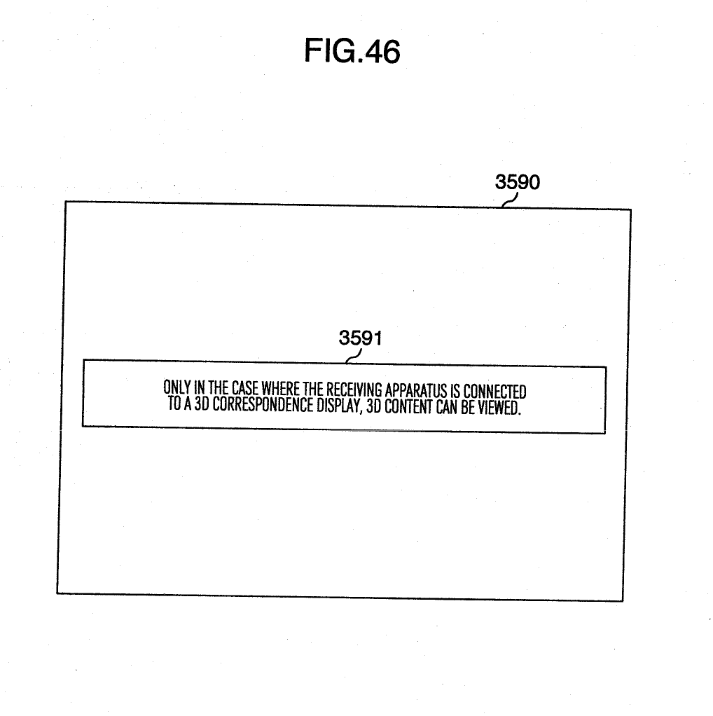

In the following cases, the device information management unit rewrites the device specification information from information indicating the 3D ready apparatus to information indicating the 3D compatible apparatus. That is, the user receives an input to the effect that “the screen corresponds to the 3D display” through purchase of the 3D glasses from the setting screen. Or, alternatively, the user receives an input to the effect that “the 3D glasses are previously purchased and the screen corresponds to the 3D display” displayed after screens of FIGS. 43 and 46 in the case of purchasing/playing back the 3D content.

As can be seen from the above discussion, when the device specification information is rewritten from information indicating the 3D ready apparatus to information indicating the 3D compatible apparatus based on the option installation, in the case where this device specification information is acquired to create a character string of FIG. 40, the option 2 of FIG. 40 is changed from RD (3D ready apparatus) to OK (standard compatible apparatus).

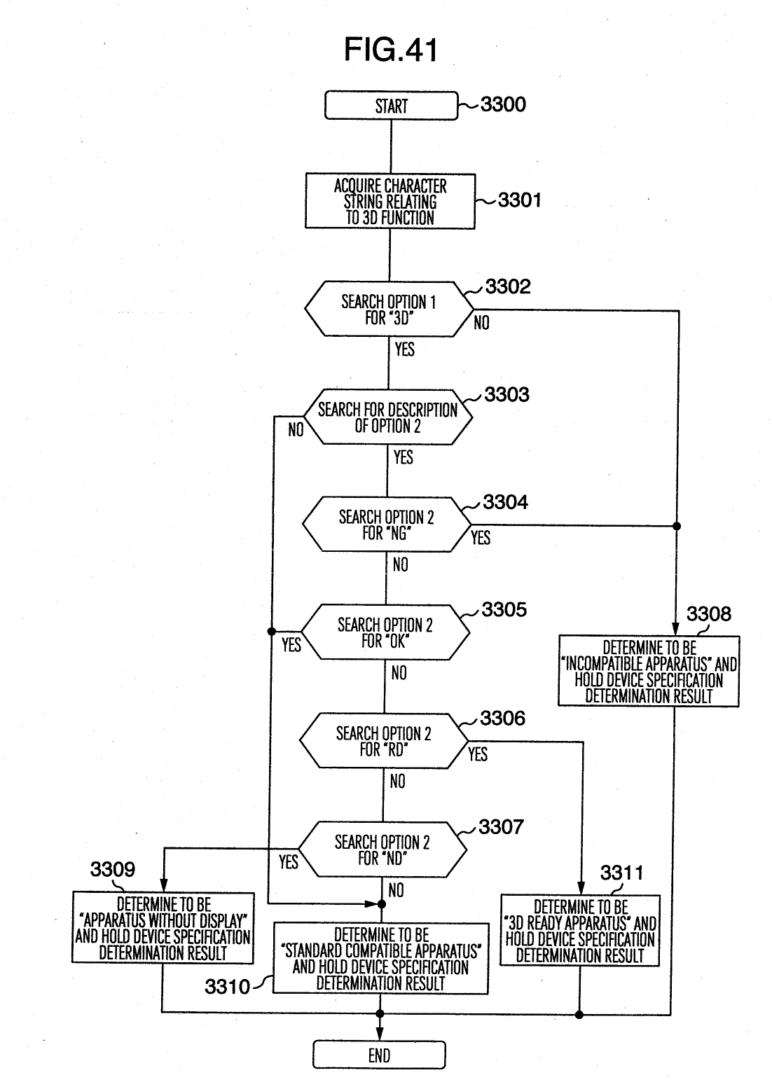

FIG. 41 illustrates an example of the device specification determination processing of step S4815.

The browser 51 acquires the character string 3201 representing device specifications corresponding to the 3D content and the 3D content being execution results of the device specification determination command execution of step S4814 (step S3301).

The browser 51 searches the option 1 of the character string 3201 for a description of “3D” (step S3302). If “3D” is not described, the browser 51 determines the receiving apparatus 50 to be the “incompatible apparatus” and holds information on device specification determination results such as the “incompatible apparatus” and “NG” (step S3308).

The browser 51 searches for a description of the option 2 of the character string 3201 (step S3303). If the option 2 is not described, the browser 51 determines the receiving apparatus 50 to be the “standard compatible apparatus” and holds information on device specification determination result such as the “standard compatible apparatus” and “OK” (step S3310).

The browser 51 searches the option 2 of the character string 3201 for a description of “NG” (step S3304). If “NG” is described, the browser 51 determines the receiving apparatus 50 to be the “incompatible apparatus” and holds information on device specification determination results such as the “incompatible apparatus” and “NG” (step S3308).

The browser 51 searches the option 2 of the character string 3201 for a description of “OK” (step S3305). If “OK” is described, the browser 51 determines the receiving apparatus 50 to be the “standard compatible apparatus” and holds information on device specification determination results such as the “standard compatible apparatus” and “OK” (step S3310).

The browser 51 searches the option 2 of the character string 3201 for a description of “RD” (step S3306). If “RD” is described, the browser 51 determines the receiving apparatus 50 to be the “3D ready apparatus” and holds information on device specification determination results such as the “3D ready apparatus” and “3D” (step S3311).

The browser 51 searches the option 2 of the character string 3201 for a description of “ND” (step S3307). If “ND” is described, the browser 51 determines the receiving apparatus 50 to be the “apparatus without a display” and holds information on device specification determination results such as the “apparatus without a display” and “ND” (step S3309). If “ND” is not described, the browser 51 determines the receiving apparatus 50 to be the “standard compatible apparatus” and holds information on device specification determination results such as the “standard compatible apparatus” and “OK” (step S3310).

The above-described processing is performed, and the browser 51 acquires information on the device specification determination results from the character string 3201 in the device specification determination processing of step S4815.

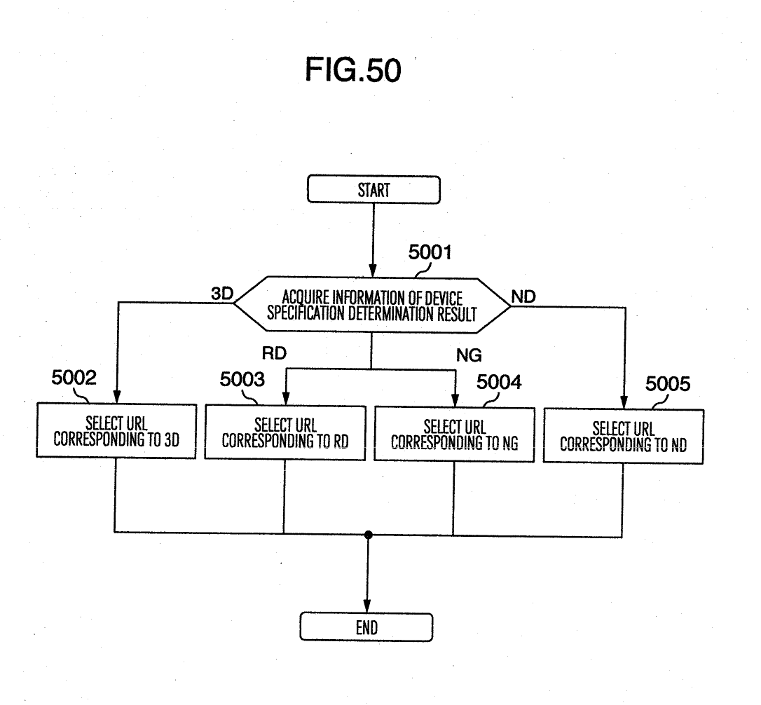

FIG. 50 illustrates an example of the portal screen selection processing of step S4816.

The browser 51 acquires information on the device specification determination results delivered from the device specification determination processing of step S4815. If the acquired information on the device specification determination results is “3D”, the process proceeds to step S5002. If it is “RD”, the process proceeds to step S5003. If it is “NG”, the process proceeds to step S5004. Nit is “ND”, the process proceeds to step S5005 (step S5001).

If the acquired information on the device specification determination results is “3D”, the receiving apparatus 50 acquires a URL corresponding to the 3D from the service request acquired from the distribution system 60 at step S4813 (step S5002).

If it is “RD”, the receiving apparatus 50 acquires a URL corresponding to the RD from the service request acquired from the distribution system 60 at step S4813 (step S5003).

If it is “NG”, the receiving apparatus 50 acquires a URL corresponding to the NG from the service request acquired from the distribution system 60 at step S4813 (step S5004).

If it is “ND”, the receiving apparatus 50 acquires a URL corresponding to the ND from the service request acquired from the distribution system 60 at step S4813 (step S5005).

The receiving apparatus 50 performs the above-described processing, and acquires a URL used at step S4817 from the service request acquired at step S4813 from the distribution system 60 by using information on the device specification determination results in the portal screen selection processing of step S4816.

From the above, the web server 61 of the distribution system 60 at step S4813 includes information so as to change a screen to be displayed on the receiving apparatus 50 in response to a case where the receiving apparatus 50 can handle the 3D content into the member page created by the web server 61 or a case where the receiving apparatus 50 cannot handle the 3D content. Through the above processing, the browser 51 can select a screen to be displayed on the receiving apparatus 50 side. As a result, the receiving apparatus 50 can appropriately handle the 3D content to be distributed by the distribution system 60.

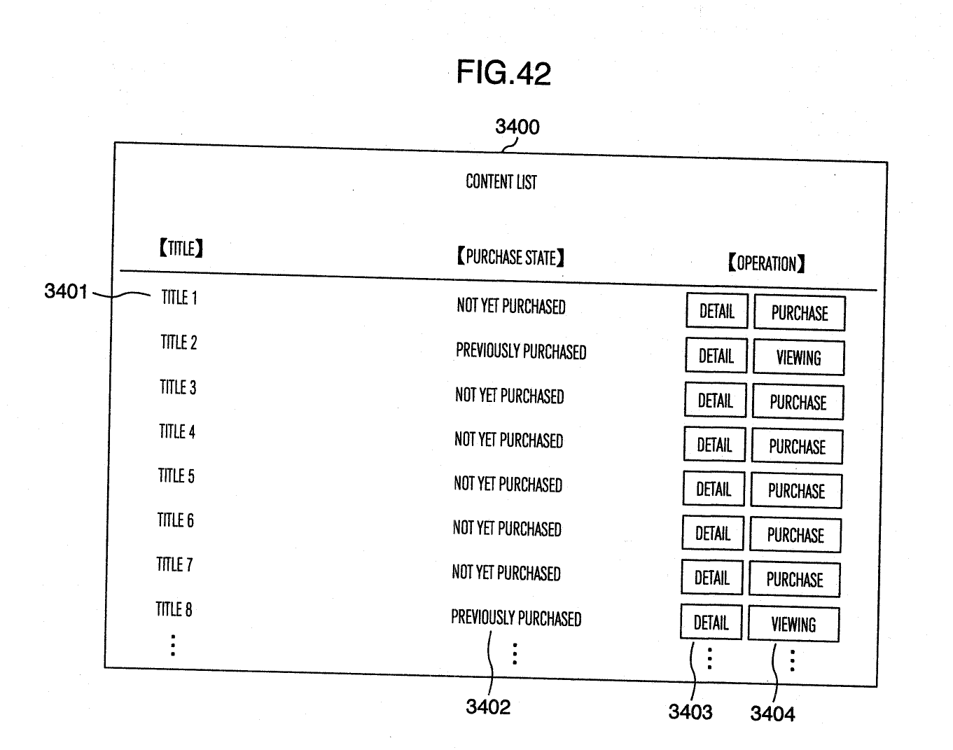

FIG. 42 illustrates an example of the portal screen 3400 of the incompatible apparatus to be displayed by the browser 51. In this example, portal screen data acquired from the portal server 3001 is displayed by using the browser 51, and the title field 3401 and the purchase state field 3402 are displayed. Further, the detail button 3403 and the purchase or viewing button 3404 are displayed as an operation button for content.

In the purchase state field 3402, information managed by the receiving apparatus 50 such as content previously purchased by a user, non-purchased content, or free content is presented.

Based on a user operation, in the case where the detail button 3403 is selected, detailed information on the corresponding content is displayed. Alternatively, in the case where the purchase or viewing button 3404 is selected, purchase or viewing processing is performed, respectively.

Further, since FIG. 42 illustrates the incompatible apparatus for viewing the 3D content, only all the 2D content is displayed. The 2D and 3D are not required to be displayed separately for each title; however, the 2D and 3D may be displayed separately for each title field.

FIG. 43 illustrates an example of the guide screen 3490 for the 3D ready apparatus. In this example, the browser 51 displays screen data for the ready apparatus in which the 3D content acquired from the portal server 3001 cannot be viewed as it is, and further displays the guide 3491.

The guide 3491 leads the following to the user, and appropriate words are described in the receiving apparatus 50 indicating the contents. That is, the user cannot view 3D content as it now stands; however, when preparing glasses necessary for viewing the 3D content or a necessary device such as a signal input and output device and updating firmware of the receiving apparatus 50, the user can view the 3D content.

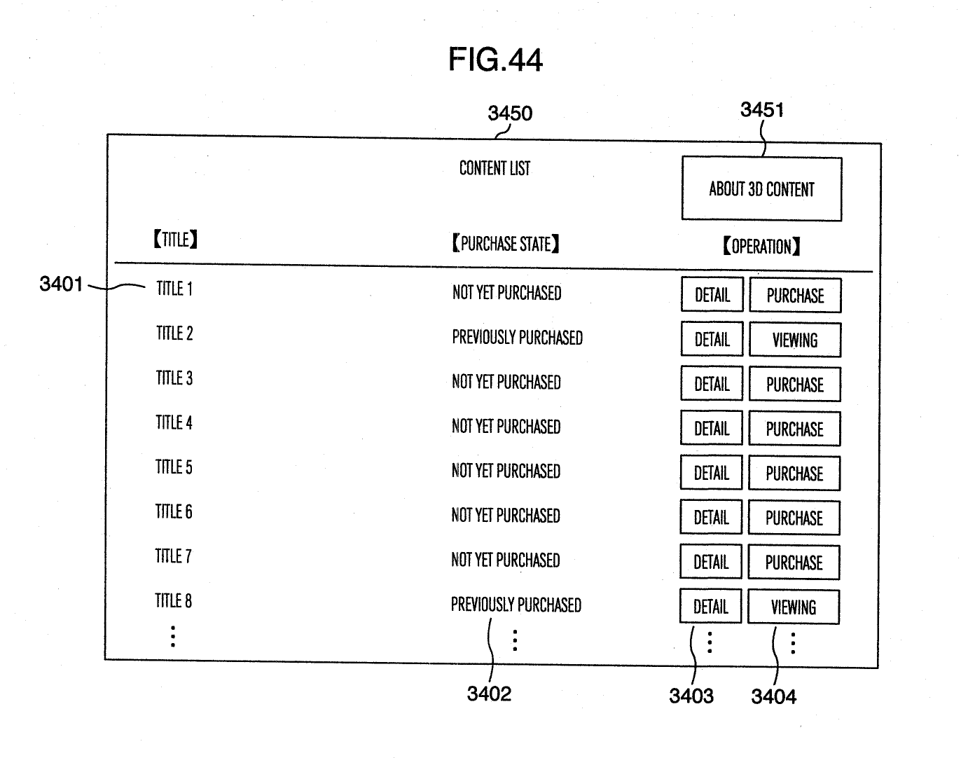

FIG. 44 illustrates an example of the portal screen 3450 for the 3D ready apparatus to be displayed by the browser 51. Only differences from FIG. 42 will be described. In this example, a button 3451 is added to the example of FIG. 42.

When the button 3451 is selected based on a user operation, the guide 3491 of FIG. 43 is displayed. Through the above processing, when the device necessary for the user is prepared and firmware of the receiving apparatus 50 is updated, the guide 3491 can lead the user to view the 3D content. In addition to the button 3451, the guide 3491 of FIG. 43 may be displayed through the above processing or at the time of selecting the detail button 3403 or the purchase or viewing button 3404.

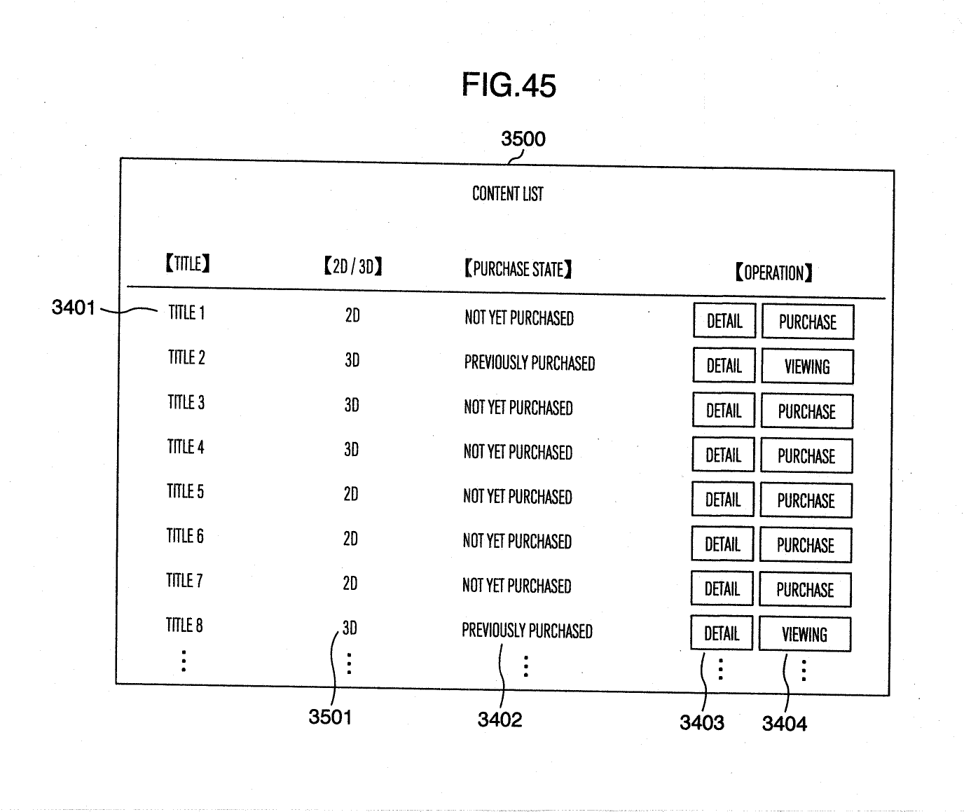

FIG. 45 illustrates an example of the portal screen 3500 for the standard compatible apparatus to be displayed by the browser 51. Only differences from FIG. 42 will be described. In this example, a content type field 3501 is added to the example of FIG. 42.

In the content type field 3501, information on its content being the 2D content or 3D content is represented. In the case where the receiving apparatus 50 is the standard compatible apparatus, since both of the 2D content and 3D content can be viewed, the user can select content to be viewed or purchased with reference to the content type field 3501.

FIG. 46 illustrates an example of a guide screen 3590 for the apparatus without a display. In this example, the browser 51 displays screen data for the apparatus without a display having no display function acquired from the portal server 3001, and displays the guide 3591.

The guide 3591 leads the following to the user, and appropriate words are described in the receiving apparatus 50 indicating the contents. That is, since the receiving apparatus 50 is the apparatus without a display, only in the case where the connected display corresponds to viewing for the 3D content, the user can view the 3D content.

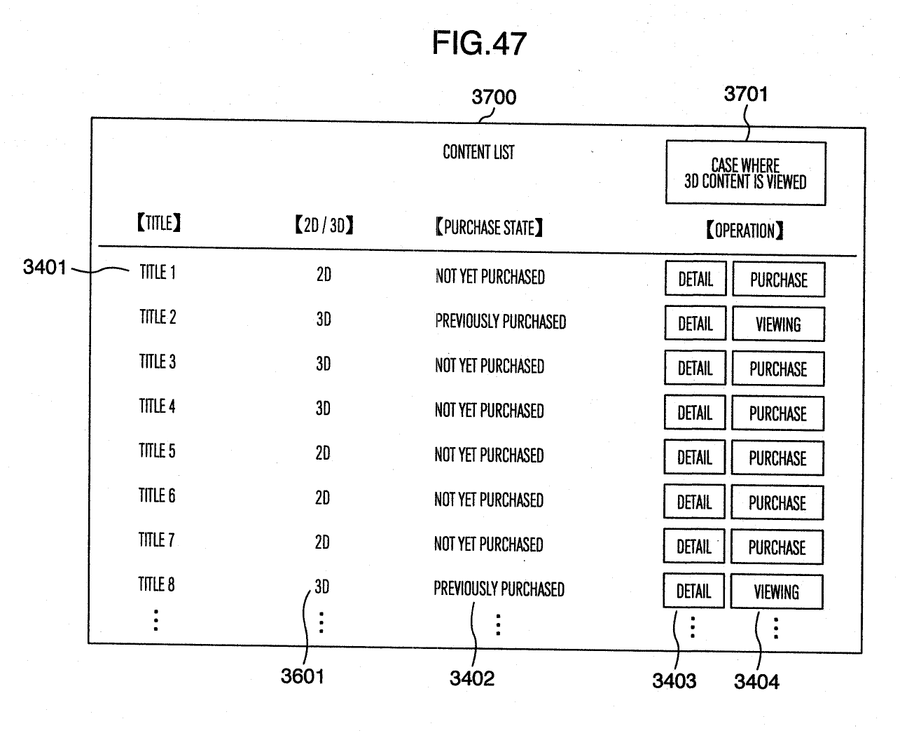

FIG. 47 illustrates an example of the portal screen 3550 for the apparatus without a display to be displayed by the browser 51. Only differences from FIG. 45 will be described. In this example, a button 3551 is added to the example of FIG. 45.

When the button 3551 is selected based on a user operation, the guide 3591 of FIG. 46 is displayed. Through the above processing, for the user, the guide 3591 can lead a display connected to the receiving apparatus 50 to be required to correspond to viewing of the 3D content. In addition to the button 3551, the guide 3591 of FIG. 46 may be displayed through the above processing or at the time of selecting the detail button 3403 and the purchase or viewing button 3404.

In the present embodiment, an example where a content list is displayed by using a browser is described, and further, a content list may be displayed by using application using an ECG.

According to the above embodiments, the receiving apparatus 50 can display optimum content based on corresponding conditions of 3D video processing. Accordingly, the user can prevent content failing to correspond to his or her own receiving apparatus from being erroneously purchased. Further, in a service providing undertaker, there is exerted an effect of persuading a receiving apparatus to correspond to 3D content and a user to purchase 3D content.

In addition, the present invention is not limited to the above-described embodiments and includes various modification examples. For example, the above-described embodiments have been described in detail for intelligibly describing the present invention and not necessarily limited to an apparatus including all the described structures. A part of structures according to an embodiment can be substituted for a structure according to another embodiment, and further, a structure according to another embodiment can be added to a structure according to an embodiment. Further, addition, deletion or substitution of another structure can be performed to a part of structures according to each embodiment.

All or part of the configurations, functions, processing units, and processing methods described above may be implemented by hardware by designing them, for example, by integrated circuits. The configurations and the functions described above may also be implemented by software by the processor interpreting and executing the programs which implement the functions. When a function is executed, the information such as the corresponding program, tables, and files may be stored in a storage device such as a memory, a hard disk, or a solid state drive (SSD). When a function is not executed, the information such as the program, tables, and files may be stored in a storage medium such as an IC card, an SD card, or a DVD.

Note that only control lines and information lines considered to be necessary for the description are shown but that not all control lines or information lines of the product are shown. It should be considered that all configurations are actually connected each other.

It should be further understood by those skilled in the art that although the foregoing description has been made on embodiments of the invention, the invention is not limited thereto and various changes and modifications may be made without departing from the spirit of the invention and the scope of the appended claims.

1. A receiving apparatus for receiving a digital signal in which a 3D video program and a 2D video program are mixedly present, comprising:
a program selection unit configured to display and select a received program list; and
a function determination unit configured to determine a function of viewing the 3D video program and 2D video program included in the receiving apparatus,
wherein the program selection unit displays a viewable program list of the receiving apparatus according to a determination result of the function determination unit at the time of displaying the received program list.

2. The receiving apparatus according to claim 1,
wherein the function determination unit determines whether the receiving apparatus can receive a 3D video program, the receiving apparatus can receive a 3D video program by adding a 3D viewing unit for viewing the 3D video program, and the receiving apparatus includes a display unit for displaying a 3D video program.

3. The receiving apparatus according to claim 1 or 2,
wherein the program selection unit displays, according to the selected program, conditions that the receiving apparatus can view a 3D video program.

4. A method for receiving a digital signal in which a 3D video program and a 2D video program are mixedly present, comprising:
determining a function of viewing the 3D video program and the 2D video program; and
displaying a viewable program list at the time of selecting a program for displaying and receiving a program list.

5. A receiving apparatus for receiving a digital signal in which a 3D video program and a 2D video program are mixedly present, comprising:
a program selection unit configured to display and select a received program list; and
a storage unit configured to store device specification information indicating whether the 3D video program included in the receiving apparatus can be displayed,
wherein:
when a device specification determination command transmitted from a server is executed, the receiving apparatus creates a character string indicating whether to correspond to a display of the 3D video program based on the device specification information; and
at the time of displaying a received program list, the program selection unit displays a viewable program list of the receiving apparatus according to whether the receiving apparatus indicated by the character string corresponds to a display of the 3D video program.

6. The receiving apparatus according to claim 5,
wherein the function determination unit determines whether the receiving apparatus can receive a 3D video program, the receiving apparatus can receive a 3D video program by adding a 3D viewing unit for viewing the 3D video program, and the receiving apparatus includes a display unit for displaying a 3D video program.

7. The receiving apparatus according to claim 5,
wherein the program selection unit displays, according to the selected program, conditions that the receiving apparatus can view a 3D video program.

8. The receiving apparatus according to claim 6,
wherein the program selection unit displays, according to the selected program, conditions that the receiving apparatus can view a 3D video program.

9. A method for receiving a digital signal in which a 3D video program and a 2D video program are mixedly present, comprising:
creating a character string indicating whether a receiving apparatus corresponds to a display of the 3D video program based on device specification information indicating whether the receiving apparatus can display a display of the 3D video program when a device specification determination command transmitted from a server is executed; and
displaying a viewable program list according to whether the receiving apparatus indicated by the character string corresponds to a display of the 3D video program at the time of selecting a program for displaying and receiving a program list.
